(19) United States
(12) Patent Application Publication
(10) Pub. No.: US 2013/0144922 A1
(43) Pub. Date: Jun. 6, 2013

(54) Device and Method for Evaluating and Optimizing Signals on the Basis of Algebraic Invariants

(71) Applicant: STORMINGSWISS GMBH, Morges (CH)

(72) Inventor: Clemens Par, Cinuos-chel (CH)

(73) Assignee: STORMINGSWISS GMBH, Morges (CH)

(21) Appl. No.: 13/756,884

(22) Filed: Feb. 1, 2013

Related U.S. Application Data
(63) Continuation of application No. PCT/EP2011/063322, filed on Aug. 2, 2011.

(30) Foreign Application Priority Data
Aug. 3, 2010 (CH) 1264/10

(51) Int. Cl. G06F 17/14; G06F 3/16

(52) U.S. Cl. CPC G06F 17/147; G06F 3/16
USPC 708/400; 700/94

(57) ABSTRACT

Signals (for example audio signals) which seem to be completely random, yet for which universally valid statements should be made, for example in the form of parameterizations which, on average, are accurate and can be determined only on the basis of short signal sections. Instead of simulating for example a Gaussian process, projections of algebraic operations—on the plane of real or complex numbers—of said signal sections for example are observed and proven for said astonishingly simple algebraic invariants. Said invariants are subsequently used as tags in order to perform, for example, a selection according to their frequency. On average, the present system proves to be more efficient than known methods to date. The practical-commercial application of said system covers nearly the entire signal processing field. The present document addresses in particular the stochastic observation of audio signals, as known for example from the field of digital audio broadcasting.

This application is a continuation of international application PCT/EP2011/063322 filed on Aug. 2, 2011, the contents of which is enclosed by reference. It claims priority of Swiss patent application CH10/1264, filed on Aug. 3, 2010, the contents of which is enclosed by reference.

The invention relates to signals (for example audio signals) and devices or methods for generating, transmitting, processing, converting and reproducing them.

The present invention relates in particular to a method and a device or a system allowing conclusions to be drawn on the basis of any function or functions of one or more signals or also of a combination or combinations of two or more signals. In the exemplary case of a stereophonic audio signal x(t), y(t), where x(t) represents the function-value of the left input signal at the point in time t, y(t) represents the function-value of the right input signal at the point in time t, it is possible to observe for example the sum of the transfer-functions

f*[x(t)]=[x(t)/√ 2̅]*(−1+i)

g*[y(t)]=[y(t)/√ 2̅]*(1+i)

in order to be able to draw conclusions as to the properties of the signals.

These conclusions should be reachable in particular on the basis of common properties of two different signals that appear to be completely random (such as for example audio signals).

Methods so far have attempted—with comparably great difficulty—to simulate this randomization principle and thus make it useful for the signals being analyzed. For example in the case of DAB (Digital Audio Broadcasting), a Gaussian process is simulated with a so-called Tapped Delay Line model or a Monte Carlo method (colored, complex Gaussian noise in two dimensions) is also used for the simulation of the mobile radio channel.

EP0825800 (Thomson Brandt GmbH) proposes the formation of different kinds of signals from a mono input signal by means of filtering, said signals being used—for example by using a method proposed by Lauridsen based on amplitude and time difference corrections, depending on the recording situation—to generate virtual single-band stereo signals separately, which are then subsequently combined to form two output signals.

WO/2009/138205 resp. EP2124486 as well as EP1850639 describe for example a method for methodically evaluating the angle of incidence for the sound event that is to be mapped, said angle of incidence being enclosed by the main axis of the microphone and the directional axis for the sound source, this being achieved by applying time differences and amplitude corrections which are functionally dependent on the original recording situation (which may be interpolated by using the system). The contents of WO/2009/138205 resp. EP2124486 as well as of EP1850639 are hereby incorporated by way of reference.

U.S. Pat. No. 5,173,944 (Begault Durand) applies HRTFs (Head Related Transfer-functions) which correlate with 90, 120, 240 and 270 degrees azimuth respectively to the differently delayed but uniformly amplified monophonic input signal, the signals formed in turn being finally superimposed on the original mono signal. In this case, the amplitude correction and the time difference corrections are chosen independently of the recording situation.

CH01159/09 resp. PCT/EP2010/055876 proposes the downstream connection of one or more panoramic potentiometers or equivalent means in a device according to WO/2009/138205 resp. EP2124486 or EP1850639 after stereo decoding has taken place (after an MS matrix, for which the relation

L=(M+S)*1/√ 2̅

and

R=(M−S)*1/√ 2̅

applies, has been passed through), which—unlike in the case of intensity stereophonic signals, i.e. for stereo signals which differ exclusively in terms of their levels but not in terms of time resp. phase differences or different frequency spectra—do not result in the intended narrowing of the function width or in the intended shifting of the function direction of the obtained stereo signals, but rather result in the degree of correlation being increased or decreased.

CH01776/09 resp. PCT/EP2010/055877 enables an optimum choice of those parameters that form the basis for generating stereophonic or pseudo-stereophonic signals. The user is provided with means for specifying the degree of correlation, the definition range, the loudness as well as further parameters of the resulting signals according to psychoacoustic aspects, and hence for preventing artifacts.

Altogether, it can be said about the state of the art that algebraic invariants so far, given the lack of corresponding basis, have never been used for analyzing or optimizing sound events or similar processes.

Although it has been generally presumed for over 100 years since David Hilbert's groundbreaking work on algebraic invariants that such algebraic invariants exist in particular for Gaussian processes (an in particular for audio signals), it was never successfully proven.

### DISCLOSURE OF THE INVENTION

Not only does the present invention demonstrate such algebraic invariants, the latter are thus made practically usable commercially for signal technology, for example for calibrating devices or methods for obtaining, improving or optimizing stereophonic or pseudo-stereophonic audio signals.

First, one analyzes a combination f̂(t) or several combinations f₁̂(t), f₂̂(t), . . . , fₚ̂(t) of at least two signals s₁(t), s₂(t), . . . , sₘ(t) resp. of their transfer-functions t₁(s₁(t)), t₂(s₂(t)), . . . , tₘ(sₘ(t))—or also the freely definable function f₁^{#}(t) or the freely definable functions f₁^{#}(t), f₂^{#}(t), . . . , f_{μ}^{#}(t) of one signal s^{#}(t) or several signals s₁^{#}(t), s₂^{#}(t), . . . , s_{Ω}^{#}(t)—on the complex number plane resp. their projection on the relief defined by the norm of all points of the complex number plane (the standard cone whose tip lies in the origin of the complex number plane and whose axis of symmetry is perpendicular to the complex number plane).

The real axis, the imaginary axis and the axis of symmetry of the cone are henceforth represented as a Cartesian coordinate system with coordinates (x₁, x₂, x₃). The change in the opening angle of the circle yields the cone equation

x₁²+x₂²−(1/g*²)*x₃=0

resp. the coefficients [1 1 −1/g*²]. Two cone equations are now analyzed:

S:=aₓ²:=1*x₁²+1*x₂²−(1/g²)*x₃²=0

and

S′:=a′ₓ²:=1*x₁²+1*x₂²−(1/g′²)*x₃²=0.

As known, one invariant is thus

a_{a′}²:=1*1²+1*1²−(1/g²)*(1/g′⁴).

Both cones S, S′ are non-polar if

(1/g²)*(1/g′⁴)=2.

S is then inscribed harmonically in S′.

If, for example, one analyzes the above combination f̂(t) or several combinations f₁̂(t), f₂̂(t), . . . , fₚ̂(t) of two or more signals s₁(t), s₂(t), . . . , sₘ(t) resp. of their transfer-functions t₁(s₁(t)), t₂(s₂(t)), . . . , tₘ(sₘ(t)) for two time intervals t₁, t₂—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for two time intervals t₁, t₂—as well as the functions S, S′ and Σ′ with

$${\sum }^{′} := {u}_{{a}^{′}}^{2} := {A}^{′} {u}_{1}^{2} + {B}^{′} {u}_{2}^{2} + {C}^{′} {u}_{3} 2 + 2 {F}^{′} {u}_{2} {u}_{3} + 2 {G}^{′} {u}_{3} {u}_{1} + 2 {H}^{′} {u}_{1} {u}_{2} = 1 * {u}_{1}^{2} + 1 * {u}_{2}^{2} + ( 1 / {g}^{″2} ) * {u}_{3}^{2} + 2 * 1 * {u}_{2} {u}_{3} + 2 * 1 * {u}_{3} {u}_{1} + 2 * 1 * {u}_{1} {u}_{2} = 0.$$

The following is true

aA′+bB′+cC′+2fF′+2gG′+2hH′=0,

and S and Σ′ should be non polar:

1*1+1*1−(1/g²)*(1/g″²)=0

or

(1/g²)*(1/g″²)=2.

Thus, provided g′=g″=1 and g=1/√2 applies, the non-polarity of S with S′ and Σ′ is ensured.

Considering the standard cone

S′=1*x₁²+1*x₂²−1*x₃²=0

thus simultaneously enables the analysis of identical vanishing invariants relative to S

S=1*x₁²+1*x₂²−2*x₃²=0

resp.

$${\sum }^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

The relation

a_{a′}²:=1*1²+1*1²−2*1²=0

is thus linear in the coefficients of the equations

$$S = 1 * {x}_{1}^{2} + 1 * {x}_{2}^{2} - 2 * {x}_{3}^{2} = 0$$

$${\sum }^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

According to Hilbert's famous theorem on invariants (Hilbert, page 291, §2), in our system, the linear combination

φ[1, 1, −2]*[1, 1, −1]²+Θ[1, 1, −2]*[1, 1, 1]²=0

in turn represents an invariant. Thus, for example, any piercing straight lines of f̂(t₁) and f̂(t₂), considered on the plane defined by the vectors (1, 1, −2) and (1, 1, 1), ξ₁ and ξ₂, correspond to an infinite number of invariants of S and S′ resp. of S and Σ′.

When considering the standard cone reflected on the complex number plane, the change of opening angle of the cone yields the cone equation

−x₁²−x₂²+(1/g*²)*x₃

resp. the coefficients [−1 −1 1/g*²]. Two cone equations are then considered:

$$S := {a}_{x}^{2} := - 1 * {x}_{1}^{2} - 1 * {x}_{2}^{2} + ( 1 / {g}^{2} ) * {x}_{3}^{2} = 0$$

$$and$$

$${S}^{′} := {a}_{x}^{′2} := - 1 * {x}_{1}^{2} - 1 * {x}_{2}^{2} + ( 1 / {g}^{′2} ) * {x}_{3}^{2} = 0.$$

It is well known that one invariant is thus:

a_{a′}²:=−1*(−1)²−1*(−1)²+(1/g²)*(1/g′⁴).

Both cones S, S′ are non polar if

(1/g²)*(1/g′⁴)=2.

S is then inscribed harmonically in S′.

If, for example, one analyzes the above combination f̂(t) or several combinations f₁̂(t), f₂̂(t), . . . , fₚ̂(t) or two or more signals s₁(t), s₂(t), . . . , sₘ(t) resp. of their transfer-functions t₁(s₁(t)), t₂(s₂(t)), . . . , tₘ(sₘ(t)) for two time intervals t₁, t₂—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for two time intervals t₁, t₂—as well as the functions S, S′ and Σ′ with

$${\sum }^{′} := {u}_{{a}^{′}}^{2} := {A}^{′} {u}_{1}^{2} + {B}^{′} {u}_{2}^{2} + {C}^{′} {u}_{3} 2 + 2 {F}^{′} {u}_{2} {u}_{3} + 2 {G}^{′} {u}_{3} {u}_{1} + 2 {H}^{′} {u}_{1} {u}_{2} = 1 * {u}_{1}^{2} + 1 * {u}_{2}^{2} + ( 1 / {g}^{″2} ) * {u}_{3}^{2} + 2 * 1 * {u}_{2} {u}_{3} + 2 * 1 * {u}_{3} {u}_{1} + 2 * 1 * {u}_{1} {u}_{2} = 0.$$

The following is true

aA′+bB′+cC′+2fF′+2gG′+2hH′=0,

and S and Σ′ should be non polar:

−1*1−1*1+(1/g²)*(1/g″²)=0

or

(1/g²)*(1/g″²)=2.

Thus, provided g′=g″=1 and g=1/√2 applies, the non-polarity of S with S′ and Σ′ is ensured.

Considering the standard cone

S′=−1*x₁²−1*x₂²+1*x₃²=0

thus simultaneously enables the consideration of identical vanishing invariants relative to S

S=−1*x₁²−1*x₂²+2*x₃²=0

resp.

$${\sum }^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

The relation

$${a}_{{a}^{′}}^{2} := - 1 * {( - 1 )}^{2} - 1 * {( - 1 )}^{2} + 2 * {1}^{2} = - 1 * 1 - 1 * 1 + 2 * 1 = 0$$

is thus linear in the coefficients of the equations

$$S = - 1 * {x}_{1}^{2} - 1 * {x}_{2}^{2} + 2 * {x}_{3}^{2} = 0$$

$$and$$

$${\sum }^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

According to Hilbert's famous theorem on invariants (Hilbert, page 291, §2), in our system, the linear combination

φ[−1, −1, 2]*[−1, −1, 1]²+Θ[−1, −1, 2]*[1, 1, 1]²=0

in turn represents an invariant. Thus, for example, any piercing straight lines of f̂(t₁) and f̂(t₂), considered on the plane defined by the vectors (−1, −1, 2) and (1, 1, 1), ξ₁ and ξ₂, correspond to an infinite number of invariants of S and S′ resp. of S and Σ′.

All combinatory possibilities for the situation of S, S′ and Σ′, as can easily be seen, are exhausted in terms of the result in the same plane.

The practical application of this fact in signal technology allows for example the analysis of a combination f̂(t) or of several combinations f₁̂(t), f₂̂(t), . . . , fₚ̂(t) of at least two signals s₁(t), s₂(t), . . . , sₘ(t) resp. of their transfer-functions t₁(s₁(t)), t₂(s₂(t)), . . . , tₘ(sₘ(t))—or also of the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) by determining said invariants. Doing this enables the function of this combination f̂(t) or of these combinations f₁̂(t), f₂̂(t), . . . , fₚ̂(t) of at least two signals s₁(t), s₂(t), . . . , sₘ(t) resp. of their transfer-functions t₁(s₁(t)), t₂(s₂(t)), . . . , tₘ(sₘ(t))—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for example on the complex number plane—the x₁ axis then coincides for example with the real axis, the x₂ axis then coincides for example with the imaginary axis—and subsequently enables the piercing points of these functions in the present example with the plane defined by the vectors (1, 1, −2) and (1, 1, 1) or (−1, −1, 2) and (1, 1, 1) to be analyzed and which now constitute absolutely or also in terms of their statistical distribution precise reference points for further analysis, processing or optimization. For example, according to CH1159/09 resp. PCT/EP2010/055876 or also CH01776/09 resp. PCT/EP2010/055877, an optimization of pseudo-stereophonic audio signals can be carried out and subsequently the piercing points of the sum of the transfer-functions f*[x(t)]=[x(t)/√ 2̅]*(−1+i) and g*[y(t)]=[y(t)/√ 2̅]*(1+i), see further below, with the plane defined by the vectors (1, 1, −2) and (1, 1, 1) or (−1, −1, 2) and (1, 1, 1) can be determined. When these piercing points are weighted by using an appropriate method, see the detailed description, it will result in parameterizations according CH1159/09 resp. PCT/EP2010/055876 or also CH01776/09 resp. PCT/EP2010/055877, which prove particularly advantageous for the audio signals being analyzed.

According to one aspect, it is recommended practice to use (inherently known) compression algorithms or data reduction methods or to analyze characteristic features such as the minima or maxima for the signals or transfer-functions or combinations or functions being analyzed, for the purpose of speeding up the evaluation thereof in accordance with the invention.

### BRIEF DESCRIPTION OF THE FIGURES

Various embodiments of the present invention are described hereinafter by way of example, with reference being made to the following drawings:

FIG. 1A shows the circuit principle of a known panoramic potentiometer.

FIG. 2A shows the attenuation curve for the left and right channels of a panoramic potentiometer without an extended stereo width range and corresponding function angles.

FIG. 3A shows a first embodiment of a device or of a method according to CH01159/09 resp. PCT/EP2010/055876, wherein the left channel L′ resp. right channel R′ resulting from the stereo decoding are each fed to a panoramic potentiometer for collective buses L and R.

FIG. 4A shows a second embodiment of a device or of a method according to CH01159/09 resp. PCT/EP2010/055876.

FIG. 5A shows a third embodiment of a device or of a method according to CH01159/09 resp. PCT/EP2010/055876.

FIG. 6A shows a fourth embodiment of a device or of a method according to CH01159/09 resp. PCT/EP2010/055876 with a circuit that is equivalent to FIG. 3A having a slightly modified MS matrix, which renders superfluous a direct downstream connection of panoramic potentiometers.

FIG. 7A shows a circuit which is equivalent to FIG. 3A resp. FIG. 6A, provided that the relation λ=ρ is true for the inversely proportional attenuations λ and ρ of the panoramic potentiometers shown in FIG. 3A.

FIG. 8A shows an enhanced circuit based on FIG. 7A for normalizing the level of the output signals from the stereo decoder.

FIG. 9A shows an example of a circuit which, as an enhancement to FIG. 8A, maps given signals x(t), y(t) as the sum of the transfer-functions f*[x(t)]=[x(t)/√Σ2]*(−1+i) and g*[y(t)]=[y(t)/√Σ2]*(1+i) on the complex number plane.

FIG. 10A shows the example of a circuit that, as an enhancement to FIG. 9A, stipulates the function width of a stereo signal.

FIG. 11A shows an example of an input circuit for an already existing stereo signal L^{o}, R^{o} prior to transfer to a circuit as shown in FIG. 12A (for determining the localization of the signal) which maps L^{o}, i.e. l(t), and R^{o}, i.e. r(t), as the sum of the transfer-functions f*[l(t)]=[l(t)/√ 2̅]*(−1+i) and g*[r(t)]=[r(t)/√ 2̅]*(1+i) on the complex number plane.

FIG. 12A shows a circuit for determining the localization of the signal, whose inputs can be connected to the outputs of FIG. 10A resp. to the outputs of FIG. 11A.

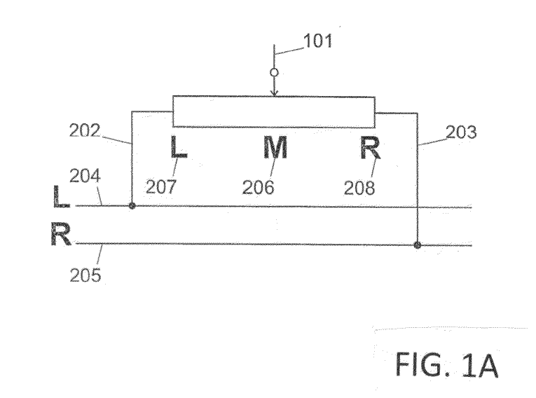

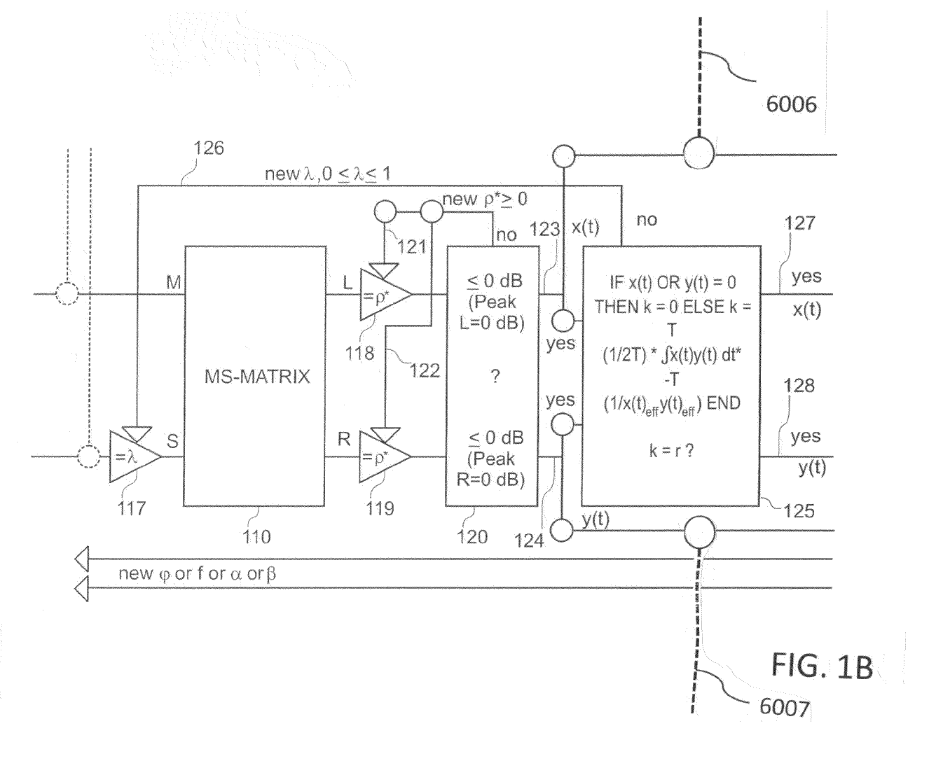

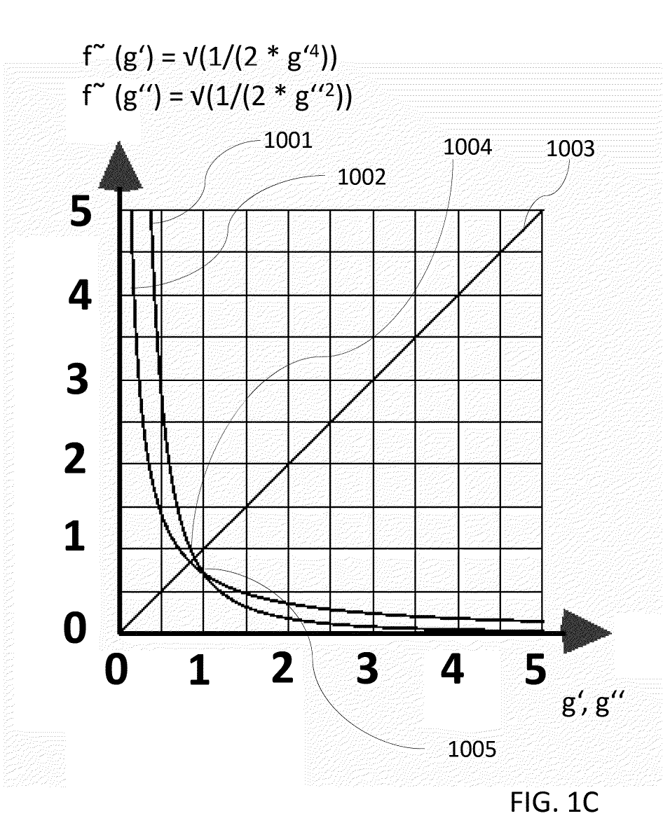

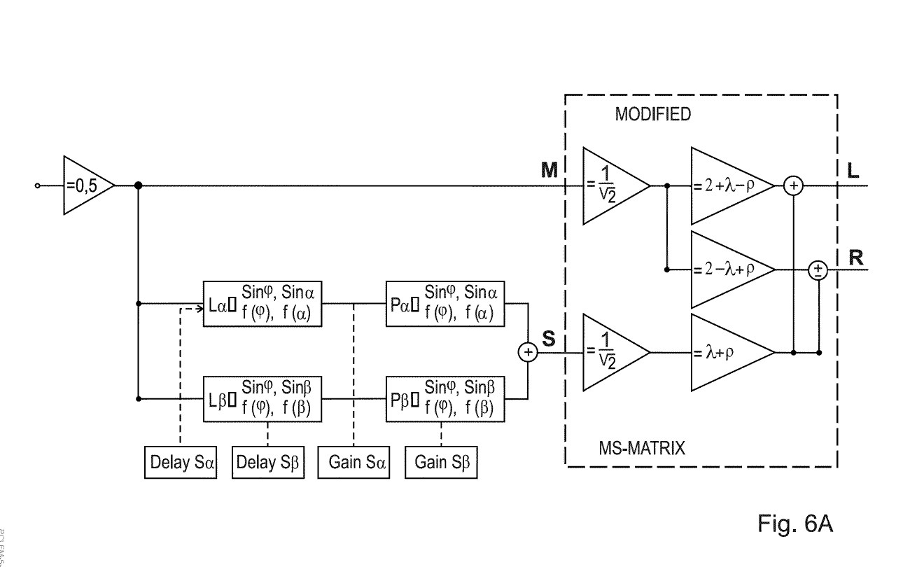

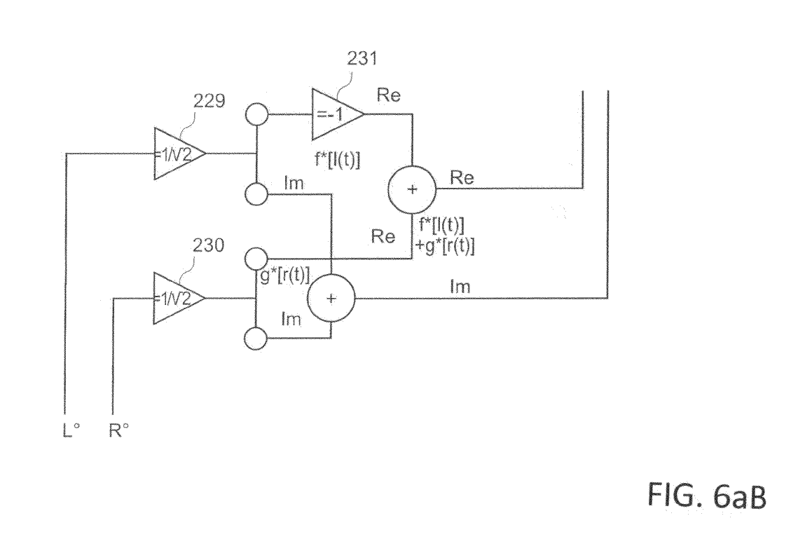

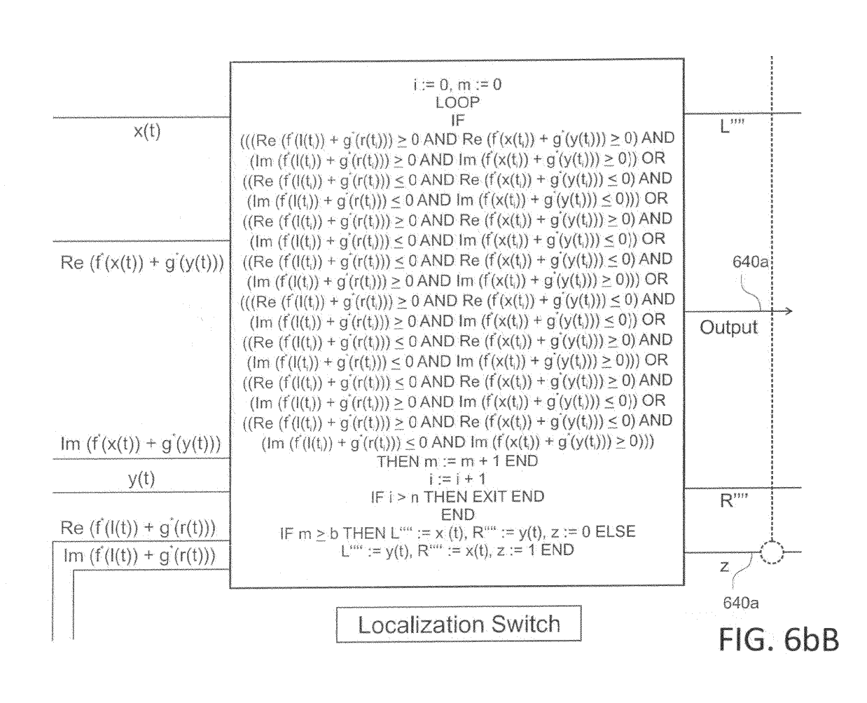

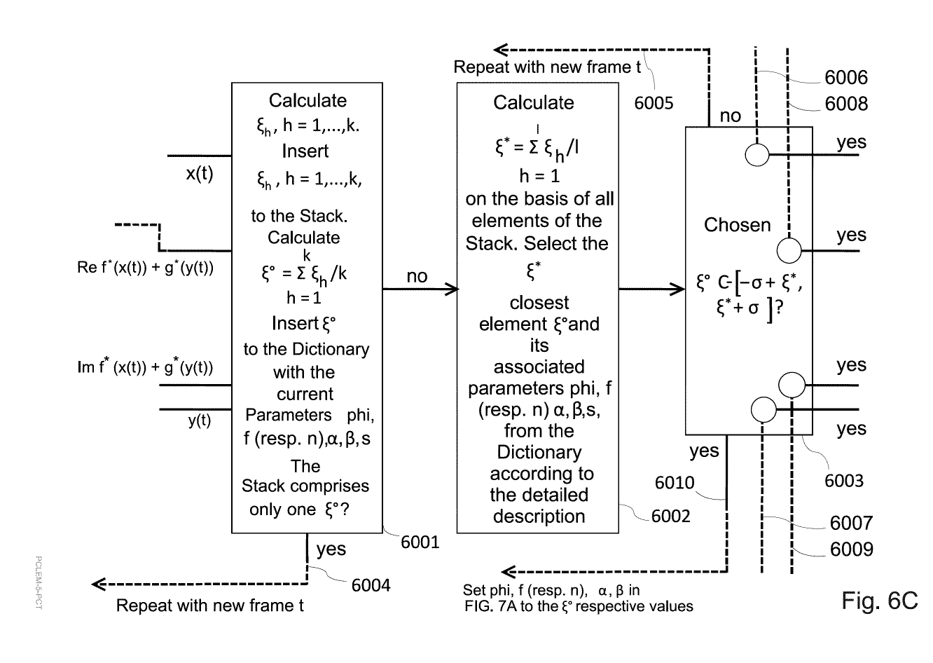

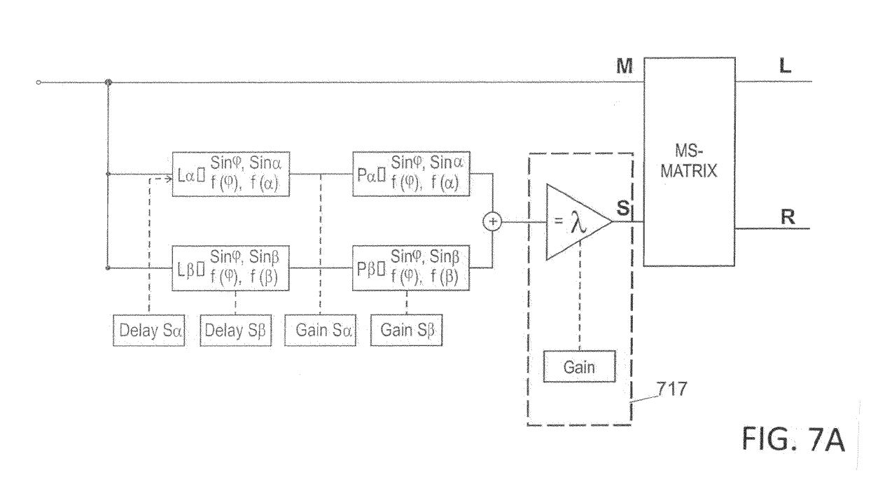

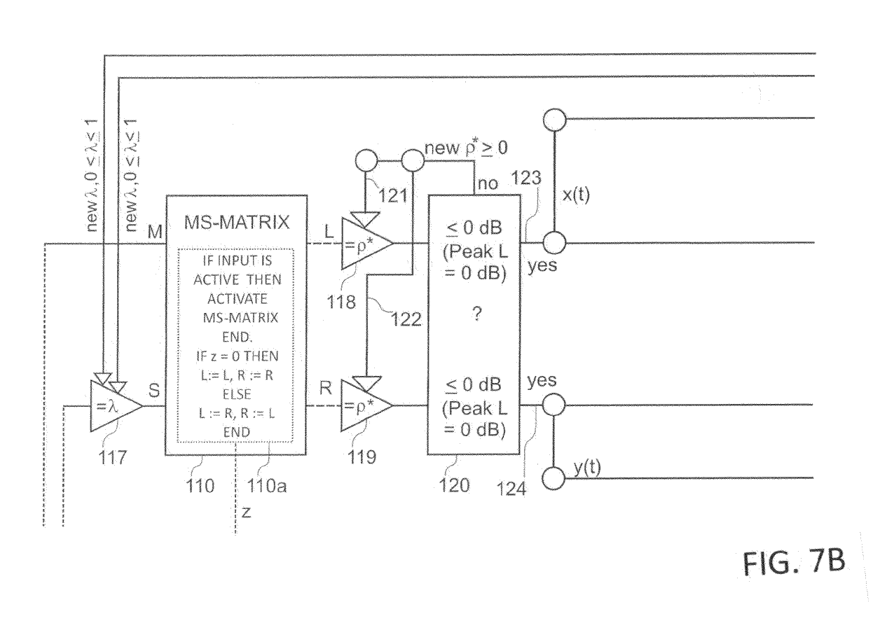

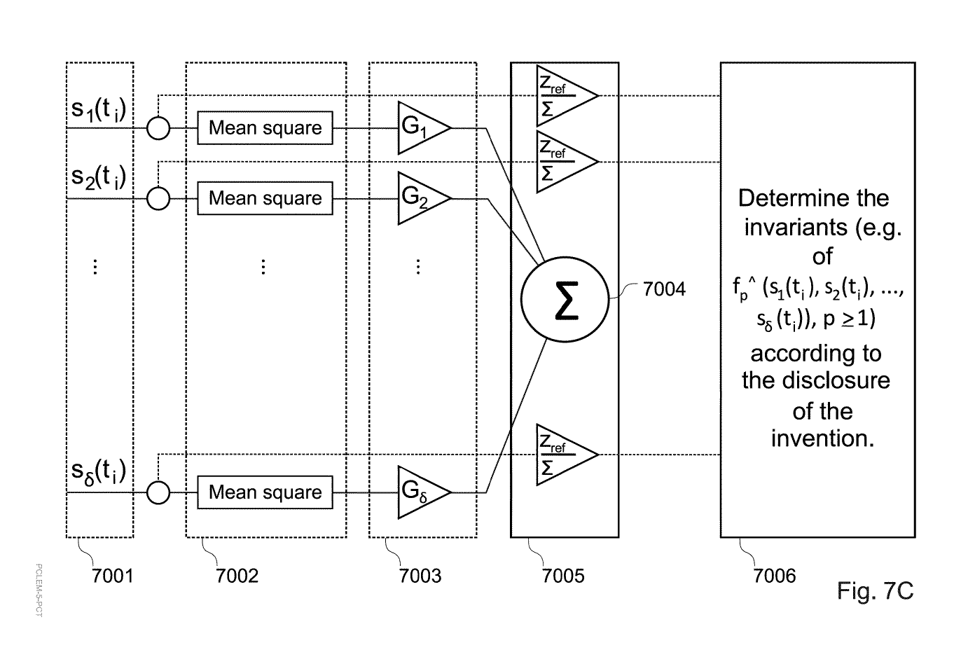

FIG. 1B shows an example of a circuit for two logic elements for normalizing the level and for normalizing the degree of correlation of the output signals from a stereo decoder (for example a stereo decoder according to EP2124486 or EP1850639), wherein the input signal M and S can (before passing through an amplifier upstream to the MS matrix) optionally be fed to a circuit according to FIG. 7B, which is optionally also connected downstream to FIG. 6b.

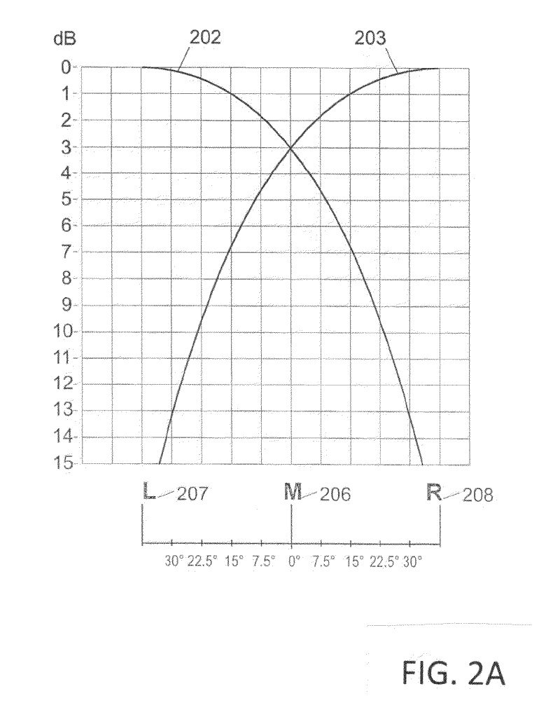

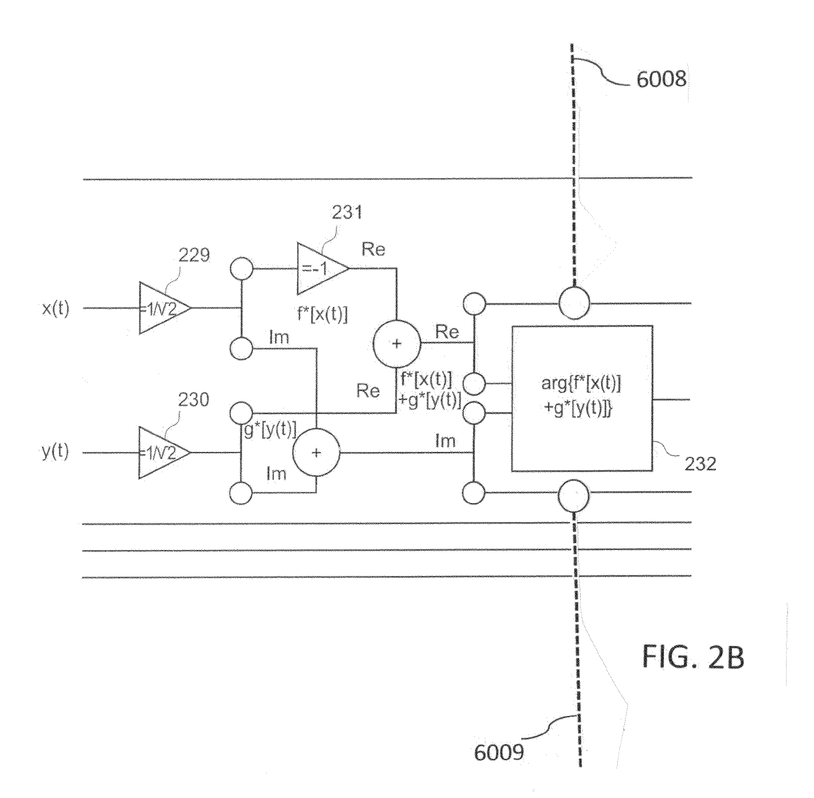

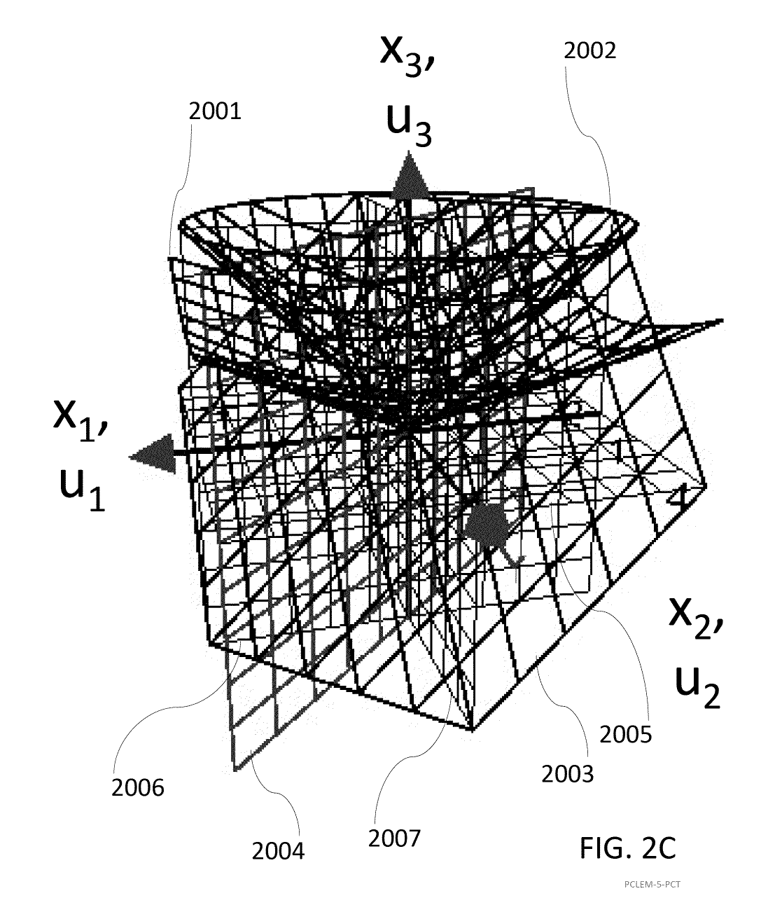

FIG. 2B shows an example of a circuit which maps given signals x(t), y(t), by using the transfer-functions f*[x(t)] and g*[y(t)], on the complex number plane, resp. ascertains the argument of the sum thereof f*[x(t)]+g*[y(t)].

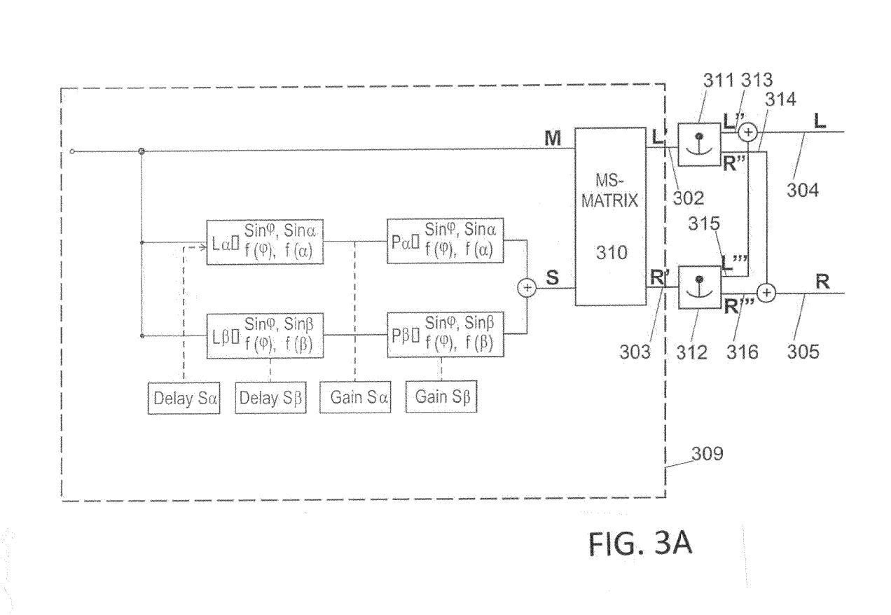

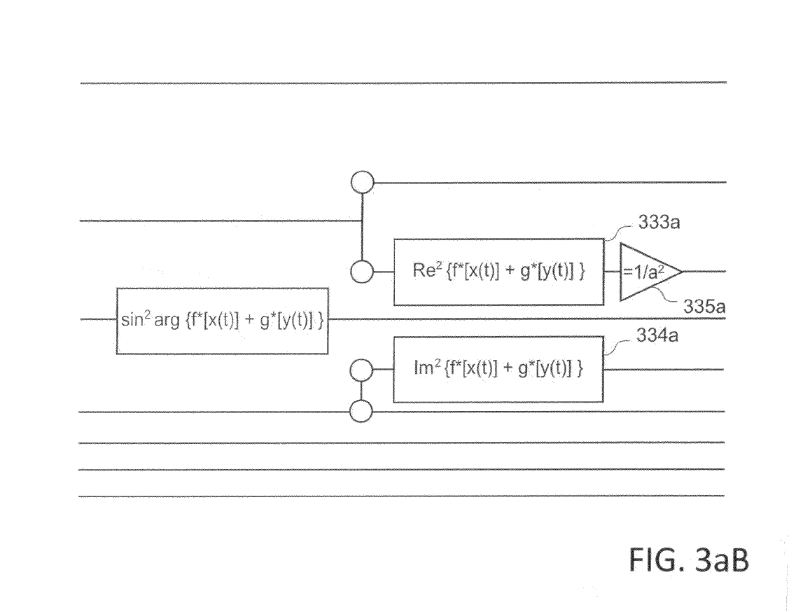

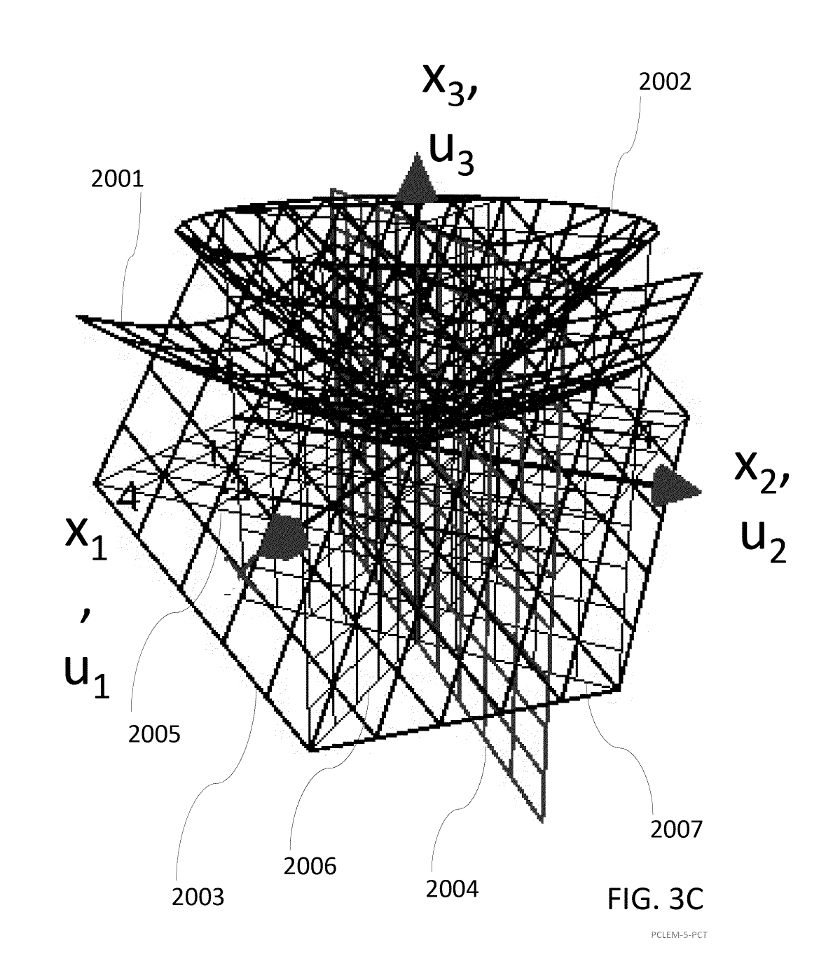

FIG. 3aB shows an example of a circuit for selecting the definition range by using the parameter a.

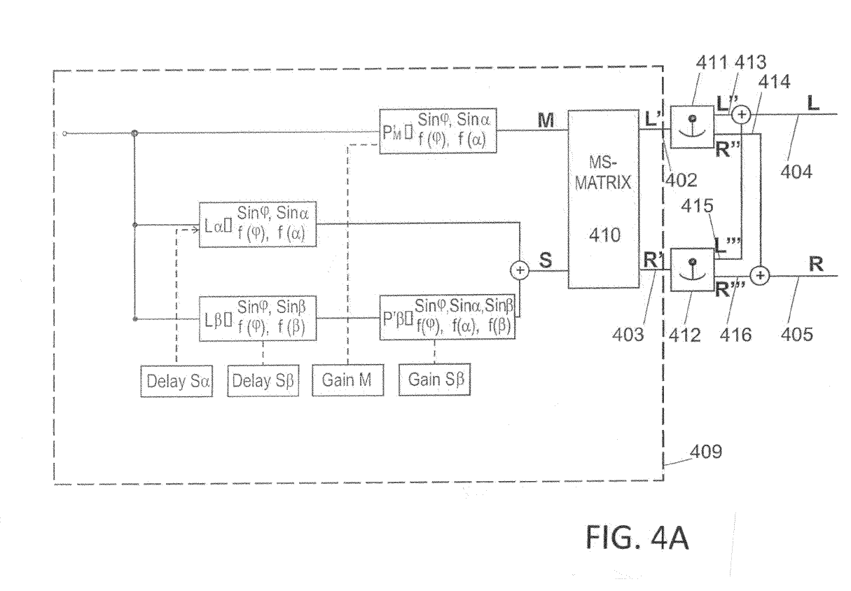

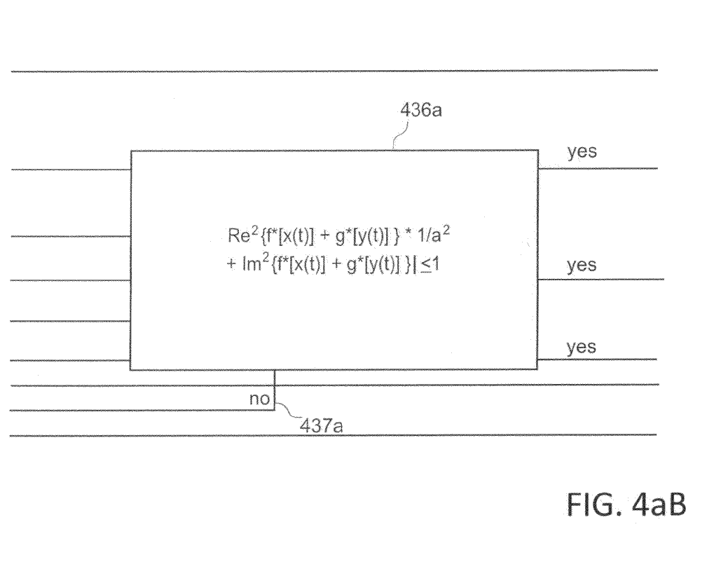

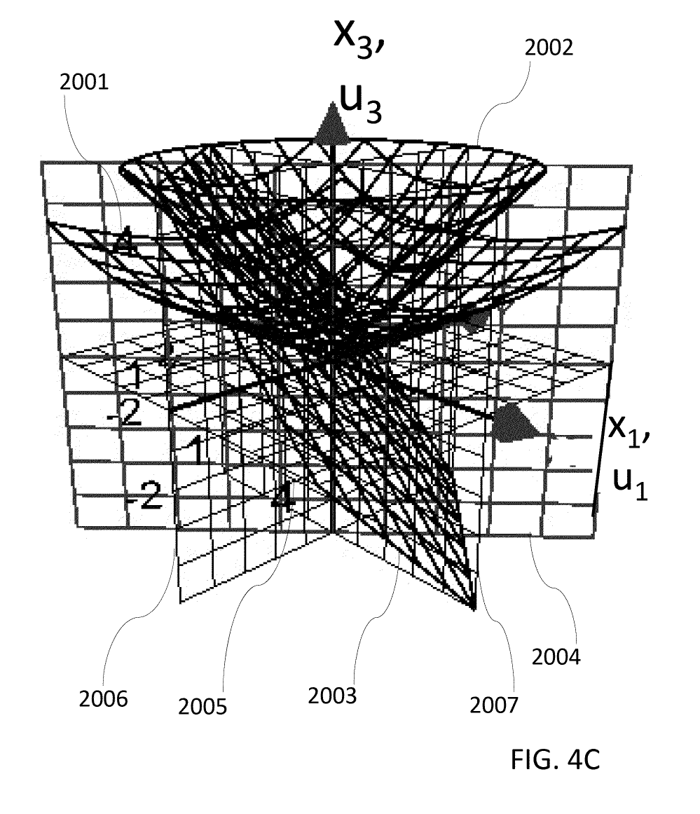

FIG. 4aB shows an example of a circuit for a third logic element which checks the signals, which are generated in FIG. 1B and which are mapped on the complex number plane as shown in FIG. 2B, in terms of the admissible definition range, defined in a new fashion according to FIG. 3aB by the parameter a, according to the constraint Re²{f*[x(t]+g*[y(t)]}*1/a²+Im²{f*[x(t]+g*[y(t)]}≦1.

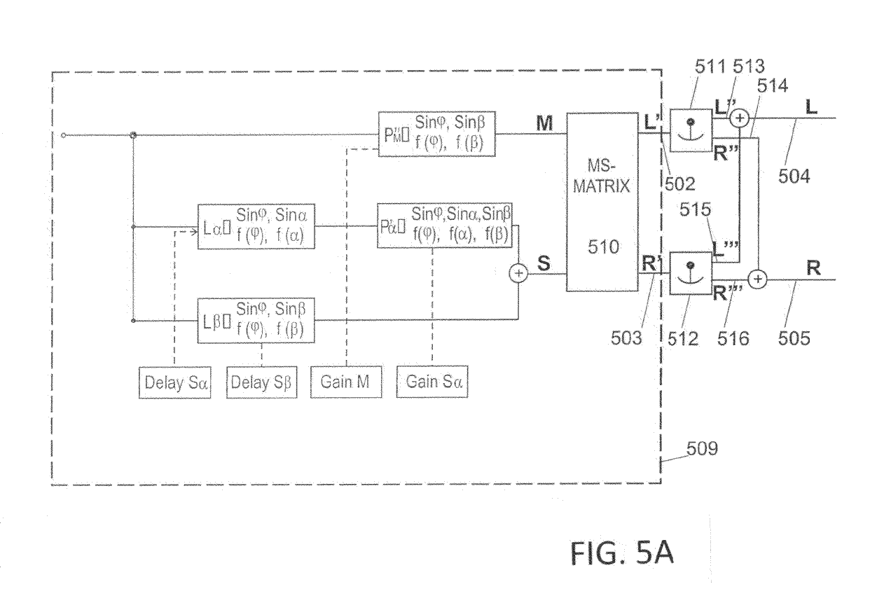

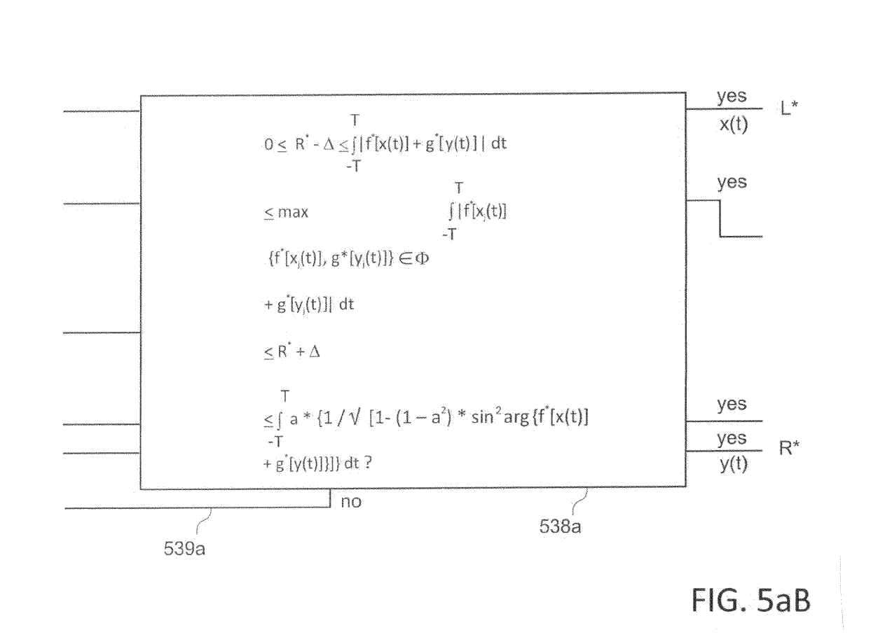

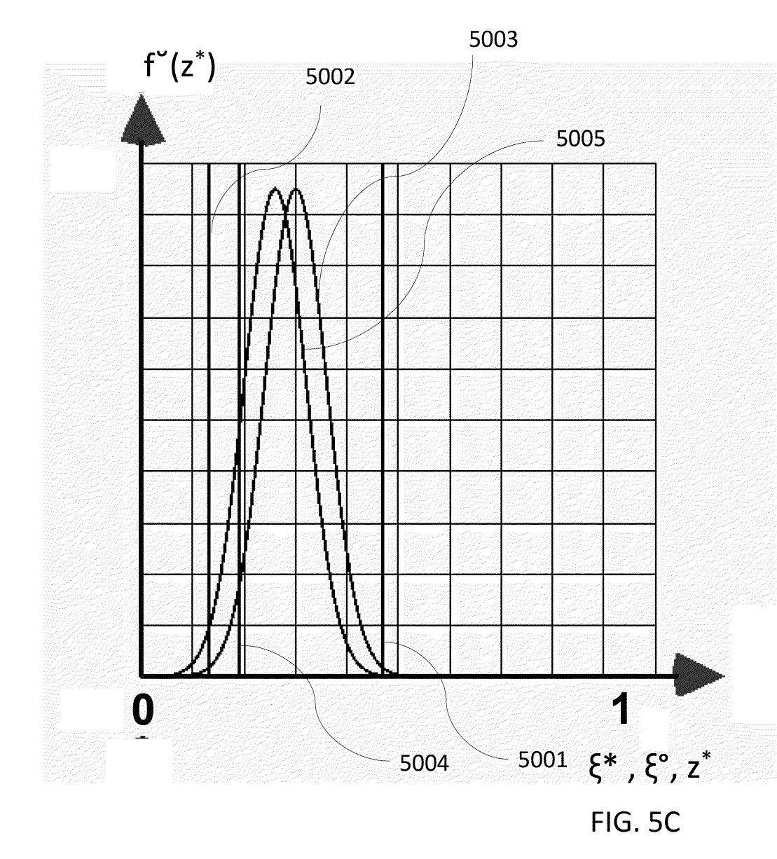

FIG. 5aB shows an example of a circuit for a fourth logic element which finally analyzes the relief of the function f*[x(t)]+g*[y(t)] for the purpose of maximizing the function-values thereof, wherein the user has a free choice of limit value R* defined by the inequality (8aB) (resp. by the deviation Δ likewise defined by the inequality (8aB)) for this maximization.

FIG. 6aB shows an input circuit for an already existing stereo signal prior to transfer to a circuit as shown in FIG. 6bB for determining the localization of the signal.

FIG. 6bB shows a circuit for determining the localization of the signal, whose inputs are connected to the outputs in FIG. 5aB resp. the outputs of FIG. 6aB.

FIG. 7B shows a further example of a circuit for normalizing stereophonic or pseudo-stereophonic signals which, when connected downstream to FIG. 6bB, is activated as soon as the parameter z is present as an input signal. In this case, the initial value of the gain factor λ corresponds to the final value of the gain factor λ in FIG. 1B when the parameter z is transferred.

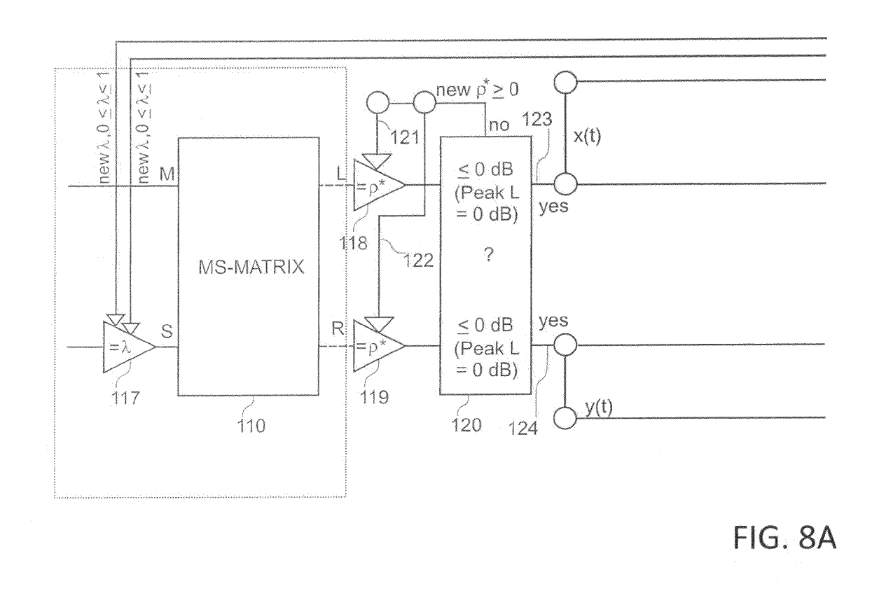

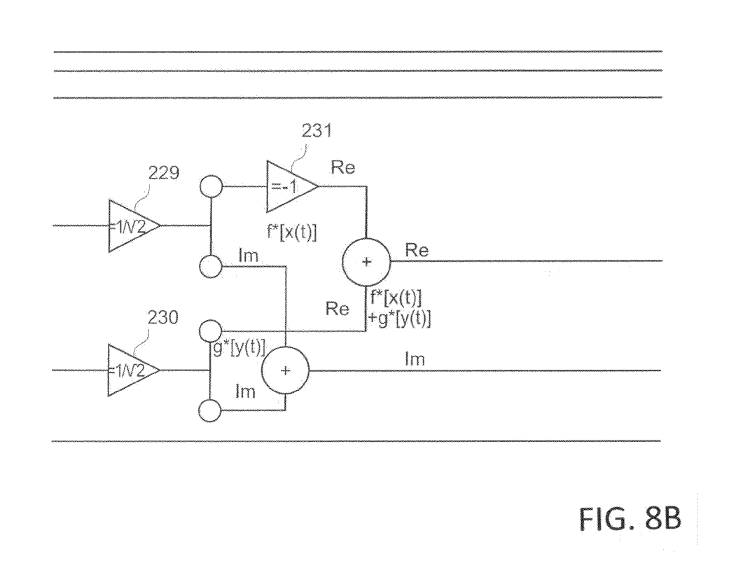

FIG. 8B shows an example of a circuit which maps given signals x(t), y(t) on the complex number plane by using the transfer-functions f*[x(t)] and g*[y(t)].

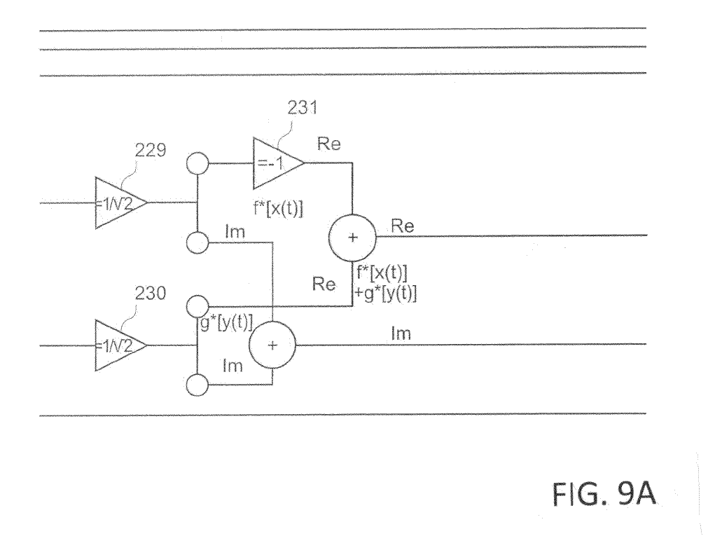

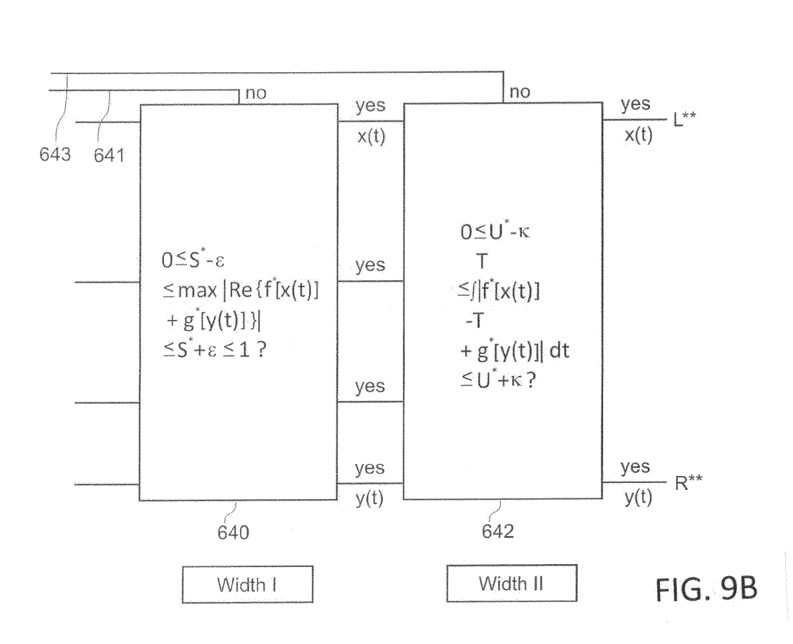

FIG. 9B shows an example of a circuit for adjusting the function width of an audio signal.

FIG. 1C shows the non-polarity constraint for the functions S, S′ and Σ′.

FIG. 2C shows the functions S, S′ and Σ′ for the Cartesian coordinate system x₁=u₁, x₂=u₂, x₃=u₃ from the perspective of the first quadrant of the corresponding complex number plane.

FIG. 3C shows the functions S, S′ and Σ′ for the Cartesian coordinate system x₁=u₁, x₂=u₂, x₃=u₃ likewise from the perspective of the first quadrant of the corresponding complex number plane.

FIG. 4C shows the functions S, S′ and Σ′ for the Cartesian coordinate system x₁=u₁, x₂=u₂, x₃=u₃ from the perspective of the fourth quadrant of the corresponding complex number plane.

FIG. 5C shows the convergence behavior of a weighting-function, which here optimizes the parameters φ, f (resp. n), α, β for example on the basis of the mean values of the inter-section points in the 1^{st} or also 3^{rd} quadrants of three pseudo-stereophonic signal sections mapped on the complex number plane with the plane defined by the vectors (1, 1, −2) and (1, 1, 1) or also (−1, −1, 2) and (1, 1, 1).

FIG. 6C shows an example of the circuit described below for optimizing pseudo-stereophonic signals on the basis of algebraic invariants, which can be directly connected downstream of FIG. 5aB, and with which it then constitutes in this example an inseparable unit. In this case, the outputs of FIG. 6C within the entire circuit schema are to be treated in such a way as if they were those of FIG. 5aB. The circuit of FIG. 6C has the effect that the elements connected upstream thereto are now passed through for various sections of audio signals. The result is an optimized parameterization φ, f, α, β on the basis of the mean values of the intersection points in the 1^{st} or also 3^{rd} quadrant of these signal sections mapped on the complex number plane with the plane defined by the vectors (1, 1, −2) and (1, 1, 1) or also (−1, −1, 2) and (1, 1, 1).

FIG. 7C shows an example of a circuit which, on the basis of the determination of the mean square energy of the input signals s₁(tᵢ), s₂(tᵢ), . . . , s_{δ}(tᵢ) and of the definable weightings G₁, G₂, . . . G_{δ}, performs a normalization of these input signals and subsequently determines the invariants of a combination f̂(t) or of several combinations f₁̂(t), f₂̂(t), . . . , fₚ̂(t) of these input signals.

### DETAILED DESCRIPTION

The algebraic principles of the present invention will first be explained with the aid of FIGS. 1C to 4C.

FIG. 1C shows the non-polarity constraint for S and S′ resp. S and Σ′. Reference number 1001 illustrates that for S and S′, expressed by f^{˜}(g′), 1002 illustrates that for S and Σ′, expressed by f^{˜}(g″). The intersection point 1004 of 1001 with the diagonal of the 1^{st} quadrant 1003 illustrates the coinciding of S and S′, the intersection point 1005 of 1001 and 1002 illustrates the sought non-polarity constraint itself; g′=g″=1 can be read directly.

FIG. 2C shows the functions S (2001), S′ (2002) and Σ′ (2003) as well as the plane 2004 defined by the vectors (1, 1, −2) and (1, 1, 1), on which the sought algebraic invariants of S and S′ resp. of S and Σ′ are located, from the perspective of the 1^{st} quadrant of the corresponding complex number plane. 2005, 2006 and 2007 show the planes defined by the Cartesian coordinate system x₁=u₁, x₂=u₂, x₃=u₃.

FIG. 3C shows the functions S (2001), S′ (2002) and Σ′ (2003) as well as the plane 2004 defined by the vectors (1, 1, −2) and (1, 1, 1), on which the sought algebraic invariants of S and S′ resp. of S and Σ′ are located, likewise from the perspective of the 1^{st} quadrant of the corresponding complex number plane. 2005, 2006 and 2007 show the planes defined by the Cartesian coordinate system x₁=u₁, x₂=u₂, x₃=u₃.

FIG. 4C shows the functions S (2001), S′ (2002) and Σ′ (2003) as well as the plane 2004 defined by the vectors (1, 1, −2) and (1, 1, 1), on which the sought algebraic invariants of S and S′ resp. of S and Σ′ are located, from the perspective of the 4^{th} quadrant of the corresponding complex number plane. 2005, 2006 and 2007 show the planes defined by the Cartesian coordinate system x₁=u₁, x₂=u₂, x₃=u₃.

It is general knowledge that audio signals that are emitted via two or more loudspeakers provide the listener with a spatial impression, provided that they show different amplitudes, frequencies, time resp. phase differences or are reverberated appropriately.

Such decorrelated signals can firstly be generated by differently positioned sound transducer systems, the signals from which are optionally post-processed, or can be generated by means so-called pseudo-stereophonic techniques, which—on the basis of a mono signal—produce such suitable decorrelation.

CH01159/09 resp. PCT/EP2010/055876, at the time of the present application, have not been published. Hereinafter, their contents will therefore be reproduced in full for a better understanding of the following examples of application of the present invention:

Some pseudo-stereophonic signals show increased “phasiness”, that is to say distinctly perceptible time differences between both channels. Frequently, the degree of correlation between both channels also is too low (lack of compatibility) or too high (undesirable convergence towards a mono sound). Pseudo-stereophonic signals, but also stereophonic signals, may therefore show deficiencies due to lacking or excessive decorrelations between the emitted signals.

It is thus an aim of CH01159/09 resp. PCT/EP2010/055876 to solve this problem and to align or inversely to differentiate more strongly stereophonic (including pseudo-stereophonic) signals.

It is another aim to improve, generate, transmit, convert and reproduce stereophonic and pseudo-stereophonic audio signals.

In CH01159/09 resp. PCT/EP2010/055876, these problems are solved inter alia by means of the ostensibly not purposeful downstream connection of a panoramic potentiometer in a device for pseudo-stereo conversion.

Panoramic potentiometers (also called pan pots or panoramic controllers) are known per se and are used for intensity stereophonic signals, i.e. for stereo signals which differ exclusively in terms of their levels but not in terms of time resp. phase differences or different frequency spectra. The circuit principle of a known panoramic potentiometer is represented in FIG. 1A. The device has an input 101 and two outputs 202, 203 which are connected to the buses 204, 205 for the group channels L (left audio channel) and R (right audio channel). In the center position (M), both buses receive the same level; in the side positions to the left (L) and to the right (R), the signal is routed only to the left bus or to the right bus, respectively. In the intermediate positions, a panoramic potentiometer produces level differences corresponding to the different positions of the phantom source on the loudspeaker base.

FIG. 2A shows the attenuation curve for the left channel and the right channel of a panoramic potentiometer without an extended stereo width range, and corresponding function angles. In the center position, the attenuation in each channel is 3 dB, the acoustic convolution thereby producing the same perception of sound level as would be if there was only one channel in the L or R position.

Panoramic potentiometers are able as voltage dividers for example to distribute the left channel in a different, selectable ratio to the resulting left output resp. right output (these outputs are also called buses) or, in the same way, to distribute the right channel in a different, selectable ratio to the same left output resp. right output (the same buses). Therefore, in the case of intensity stereophonic signals, the function width can be narrowed and the direction of such signals can be shifted.

In the case of pseudo-stereophonic signals, which make use of time resp. phase differences, different frequency spectra or reverberation (and also in the case of stereo signals of such kind in general), such narrowing of the function width resp. shifting of the function direction are not possible by using a panoramic potentiometer. The application of panoramic potentiometers to such signals is therefore appropriately disregarded as a matter of principle.

However, as represented in CH01159/09 resp. PCT/EP2010/055876, it has been observed unexpectedly and contrary to experience to date that the previously unknown downstream connection of a panoramic potentiometer downstream to a circuit for pseudo-stereo conversion affords unexpected advantages. Although such downstream connection cannot result in the aforementioned narrowing of the function width or in the shifting of the function direction of the stereo signals obtained, the degree of correlation between the left signal and the right signal can however be increased or also decreased in this way by using such a panoramic potentiometer.

In a preferred embodiment, a panoramic potentiometer is connected downstream respectively to the left output and to the right output of the circuit for obtaining a pseudo-stereophonic signal. In this case, the buses of both panoramic potentiometers are preferably used collectively and preferably identically.

In this arrangement, each panoramic potentiometer has an input and two outputs. The input of a first panoramic potentiometer is connected to a first output of the circuit, and the input of a second panoramic potentiometer is connected to a second output of this circuit. The first output of the first panoramic potentiometer is connected to the first output of the second panoramic potentiometer. The second output of the first panoramic potentiometer is connected to the second output of the second panoramic potentiometer.

Alternatively and equivalently, rather than using panoramic potentiometers, the degree of correlation can also be adjusted by using a first circuit for pseudo-stereo decoding with a stereo decoder and an amplifier connected upstream of the stereo decoder for amplifying an input signal of the stereo decoder, this being achieved without panoramic potentiometer. An equivalent adjustment of the degree of correlation can therefore be implemented with even fewer components.

Alternatively and equivalently, rather than using a panoramic potentiometer, the degree of correlation can also be varied by using a second circuit, this being achieved with a modified stereo decoder which contains an adder and a subtractor in order to add respectively subtract input signals (M, S), which are respectively amplified by predetermined factors, in order to generate signals which are identical to the bus signals from the panoramic potentiometers. An equivalent adjustment of the degree of correlation can therefore be implemented with even fewer components.

The invention can also be applied to devices or methods that generate signals which are reproduced by more than two loudspeakers (for example surround sound systems belonging to the prior art).

FIGS. 3A to 5A show various embodiments of the circuit principle described above, in which a panoramic potentiometer 311 and 312, 411 and 412, 511 and 512, respectively, is connected directly downstream to a pseudo conversion circuit 309, 409 resp. 509. In each example shown here, the pseudo conversion circuit 309, 409 resp. 509 comprises a circuit having an MS matrix 310, 410 resp. 510, as described in WO/2009/138205 resp. EP2124486 as well as in EP1850639.

This panoramic potentiometer 311 and 312, 411 and 412, 511 and 512 can be used to increase or decrease the degree of correlation of the resulting buses L 304, 404, 504 and R 305, 405, 505. Accordingly, the left channel L′ 302, 402, 502 and the right channel R′ 303, 403, 503 resulting from the stereo decoding are fed each to a panoramic potentiometer for collectively used buses L and R.

If the attenuation λ for the left input signal L′ of the panoramic potentiometer 311, 411 or 511 and the attenuation ρ for the right input signal R′ of the panoramic potentiometer 312, 412, 512 for a stereo signal 302 and 303, 402 and 403, 502 and 503 resulting from a device 309, 409 or 509 is limited to the range between 0 and 3 dB, the inversely proportional relations

1≧λ≧0

and

1≧ρ≧0

may be introduced (where 1 corresponds to the value 0 dB and 0 corresponds to the value 3 dB).

λ and ρ therefore correspond to the inversely proportional attenuations of the panoramic potentiometers shown in FIG. 3A to FIG. 5A, limited to the range between 0 and 3 dB.

Therefore, the following relations are obtained for the resulting stereo signals (buses) L and R (304 and 305, 404 and 405, 504 and 505) resp. the output signals L″ 313, 413, 513 and R″ 314, 414, 514 from the panoramic potentiometer 311, 411, 511 and the output signals L′″ 315, 415, 515 and R′″ 316, 416, 516 from the panoramic potentiometer 312, 412, 512:

L=L″+L′″=½*L′(1+λ)+½*R′(1−ρ) (1A)

and

R=R″+R′″=½*L′(1−λ)+½*R′(1+ρ) (2A)

FIG. 6A shows a further embodiment with a circuit equivalent to FIG. 3A having a slightly modified MS matrix, which renders direct downstream connection of panoramic potentiometers superfluous. Taking into account the equivalences of the stereo decoding (MS matrixing)

L′=(M+S)*1/√ 2̅

and

R′=(M−S)*1/√ 2̅

the following relations are obtained:

L=[M(2+λ−ρ)+S(λ+ρ)]*½√ 2̅ (1A)

R=[M(2−λ+ρ)−S(λ+ρ)]*½√ 2̅ (2A)

This allows the signals on the buses L and R to be also derived directly from the input signals M and S of the stereo decoding circuit.

If λ=ρ (same attenuation in the left channel and in the right channel), the following relations are true:

L=(M+λ*S)*1/√ 2̅ (3A)

R=(M−λ*S)*1/√ 2̅ (4A)

i.e. the variation in the amplitude of the signal S is equivalent to the downstream connection of a respective panoramic potentiometer for identical attenuation in the left channel and in the right channel. Under these assumptions, the output signals L and R correspond to the bus signals L and R in FIG. 3A.

This will therefore yield a circuit or a method showing for example the form in FIG. 6A (trivial modifications being possible), which forms a composite signal from the M signal, amplified by the factor (2+λ−ρ), and the S signal, amplified by the factor (λ+ρ), as well as a difference signal which is compiled from the M signal, amplified by the factor (2−λ+ρ), minus the S signal, amplified by the factor (λ+ρ), with correction by the factor ½√Σ2 needing to be performed overall in order to obtain signals L and R equivalent to the formulae (1A) and (2B).

FIG. 7A shows a circuit equivalent to FIG. 3A resp. FIG. 6A, provided that the relationship λ=ρ is true for the inversely proportional attenuations λ and ρ of the panoramic potentiometers shown in FIG. 3A. This circuit should not be confused with the arrangement known from intensity stereophony (MS microphone technique) for altering the recording or opening angle (which does not take place here!).

In this case, it is assumed that uniform attenuation for proposed panoramic potentiometers or modified MS matrix, as just illustrated, is frequently sufficient for aligning or differentiating stereo signals. When λ=ρ, the device just illustrated is then simplified on the basis of the above formulae (3A) and (4A) according to:

L=(M+λ*S)*1/√ 2̅ (3A)

R=(M−λ*S)*1/√ 2̅ (4A)

which is equivalent to a simple amplitude correction of the S signal (717).

Such an amplitude correction for the S signal has been known to date only for the classical MS microphone technique and in the ideal range results in the alteration of the recording or opening angle in that case, which does not take place here. A transfer of the same operating principle is not possible (and an application of the MS microphone technique to the present circuit is accordingly not obvious).

In FIG. 7A, the S signal is therefore additionally amplified by the factor λ (1≧λ≧0) prior to finally passing through the MS matrix. The resulting stereo signal is equivalent to the bus signals 304 and 305 in FIG. 3A, 404 and 405 in FIGS. 4A and 504 and 505 in FIG. 5A for uniform attenuation and also to the output signal L and R in FIG. 6A, provided that λ=ρ is true in that case.

In practice, this circuit resp. method can be used to exactly stipulate the degree of correlation, i.e. there is a direct functional relationship between the attenuation λ and the degree of correlation r, for which ideally

0.2≦r≦0.7

is true. For λ, a series of experiments has found

0.07≦λ≦0.46

to be favorable for most applications.

In particular, artifacts (such as disturbing time differences, phase shifts, or the like) can be eliminated without difficulty by using this device or method, whether manually or automatically (algorithmically).

On the basis of the equivalence of downstream panoramic potentiometers with uniform attenuation and amplitude correction of the S signal by the factor λ (1≧λ≧0) prior to final MS matrixing, it is therefore possible to achieve convincing pseudo-stereophony which, on the basis of the original mono signal, grants the listener a comprehensive, albeit extremely simple, post-processing option, while fundamentally maintaining the compatibility and avoiding disturbing artifacts.

This device can be used for example in telephony, in the field of professional post-processing of audio signals or else in the area of high-quality electronic consumer goods, the aim of which is extremely simple but efficient handling.

For narrowing or expanding the function width:

For this application, the additional use of prior art compression algorithms or data reduction methods or the analysis of characteristic features, such as the minima or maxima for the pseudo-stereophonic signals obtained is recommended in order to speed up evaluation thereof in accordance with the invention.

Of particular interest (for example for reproducing stereophonic signals in automobiles) is the subsequent narrowing or expanding of the function width of the stereo signal obtained by using the specific variation of the degree of correlation r of the resulting stereo signal resp. the attenuations λ or else ρ (for forming the resulting stereo signal). The previously determined parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β can be retained in this case, and it makes sense that now only a final amplitude correction is necessary, for example as per the logic element 120 in FIG. 8A, provided that this narrowing or expanding of the function width is performed manually.

If this is to be automated, series of psychoacoustic experiments show that a constant function width for stereophonic output signals x(t), y(t) resp. complex transfer-functions thereof

f*[x(t)]=[x(t)/√ 2̅]*(−1+i) (5A)

g*[y(t)]=[y(t)/√ 2̅]*(1+i) (6A)

is essentially dependent on the criterion

0≦S*−ε≦max |Re{f*[x(t)]+g*[y(t)]}|≦S*+ε≦1 (7A)

and also on the criterion

$$0 \leq {U}^{*} - κ \leq {\int }_{- T}^{T} \vert \{ {f}^{*} [ x ( t ) ] + {g}^{*} [ y ( t ) ] \} \vert d t \leq {U}^{*} + κ \qquad ( 8 A )$$

(where S* and ε or, respectively, U* and κ need to be stipulated differently for telephone signals, for example, than for music recordings). Accordingly, it is now necessary to determine only suitable function-values x(t), y(t) which are dependent on the degree of correlation r of the resulting stereo signal respectively on the attenuations λ or else ρ (for the formation of the resulting stereo signal) resp. on a logic element 120 in FIG. 8A, in accordance with an iterative operating principle which is based on feedback.

The represented arrangement can accordingly be enhanced as follows within the context of an arrangement for example in the form shown in FIG. 8A to 10A:

An output signal resulting from an arrangement as shown in FIG. 1A to 7A is in this case amplified uniformly by a factor ρ*(amplifiers 118, 119 in FIG. 8A) such that the maximum of both signals has a level of exactly 0 dB (normalization on the unit circle of the complex number plane). By way of example, this is achieved by the downstream connection of a logic element 120 which varies or corrects the gain factor ρ* of the amplifiers 118 and 119 via the feedback loops 121 and 122 until the maximum level for the left channel and for the right channel is 0 dB.

In a further step, the resulting signals x(t) (123) and y(t) (124) are now fed to a matrix in which, following respective amplification by the factor 1/√2 (amplifiers 229, 230 in FIG. 9), they are split into a respective identical real and imaginary part, with the real part formed from the signal x(t), amplified by means of 229, additionally passing through the amplifier 231 with the gain factor −1. This therefore yields the transfer-functions

f*[x(t)]=[x(t)/√ 2̅]*(−1+i) (5A)

and

g*[y(t)]=[y(t)/√ 2̅]*(1+i) (6A)

The respective real and imaginary parts are now summed and therefore produce the real part resp. the imaginary part of the sum of the transfer-functions f*[x(t)]+g*[y(t)].

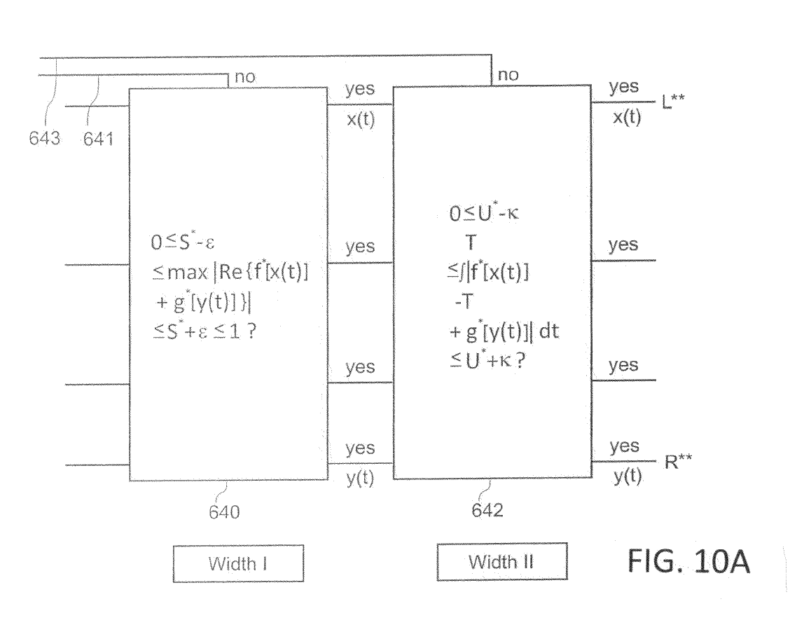

An arrangement, for example based on the logic element 640 in FIG. 10A, now needs to be connected downstream, which arrangement checks, for a limit value S*—suitably selected by the user with respect to the function width of the stereo signal that is to be achieved—or a suitably selected deviation ε—both defined by the inequality (7A)—whether the condition

0≦S*−ε≦max |Re{f*[x(t)]+g*[y(t)]}|≦S*+ε≦1 (7A)

is met. If this is not the case, a feedback loop 641 is used to determine a new optimized value for the degree of correlation r resp. for the attenuations λ or else ρ (for the formation of the resulting stereo signal), and the previous steps just described, as illustrated in FIG. 8A to 10A, are performed until the above condition (7A) is fulfilled.

The input signals for the logic element 640 are now transferred to an arrangement, for example based on the logic element 642 in FIG. 10A. Such arrangement finally analyzes the relief of the function f*[x(t)]+g*[y(t)] for the purpose of optimizing the function-values in terms of the function width of the stereo signal that is to be achieved, the user being able to suitably select the limit value U* as well as the deviation κ, both defined by the inequality (8A), with respect to the function width of the stereo signal that is to be achieved. Overall, the condition

0≦U*−κ≦∫|f*[x(t)]+g*[y(t)]|dt≦U*+κ

must be met. If this is not the case, a feedback loop 643 is used to determine a new optimized value for the degree of correlation r resp. for the attenuations λ or else ρ (for the formation of the resulting stereo signal), and the previous steps just described, as illustrated in FIG. 8A to 10A, are performed until the relief of the function f*[x(t)]+g[*y(t)] satisfies the desired optimization of the function-values with respect to the function width taking into account the limit value U* and the deviation κ, both suitably chosen by the user.

In terms of the function width—determined by the degree of correlation r resp. the attenuations λ or else ρ (for the formation of the resulting stereo signal)—the signals x(t) (123) and y(t) (124) therefore correspond to the specifications by the user and represent the output signals L** and R** from the arrangement which has just been described.

The present considerations remain valid as an entity even if a different reference system than the unit circle of the imaginary plane is chosen. By way of example, instead of normalizing function-values, it is also possible to normalize the axis length in order to reduce the computing time accordingly.

Stipulation of the Function Direction

Occasionally, it is also important to mirror the stereophonic function obtained about the main axis of the directional pattern on which the stereophonic processing is based, since, for instance, mirror inverted function in relation to the main axis occurs. This can be achieved manually by swapping the left channel and the right channel.

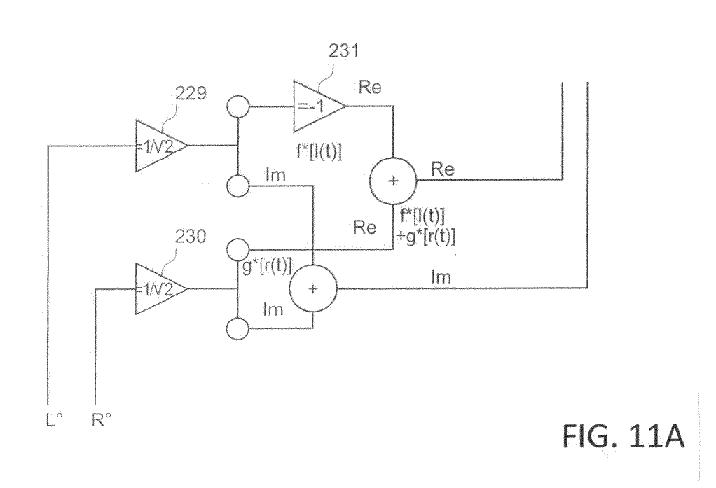

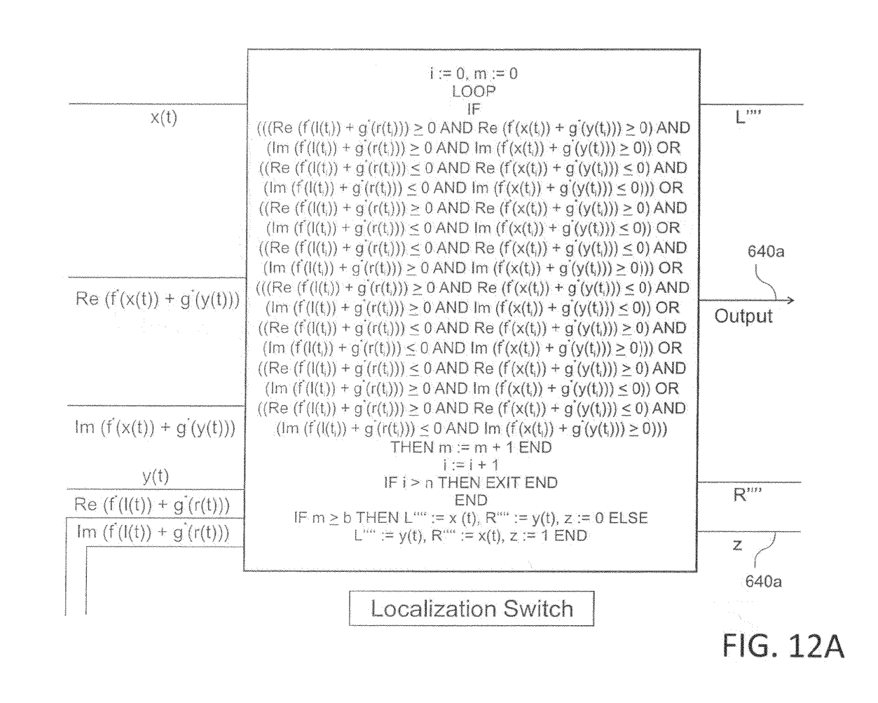

If an already existing stereo signal L^{o}, R^{o} is to be mapped by the present system, the correct function direction can also be ascertained automatically by means of the phantom sources generated using the illustrated pseudo-stereophonic methodology, as is shown by way of example in FIG. 12A (which is directly connected downstream with FIG. 10A, whereas FIG. 11A may likewise be added to FIG. 12A for determining the sum of the complex transfer-functions f*(l(tᵢ))+g*(r(tᵢ)) for the already existing stereo signal L^{o}, R^{o}; cf. the explanations relating to FIG. 9A). In this case, at suitably chosen times tᵢ (for which not all of the subsequently cited correlating function-values of the transfer-functions f*(x(tᵢ))+g*(y(tᵢ) resp. f*(l(tᵢ))+g*(r(tᵢ)) may be equal to zero for at least one case), the already ascertained transfer-function f*(x(tᵢ))+g*(y(t_{I})) as shown in FIG. 9A is compared with the transfer-function f*(l(tᵢ))+g*(r(tᵢ)) of the left signal l(t) resp. right signal r(t) of the original stereo signal L^{o}, R^{o}. If these transfer-functions range in the same quadrant or in the diagonally opposite quadrant of the complex number plane, the total number m of function-values from said transfer-functions which are located in the same quadrant or in the diagonally opposite quadrant of the complex number plane is increased by 1 in each case.

An empirically (or statistically determined) specifiable number b, which should be less than or equal to the number of correlating function-values of the transfer-functions f*(x(tᵢ))+g*(y(t_{I}) resp. f*(l(tᵢ))+g*(r(tᵢ)) unequal to zero, now stipulates the number of necessary matches. Below this number, the left channel x(t) and the right channel y(t) of the stereo signal resulting, for example, from an arrangement as shown in FIG. 8A-10A are swapped.

If an originally stereophonic signal is to be encoded into a mono signal plus the function f describing the directional pattern (resp. the simplifying parameter n of said function) and likewise plus the parameters φ, α, β, λ or ρ (for example for the purpose of data compression) (for an exemplary output 640a which may be enhanced by the parameter z, see below), it makes sense to jointly encode the information regarding whether the resulting left channel and the resulting right channel need to be swapped (for example expressed by the parameter z, which takes the value 0 or 1).

With slight modifications, similar circuits to the circuits shown in FIGS. 11A and 12A can be constructed which can be connected directly downstream with FIG. 3A or 4A or 5A or 6A or 7A or else can be used at another location within the electrical circuit or algorithm.

For obtaining stable FM stereo signals by using CH01159/09 resp. PCT/EP2010/055876 by way of example for the evaluation of an existing stereo signal which can be reproduced by two or more loudspeakers:

CH01159/09 resp. PCT/EP2010/055876 is also of particular importance in connection with obtaining stable FM stereo signals under bad reception conditions (for example in automobiles). In this case, it is possible to achieve stable stereophony by simply using the main channel signal (L+R) as an input signal, which is the sum of the left and right channel of the original stereo signal. The complete or incomplete sub-channel signal (L−R), which is the result of subtracting the right channel from the left channel of the original stereo signal, can also be used in this case in order to form a useable S signal or in order to determine or optimize the parameters f (resp. n), which describe the directional pattern of the signal that is to be rendered stereophonic as well as the angle φ that is to be ascertained manually or by metrology and is enclosed by the main axis and the sound source, the fictitious left opening angle α, the fictitious right opening angle β, the attenuations λ or else ρ for the formation of the resulting stereo signal or, resulting therefrom, the gain factor ρ* for normalizing the left channel and the right channel, resulting from the MS matrixing (for example determined in a similar fashion to the logic element 120 as shown in FIG. 8A) or from another arrangement on the unit circle (in this case 1 corresponds to the maximum level of 0 dB which has been normalized by using ρ*, where x(t) is the left output signal resulting from this normalization and y(t) is the right output signal resulting from this normalization) or the degree of correlation r of the resulting stereo signal or the parameter a, for example defined by the inequality (9aA) below for defining the admissible range of values for the sum of the transfer-functions of the resulting output signals (for example said complex transfer-functions

f*[x(t)]=[x(t)/√ 2̅]*(−1+i) (5A)

and

g*[y(t)]=[y(t)/√ 2̅]*(1+i) (6A)

where, for 0≦a≦1 for example the following is true:

Re²{f*[x(t]+g*[y(t)]}*1/a²+Im²{f*[x(t]+g*[y(t)]}≦1) (9aA)

or the limit value R*, defined by the inequality (11aA) below, or the deviation Δ, likewise defined by the inequality (11aA) below for stipulating or maximizing the absolute value of the function-values of the sum of these transfer-functions (where, for this stipulation or maximization and for the time interval [−T, T] resp. the total number of possible output signals xⱼ(t), yⱼ(t), the following for example is true:

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ x j ( t ) ] \{ {f}^{*} [ x j ( t ) ] , {g}^{*} [ y j ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t ) \qquad ( 11 aA )$$

or the limit value S* defined above or the deviation ε defined above (for which, by way of example, it must be true that

0≦S*−ε≦max |Re{f*[x(t)]+g*[y(t)]}|≦S*+ε≦1) (7A)

or the limit value U* defined above or the deviation κ defined above (for which, by way of example, it must be true that

$$0 \leq {U}^{*} - κ \leq {\int }_{- T}^{T} \vert {f}^{*} [ x ( t ) ] + {g}^{*} [ y ( t ) ] \vert d t \leq {U}^{*} + κ ) , \qquad ( 8 A )$$

all for determining the function width of the stereo signal to be achieved, or the function direction of the reproduced sound sources in accordance with the arrangement described above. In any case, the result is stereophonic function which is constant in respect of the FM signal.

In particular, the use of compression algorithms or data reduction methods which belong to the prior art resp. the analysis of characteristic features, such as the minima or maxima, is also recommended in this case in order to speed up the evaluation of stereophonic or pseudo-stereophonic signals according to the criteria described above.

CH01776/09 resp. PCT/EP2010/055877 at the time of the present application have not been published. Hereinafter, their contents will therefore be reproduced in full for a better understanding of the following examples of application of the present invention:

In the case of the configuration according to EP2124486, according to EP1850639 and/or according to CH01159/09 resp. PCT/EP2010/055876, different parameters may be chosen in the stereo decoder and which are used to generate pseudo-stereophonic signals. Though often several parameters or several sets of parameters may be used in order to obtain pseudo-stereophonic audio signals, the choice of such parameters has an impact on the perceived spatial sound image. The choice of the parameters which are optimum in a certain condition or for a particular audio signal is however not trivial.

Furthermore, the adjustment of the parameters also frequently has an impact on the degree of correlation between the left channel and the right channel. In the context of CH01776/09 resp. PCT/EP2010/055877, however, it has been found that it would make sense to stipulate a uniform degree of correlation for the evaluation of different parameterizations for φ resp. f (resp. the simplifying parameter n), α, β.

An aim therein is to provide a new method and a new device for obtaining pseudo-stereophonic signals resp. a new method and a new device for automatically and optimally choosing such parameters which form the basis for the generation of stereophonic or pseudo-stereophonic signals, resp. a method and a device for optimally and automatically determining particularly the parameters (φ, λ, ρ resp. f (resp. n), α, β) while generating said stereophonic or pseudo-stereophonic signals.

Such a method resp. such a device are intended to be used to select, from a plurality of decorrelated, in particular pseudo-stereophonic, signal variants, those whose decorrelation is found to be particularly advantageous.

In particular, it should be possible to influence the selection criteria themselves in a form as efficient and compact as possible in order to be able to convert signals of different nature (for example speech in contrast to music recordings) into the optimized reproduction thereof.

According to one aspect, CH01776/09 resp. PCT/EP2010/055877 propose a device and a method for obtaining pseudo-stereophonic output signals x(t) and y(t) by using a stereo decoder, wherein x(t) is the function-value of the resulting left output channel at the time t, and y(t) is the function-value of the resulting right output channel at the time t, in which the obtainment is iteratively optimized until <x(t), y(t)> is within a pre-determined definition range.

If there are dropouts or similar defects, however, an insignificant quantity of single points may lie outside the definition range. In this case, the obtainment is iteratively optimized until a portion of <x(t), y(t)> is within the pre-determined definition range.

The desired definition range is preferably stipulated by a single numerical parameter a, where preferably 0≦a≦1. This parameter and hence the definition range can be usefully stipulated for example by the inequality

Re²{f*[x(t]+g*[y(t)]}*1/a²+Im²{f*[x(t]+g*[y(t)]}≦1

wherein the relations

f*[x(t)]=[x(t)/√ 2̅]*(−1+i)

and

g*[y(t)]=[y(t)/√ 2̅]*(1+i)

apply for the complex transfer-functions f*[x(t)] and g*[y(t)]} of the output signal x(t), y(t).

The user can arbitrarily stipulate such a definition range, on the basis of the unit circle of the complex number plane resp. of the imaginary axis (if the maximum level of the output signal x(t), y(t) has been normalized on the unit circle), by using the parameter a, 0≦a≦1.

This principle also remains valid when a reference system other than the unit circle of the complex number plane is chosen and a different new definition range is defined. “Definition range” is therefore understood generally to mean an admissible range of values for <x(t), y(t)> of the output signal x(t), y(t), which, overall, is intended to contain <x(t), y(t)> in full or in part (for example in the case of defective sound recordings which show what are known as dropouts).

In a preferred variant embodiment, the degree of correlation of the output signals (x(t) and y(t)) is normalized. In a preferred variant embodiment, the level of the maximum of the resulting left and right channel is normalized. In this way, certain parameters can be iteratively optimized in order to attain the desired definition range, without said parameters affecting the degree of correlation or the level of the maximum of the resulting left channel and right channel.

It also makes sense if—for extremely different parameterizations for φ resp. f (resp. n), α, β—criteria which are dependent on |<x(t), y(t)>| are used for the stipulation. For this purpose, according to the invention, a corresponding range of values dependent on |<x(t), y(t)>| is normalized, so as to constitute a criterion for the optimization of the parameters.

In one embodiment, a method for obtaining pseudo-stereophonic output signals x(t) and y(t) by using a converter is therefore proposed, wherein x(t) is the function-value of the resulting left output channel at the time t, wherein y(t) is the function-value of the resulting right output channel at the time t, wherein the complex transfer-functions f*[x(t)] and g*[y(t)] of the output signals are defined:

f*[x(t)]=[x(t)/√ 2̅]*(−1+i)

g*[y(t)]=[y(t)/√ 2̅]*(1+i)

in which the obtaining is iteratively optimized until the following criterion is satisfied:

Re²{f*[x(t]+g*[y(t)]}*1/a²+Im²{f*[x(t]+g*[y(t)]}≦1,

where 0≦a≦1 stipulates the desired definition range.

A remarkable aspect of the methods for obtaining pseudo-stereophonic signals according to WO/2009/138205 resp. EP2124486 or according to EP1850639 is the fact that they always provide a perfect mid-signal. For this reason, the short time cross correlation

$$r = ( 1 / 2 T ) * {\int }_{- T}^{T} x ( t ) y ( t ) d t * ( 1 / {x ( t )}_{eff} {y ( t )}_{eff} ) \qquad ( 1 B )$$

is introduced here for the time interval [−T, T] and the output signals x(t) from the left channel and y(t) from the right channel.

As already mentioned, it makes sense if a uniform degree of correlation is attained for extremely different parameterizations for φ resp. f (resp. n), α, β. For this purpose, according to the invention, the degree of correlation between the output signals (x(t) and y(t)) is normalized. This normalization can preferably be stipulated by means of the specific variation of λ (left attenuation) or ρ (right attenuation).

On the basis of the uniform degree of correlation, the signal attained can now be systematically subjected to evaluation criteria that can be influenced by the user.

It also makes sense if a uniform level for the maximum of the resulting left and right channel is being attained for extremely different parameteriza-tions for φ resp. f (resp. n), α, β. For this purpose, in the represented system, the level of the maximum of the resulting left and right channel is normalized, so that this level is not influenced by the optimization of the parameters.

It makes sense, for example, for the modulation for the maximum of the left signal L and of the right signal R to initially be uniformly confined for example to 0 dB by means of a first logic element.

It also makes sense if—for extremely different parameterizations for φ resp. f (resp. n), α, β—criteria which are dependent on |<x(t), y(t)>| are used for the stipulation. For this purpose, according to the invention, a corresponding range of values is normalized, so as to constitute a criterion for the optimization of the parameters.

x(t) and y(t) are mapped within the unit circle of the complex number plane. The function f*[x(t)]+g*[y(t)] can now be analyzed in more detail in order to draw conclusions concerning the quality of the respective output signal from a device according to WO/2009/138205 resp. EP2124486 or EP1850639, for example. Any decorrelation between the two signals f*[x(t)] and g*[y(t)] is in this case equivalent to a deflection on the real axis when analyzing the function f*[x(t)]+g*[y(t)].

The stereo decoder is therefore optimized according to said criteria for example for |Re{f*[x(t)]+g*[y(t)]}| and for |Im{f*[x(t)]+g*[y(t)]}|.

This method has proven itself to be particularly advantageous, since a single parameter, namely a, takes optimum account of, in particular, the different nature of the output signals from a device or a method according to WO/2009/138205 resp. EP2124486 or EP1850639. The parameter may preferably be dependent on the type of the audio signal, for example in order to process speech or music differently on a manual or automatic basis. In the case of speech, unlike music recordings, the definition range determined by the parameter a preferably needs to be restricted significantly due to disturbing artifacts such as high frequency sidetones during the articulation.

In addition, given the limitation to a single parameter a, any optimum function range can be chosen for f*[x(t)]+g[*y(t)] based on the unit circle resp. the imaginary axis.

If the signals x(t), y(t) do not satisfy the aforementioned conditions, the invention involves optimization being carried out by re-determining the parameters φ or f (resp. n) or α or β—according to an iterative procedure that is matched with the function-values x[t(φ, f, α, β)] and y[t(φ, f, α, β)] resp. x[t(φ, n, α, β)] and y[t(φ, n, α, β)]—whilst executing steps described so far until x(t) and y(t) meet the aforementioned conditions.

In a further step, the relief of the function f*[x(t)]+g*[y(t)] for example is now analyzed for the purpose of maximizing the function-values thereof. It is possible to show that this procedure is equivalent to the maximization of

$${\int }_{- T}^{T} \vert {f}^{*} [ x ( t ) ] + {g}^{*} [ y ( t ) ] \vert d t \qquad ( 6 B )$$

this expression, for its part, remains less than or equal to the value of

$${\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t . \qquad ( 7 aB )$$

In this case too, the user is provided with a tool insofar as he has a free choice of the limit value R* (or the deviation Δ defined by the inequality (8aB), see below) for this maximization within the context of (8aB). Overall, the following condition must be met for the total number of possible signal variants xⱼ(t), yⱼ(t):

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * sin 2 arg \{ {f}^{*} [ x ( t ) ] + {g}^{*} [ y ( t ) ] \} ] \} d t \qquad ( 8 aB )$$

R* and Δ are directly related to the loudness of the output signal that is to be attained (i.e. to those parameters which the listener also takes as a basis for assessing the validity of a stereophonic function).

If the neighborhood of the limit value R*, defined by Δ, or the maximum of all possible integrated reliefs is not reached, optimization in terms of the limit value R* and the deviation Δ or in terms of the aforementioned maximum—in accordance with an iterative procedure that is matched with the function-values x[t(φ, f, α, β)] and y[t(φ, f, α, β)] resp. x[t(φ, n, α, β)] and y[t(φ, n, α, β)]—involves new parameters φ resp. f resp. α resp. β being determined, and all steps described so far being executed until signals x(t), y(t) resp. parameters φ resp.λ resp.ρ resp.f (resp. n) resp. α resp. β result, which correspond to optimum stereophonization.

With an appropriate choice of the degree of correlation r, of the parameter a—stipulating the desired respective definition range—and of the limit value R*and also deviation Δ thereof, it is possible to configure optimum systems for the respective area of application (for example speech or music reproduction) for the respective nature of the input signals.

The present considerations remain valid as an entity even if a different reference system than the unit circle of the imaginary plane is chosen. By way of example, instead of normalizing function-values, it is also possible to normalize the axis length in order to reduce the computing time accordingly.

According to one aspect, it is recommended practice to use (inherently known) compression algorithms or data reduction methods or to analyze characteristic features such as the minima or maxima for the pseudo-stereophonic signals obtained according to WO/2009/138205 resp. EP2124486 or EP1850639, for the purpose of speeding up the evaluation thereof.

Instead of the proposed analysis of |<x(t), y(t)>|, it is also possible to use |<x(t), y(t)>|² for optimizing the stereophonization. The computing time is significantly reduced as a result.

CH01776/09 resp. PCT/EP2010/055877 can incidentally be applied to devices or methods that generate stereophonic signals which are reproduced by more than two loudspeakers (for example surround sound systems belonging to the prior art).

According to one aspect, CH01776/09 resp. PCT/EP2010/055877 proposes the cascaded downstream connection of a plurality of means (for example logic elements), some of the parameters of which can be aligned, with a stereo decoder (for example according to WO/2009/138205 resp. EP2124486 or EP1850639), wherein feedback for said devices or methods involves the parameters φ resp. λ resp. ρ resp. f (resp. n) esp. α resp. β being changed in an optimized way until all conditions of the logic elements are met.

These means (logic elements) can incidentally be arranged differently, and can even—with restrictions—be omitted completely or in part.

For a stereo decoder, for example in a device according to WO/2009/138205 resp. EP2124486 or EP1850639—for the case of identical inversely proportional attenuations λ and ρ—optimized parameters φ, λ, f (resp. the simplifying parameter n), α, β are to be determined in order to convert a mono signal into corresponding pseudo-stereophonic signals which have optimum decorrelation and loudness (the two criteria according to which the listener assesses the quality of a stereo signal). The intent is to achieve such determination with as few technical means as possible.

FIG. 1B shows the circuit principle for the first two logic elements, as described, for normalizing the level and for normalizing the degree of correlation of the output signals from a stereo decoder with an MS matrix 110 (for example a stereo decoder according to WO/2009/138205 resp. EP2124486 or EP1850639), wherein the input signal M and S can (prior to passing through an amplifier connected upstream to the MS matrix) optionally be fed to a circuit according to FIG. 7B, which is optionally and ideally connected downstream to FIG. 6bB, and is activated as soon as the parameter z resulting from FIG. 6bB has been determined (see below).

The first logic element 120 for normalizing the level is in this case coupled to two identical amplifiers having the gain factor ρ* and ensures a modulation, showing the maximum of 0 dB, of the left channel L and the right channel R.

The signals L and R resulting from the arrangement 110 (for example an MS matrix according to WO/2009/138205 resp. EP2124486 or EP1850639) are amplified uniformly by the factor ρ* (amplifiers 118, 119) in such a way that the maximum of both signals has a level of exactly 0 dB (normalization on the unit circle of the complex number plane). This is achieved for example by the downstream connection of a logic element 120 which uses the feedbacks 121 and 122 and variation or correction of the gain factor ρ* of the amplifiers 118 and 119 to cause a modulation of the maximum value of L and R to reach 0 dB.

The resulting stereo signals x(t) (123) and y(t) (124), the amplitudes of which are directly proportional to L and R, are fed in a second step to a further logic element 125 which determines the degree of correlation r by using the short time cross relation:

$$r = ( 1 / 2 T ) * {\int }_{- T}^{T} x ( t ) y ( t ) d t * ( 1 / {x ( t )}_{eff} {y ( t )}_{eff} ) \qquad ( 1 B )$$

r can be stipulated by the user in the interval −1≦r≦1 and ideally ranges in the interval 0.2≦r≦0.7.

Any deviation from r results in optimized adjustment of the gain factor λ of the amplifier 117 for the S signal via the feedback 126.

The resulting signals L and R again pass through the amplifiers 118 and 119 and also the logic element 120, which in turn causes a fresh modulation of the maximum value of L and R to reach 0 dB again via the feedbacks 121 and 122, and said signals are then fed to the logic element 125 again.

This procedure is performed in an optimized way until the degree of correlation r stipulated by the user has been attained.

The result is a stereo signal x(t), y(t) normalized in relation to the unit circle of the complex number plane.

FIG. 2B clarifies the circuit principle which maps the input signals x(t), y(t) on the complex number plane resp. determines the argument of the sum thereof f*[x(t)]+g*[y(t)]. With this circuit, the resulting signals x(t) and y(t) from the output of FIG. 1B are fed to a matrix in which, following respective amplification by the factor 1/√ 2̅ (amplifiers 229, 230), said signals are broken down into respective identical real and imaginary parts, with the real part formed from the signal x(t), amplified by means of 229, additionally passing through the amplifier 231 with the gain factor −1. Therefore, the transfer-functions:

f*[x(t)]=[x(t)/√ 2̅]*(−1+i) (2B)

and

g*[y(t)]=[y(t)/√ 2̅]*(1+i) (3B)

are obtained.

The respective real and imaginary parts are now summed and therefore produce the real part and the imaginary part of the sum of the transfer-functions f*[x(t)]+g*[y(t)].

The element 232 determines the argument for f*[x(t)]+g*[y(t)].

FIG. 3aB enables the definition range to be selected by means of the parameter a, 0≦a≦1, wherein continuous regulation is made possible by means of the parameter a, on the basis of the unit circle of the complex number plane resp. of the imaginary axis. The user can therefore freely determine the definition range determined by the parameter a on the complex number plane within the unit circle. For this, the squared real part (333a) and the squared imaginary part (334a) of f*[x(t)]+g*[y(t)] are calculated. The signal resulting from 333a is then fed to an amplifier 335a and is amplified by the gain factor 1/a² freely selectable by the user. Additionally, the squared sine of the argument of the sum of the transfer-functions f*[x(t]+g*[y(t)] is calculated.

FIG. 4aB, which is to be connected downstream at the output of FIG. 3aB, shows the circuit principle for a new third logic element, which checks the signals generated in FIG. 1B and mapped on the complex number plane according to FIG. 2B, according to the condition

Re²{f*[x(t]+g*[y(t)]}*1/a²+Im²{f*[x(t]+g*[y(t)]}≦1 (4aB)

The squared real part and squared imaginary part of the sum of the transfer-functions f*[x(t)]+g*[y(t)] and the signals resulting from 334a and 335a are in this case fed to a further logic element 436a, which checks whether the above criterion is satisfied, hence whether the values of the sum of the transfer-functions f*[x(t)]+g*[y(t)] are within the new range of values defined by the user by means of a.

If this is not the case, a feedback 437 is used to determine new optimized values φ resp. f (resp. n) resp. α resp. β, and the entire system described so far is passed through again until the values of the sum of the transfer-functions f*[x(t)]+g*[y(t)] are within the new srange of values defined by the user by means of a. The output signals for the logic element 436a are now transferred to the last logic element 538a (FIG. 5aB).

The latter finally analyzes the relief of the function f*[x(t)]+g*[y(t)] for the purpose of maximizing the function-values, wherein the user has a free choice of limit value R* determined by the inequality (8aB) (and of deviation Δ, likewise determined by the inequality (8aB)) for this maximization. Overall, the condition:

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t \qquad ( 8 aB )$$

must be met. If this is not the case, a feedback 539a is used to iteratively determine new optimized values φ resp. f (resp. n) resp.αresp.β, and the entire system described so far is passed through again until the relief of the function f*[x(t)]+g*[y(t)] satisfies the desired maximization of the function-values taking into account the limit value R* resp. the deviation Δ, both defined by the user.

Hence, the original pseudo-stereo converter, for example according to one of the embodiments in in WO/2009/138205 resp. EP2124486 or EP1850639 (in this case assuming the instance of identical inversely proportional attenuations λ and ρ), is used to iteratively determine new parameters φ resp. f (resp. n) resp. α resp. β until x(t) and y(t) meet the aforementioned conditions (4aB) and (8aB).

In terms of compatibility (determined by the selectable degree of correlation r), definition range (determined by the selectable gain factor a) and loudness (determined by the selectable limit value R* resp. the selectable deviation Δ), the signals x(t) (123) and y(t) (124) therefore correspond to the selections by the user and are the output signals L and R* from the arrangement described.

Stipulation of the Function Direction:

Occasionally, it is also important to mirror the stereophonic function obtained about the main axis of the directional pattern on which the stereophonic processing is based, since for example mirror inverted function in relation to the main axis occurs. This can be achieved manually by swapping the left channel and the right channel.

If an already existing stereo signal L^{o}, R^{o} is to be mapped by the present system, the correct function direction can also be ascertained automatically by means of the phantom sources generated using the illustrated pseudo-stereophonic methodology, as is shown by way of example in FIG. 6bB (which is directly connected downstream to FIG. 5aB, whereas FIG. 6aB may likewise be added to FIG. 6bB for determining the sum of the complex transfer-functions f*(l(tᵢ))+g*(r(tᵢ)) for the already existing stereo signal L^{o}, Rₒ). In this case, at suitably chosen times tᵢ (for which not all of the subsequently cited correlating function-values of the transfer-functions f*(x(tᵢ))+g*(y(tᵢ) resp. f*(l(tᵢ))+g*(r(tᵢ)) may be equal to zero for at least one case), the already ascertained transfer-function f*(x(tᵢ))+g*(y(t_{I})) as shown in FIG. 2B is compared with the transfer-function f*(l(tᵢ))+g*(r(tᵢ)) of the left signal l(t) resp. of the right signal r(t) of the original stereo signal L^{o}, R^{o} (which transfer-function is ascertained by using the circuit shown in FIG. 6aB, the design of which corresponds to the first part of the circuit for the input signals x(t), y(t) in FIG. 2B). If these transfer-functions range in the same quadrant or in the diagonally opposite quadrant of the complex number plane, the total number m of the function-values from the cited transfer-functions which are located in the same quadrant or in the diagonally opposite quadrant of the complex number plane is increased by 1 in each case.

An empirically (or statistically determined) specifiable number b, which should be less than or equal to the number of correlating function-values of the transfer-functions f*(x(tᵢ))+g*(y(t_{I}) resp. f*(l(tᵢ))+g*(r(tᵢ)) unequal to zero, now stipulates the number of necessary matches. Below this number, the left channel x(t) and the right channel y(t) of the stereo signal resulting for example from an arrangement as shown in FIG. 1B, 2B, 3aB to 5aB are swapped.

If an originally stereophonic signal is to be encoded into a mono signal plus the function f describing the directional pattern (resp. the simplifying parameter n of said function) and likewise the parameters φ, α, β, λ or ρ (for example for the purpose of data compression) (for an exemplary output 640a which may be enhanced by the parameter z, see below), it makes sense to jointly encode the information regarding whether the resulting left channel is to be swapped with the resulting right channel (for example expressed by the parameter z, which takes the value 0 or 1, and, if desired, can simultaneously activate a circuit as shown in FIG. 7B).

With slight modifications, similar circuits to the circuits shown in FIG. 6aB and 6bB can be constructed which can also be used at another location within the electrical circuit or algorithm.

For Narrowing or Expanding the Function Width:

For this application too, the additional use of prior art compression algorithms or data reduction methods or the analysis of characteristic features, such as the minima or maxima for the pseudo-stereophonic signals obtained is recommended in order to speed up evaluation thereof in accordance with the invention.

Of particular interest (for example for reproducing stereophonic signals in automobiles) is the subsequent narrowing or expanding of the function width of the stereo signal obtained by using the specific variation of the degree of correlation r of the resulting stereo signal resp. the attenuations λ or else ρ (for forming the resulting stereo signal). The previously determined parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β can be retained in this case, and it makes sense that now only a final amplitude correction is necessary, for example as per the logic element 120 in FIG. 1B, provided that this narrowing or expanding of the function width is performed manually.

If this is to be automated, series of psychoacoustic experiments show that a constant function width is essentially dependent on the criterion

0≦S*−ε≦max |Re{f*[x(t)]+g*[y(t)]}|≦S*+ε≦1 (9B)

as well as on the criterion

$$0 \leq {u}^{*} - κ \leq {\int }_{- T}^{T} \vert \{ {f}^{*} [ x ( t ) ] + {g}^{*} [ y ( t ) ] \} \vert d t \leq {u}^{*} + κ \qquad ( 10 B )$$

(where S* and ε resp. U* and κ need to be stipulated differently for telephone signals, for example, than for music recordings). Accordingly, it is now necessary to determine only suitable function-values x(t), y(t) which are dependent on the degree of correlation r of the resulting stereo signal respectively on the attenuations λ or else ρ (for the formation of the resulting stereo signal) or, where necessary, on a logic element which is identical to the logic element 120 in FIG. 1B, in accordance with an iterative operating principle which is based on feedback.

The arrangement according to FIG. 1B, 2B, 3aB to 5aB, 6aB, 6bB can accordingly be enhanced within the context of an arrangement, for instance, of the form shown in FIG. 77B, 8B and/or 9B. FIG. 7B in this case shows a further example of a circuit for normalizing stereophonic or pseudo-stereophonic signals which, when connected downstream to FIG. 6bB, is activated as soon as the parameter z is present as an input signal. In this case, the initial value of the gain factor λ corresponds to the final value of the gain factor λ in FIG. 1B when the parameter z is transferred, and the input signals in FIG. 1B are transferred directly as input signals to FIG. 7B at the time of this transfer.

The circuits shown in FIG. 7B to 9B can incidentally also be used autonomously in other circuits or algorithms.

In the present arrangement, the left channel and the right channel are swapped in the MS matrix 110 by using a logic element 110a (which also activates this MS matrix as soon as the parameter z is present as an input signal), provided that the parameter z is equal to 1, otherwise such a swap does not take place.

The resulting output signals L and R from the MS matrix 110 are now amplified (amplifiers 118, 119) uniformly by the factor ρ* such that the maximum of both signals has a level of exactly 0 dB (normalization on the unit circle of the complex number plane). This is achieved for example by the downstream connection of a logic element 120 which uses the feedbacks 121 and 122 and variation resp. correction of the gain factor ρ* of the amplifiers 118 and 119 to cause a modulation of the maximum value of L and R to reach 0 dB.

In a further step, the resulting signals x(t) (123) and y(t) (124) are now fed to a matrix as shown in FIG. 8B in which, following respective amplification by the factor 1/√2 (amplifiers 229, 230), they are split into respective identical real and imaginary parts, with the real part formed from the signal x(t), amplified by means of 229, additionally passing through the amplifier 231 with the gain factor −1. The complex transfer-functions f* [x(t)]+g*[y(t)] already mentioned in connection with FIG. 2B are thus obtained. The respective real and imaginary parts are now summed and thus result in the real part and the imaginary part of the sum of the transfer-functions f*[x(t)]+g*[y(t)].

An arrangement, for example based on the logic element 640 in FIG. 9B, now needs to be connected downstream, which arrangement checks, for a limit value S*—suitably chosen by the user with respect to the function width of the stereo signal that is to be attained—or a suitably chosen deviation ε—both defined by the inequality (9B)—whether the condition

0≦S*−ε≦max |Re{f*[x(t)]+g*[y(t)]}|≦S*+ε≦1 (9B)

is met. If this is not the case, a feedback 641 is used to determine a new optimized value for the degree of correlation r resp. for the attenuations λ or else ρ (for the formation of the resulting stereo signal), and the previous steps just described, as illustrated in FIGS. 7B to 9B, are performed until the above condition (9B) is fulfilled.

The output signals for the logic element 640 are now transferred to an arrangement, for example based on the logic element 642 in FIG. 9B. This arrangement finally analyzes the relief of the function f*[x(t)]+g*[y(t)] for the purpose of optimizing the function-values in terms of the function width of the stereo signal that is to be achieved, the user being able to suitably select the limit value U*and the deviation κ, both defined by the inequality (10B), with respect to the function width of the stereo signal that is to be achieved. Overall, the condition:

0≦U*−κ≦∫|f*[x(t)]+g*[y(t)]|dt≦U*+κ (10B)

must be met. If this is not the case, a feedback 643 is used to determine a new optimized value for the degree of correlation r resp. for the attenuations λ or else ρ (for the formation of the resulting stereo signal), and the previous steps just described, as illustrated in FIGS. 7B to 9B, are performed until the relief of the function f*[x(t)]+g*[y(t)] satisfies the desired optimization of the function-values with respect to the function width taking into account the limit value U* and the deviation κ, both suitably chosen by the user.

In terms of the function width—determined by the degree of correlation r resp. the attenuations λ or else ρ (for the formation of the resulting stereo signal)—the signals x(t) (123) and y(t) (124) therefore correspond to the selections by the user and represent the output signals L** and R** from the arrangement which has just been described.

The arrangement just described, or portions of this arrangement, can be used as an encoder for a full-fledged stereo signal that is limited to a mono signal plus the parameters φ, f (resp. the simplifying parameter n), α, β, λ resp. ρ).

An already existing stereo signal can be evaluated in respect of r resp. a resp. R* resp. Δ resp. the function direction (resp. parameters S* resp. ε resp. U* resp. κ described below) and can then likewise be encoded anew as a mono signal by using the parameters φ, f (resp. n), α, β, λ resp. ρ in view of a device or a method according to WO/2009/138205 resp. EP2124486 or EP1850639.

Similarly, the arrangement just described, to which the elements below may possibly be added, can be used as a decoder for mono signals. If φ, f (resp. n), α, β, λ resp. ρ resp. The function direction (for example expressed by the parameter z, which can assume the value 0 or 1) are known, such a decoder is reduced to an arrangement according to WO/2009/138205 resp. EP2124486 or EP1850639.

Overall, such encoders or decoders can be used wherever audio signals are recorded, transduced/converted, transmitted or reproduced. They provide an excellent alternative to multichannel stereophonic techniques.

Specific areas of application are telecommu-nications (hands-free devices), global networks, computer systems, broadcasting and transmission devices, particularly satellite transmission devices, professional audio technology, television, film and broadcasting and also electronic consumer goods.

The invention is also of particular importance in connection with the obtaining of stable FM stereo signals under bad reception conditions (for example in automobiles). In this case, it is possible to achieve stable stereophony by simply using the main channel signal (L+R) as an input signal, which is the sum of the left channel and of the right channel of the original stereo signal. The complete or incomplete sub-channel signal (L−R), which is the result of subtracting the right channel from the left channel of the original stereo signal, can also be used in this case in order to form a useable S signal resp. in order to determine or optimize the parameters f (resp. n), which describe the directional pattern of the signal that is to be rendered stereophonic, the angle φ—to be ascertained manually or by metrology—enclosed by the main axis and the sound source, the fictitious left opening angle α, the fictitious right opening angle β, the attenuations λ or else ρ for the formation of the resulting stereo signal or, resulting therefrom, the gain factor ρ* of FIG. 1B for normalizing the left and right channel, resulting from the MS matrixing or from another arrangement according to the invention, on the unit circle (in this case 1, for example, corresponds to the maximum level of 0 dB which has been normalized by using ρ*, where x(t) is the left output signal resulting from this normalization and y(t) is the right output signal resulting from this normalization) or the degree of correlation r of the resulting stereo signal or the gain factor a for defining the admissible range of values for the sum of the transfer-functions of the resulting output signals (for example the complex transfer-functions

f*[x(t)]=[x(t)/√ 2̅]*(−1+i) (2B)

and

g*[y(t)]=[y(t)/√ 2̅]*(1+i),

where, for 0≦a≦1, for example, the following is true:

Re²{f*[x(t]+g*[y(t)]}*1/a²+Im²{f*[x(t]+g*[y(t)]}≦1) (4aB)

or the limit value R* or the deviation Δ for stipulating or maximizing the absolute value of the function-values of the sum of these transfer-functions (where, for this stipulation or maximization and for the time interval [−T, T] resp. the total number of possible output signals xⱼ(t), yⱼ(t), the following for example is true:

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t ) \qquad ( 8 aB )$$

or the function direction of the reproduced sound sources, for example by determining the corresponding quadrants for the function-values of the sum, determined for example according to FIG. 6aB, of the transfer-functions for the left and right channel of the original stereo signal (which can be optimized for example by virtue of subsequent swapping of the resulting left resp. right channel, see above), or the limit value S* or the deviation 8 (for which, by way of example, it must be true that

0≦S*−ε≦max |Re{f*[x(t)]+g*[y(t)]}|≦S*+ε≦1) (9B)

or the limit value U* or the deviation κ (for which, by way of example, it must be true that

$$0 \leq {U}^{*} - κ \leq {\int }_{- T}^{T} \vert {f}^{*} [ x ( t ) ] + {g}^{*} [ y ( t ) ] \vert d t \leq {U}^{*} + κ ) , \qquad ( 10 B )$$

all for determining resp. optimizing the function width of the stereo signal to be attained. In any case, the result is stereophonic function which is constant in respect of the FM signal.

In this case too, it is additionally possible to use prior art compression algorithms, data reduction methods or the analysis of characteristic features, such as the minima and maxima, in order to speed up the evaluation of existing or obtained signals or signal components.

In each embodiment and in each figure resp. each element, the circuits, converters, arrangements or logic elements described can be implemented for example by equivalent software programs and programmed processors or DSP or FPGA solutions.

### LIST OF SYMBOLS USED

φ (phi) angle of incidence
α (alpha) left fictitious opening angle
β (beta) right fictitious opening angle
λ attenuation for the left input signal
ρ attenuation for the right input signal
   The attenuations λ and ρ can be used to adjust the degree of correlation of the stereo signal.
ψ polar angle
f polar distance, which describes the directional pattern of the M signal
P_{α}, P_{β} gain factor for α resp. β
L_{α}, L_{β} time difference for α resp. β
S_{α} simulated left signal component of the S signal
S_{β} simulated right signal component of the S signal
x(t) left output signal
y(t) right output signal
f*[x(t)] complex transfer-function
g*[y(t)] complex transfer-function
a gain factor for the definition of the admissible range of values for the sum of the transfer-functions of the resulting output signals x(t), y(t)
r degree of correlation, derived from the short-time cross correlation
R* limit value for the loudness of the resulting output signals x(t), y(t)
Δ deviation
S* 1^{st} limit value for the function width of the resulting output signals x(t), y(t)
ε deviation
U* 2^{nd} limit value for the function width of the resulting output signals x(t), y(t)
κ deviation

The practical-commercial application of the algebraic invariants just developed covers nearly the entire signal processing field. The stochastic analysis of audio signals, as known for example from the field of digital audio broadcasting (DAB), is of particular interest; in that field, so far, for the simulation of Gaussian processes, techniques such as the so-called Tapped Delay Line model or Monte Carlo methods (colored, complex Gaussian noise in two dimensions) were used, see bibliographical references. The transfer of the operating principles applied there for stabilizing optimization processes, such as described in CH01776/09 resp. PCT/EP2010/055877, would be conceivable, yet not very efficient in practice.

On the basis of the present algebraic invariants, it is however possible, as part of the invention, to define for example a weighting as follows:

For this purpose, a first optimization according to CH01776/09 resp. PCT/EP2010/055877, FIG. 1B, 2B, 3aB to 5aB, is performed on a signal section of the length t₁. The outputs of FIG. 5aB are connected for example to a module 6001 according to FIG. 6C and the invariants (constituted at the intersection points ξₕ₁ of the sum of the complex transfer-functions f*[x(t₁)]=[x(t₁)/√ 2̅]*(−1+i) and g*[y(t₁)]=[y(t₁)/√ 2̅]*(1+i) with the half-plane defined by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₁ from the total number k₁ are stored in a memory (“stack”) valid for all further described operation sequences; the mean value

$${ξ°}_{1} := ( {\sum }_{{h}_{1} = 1}^{{k}_{1}} {ξ}_{h 1} ) / {k}_{1}$$

is likewise calculated. The latter is stored together with the parameterization φ₁, f₁ (resp. n₁), α₁, β₁, determined by means of said first optimization, in a further dictionary valid for all further described operation sequences.

According to the function command 6004, in a second step a second optimization according to CH01776/09 resp. PCT/EP2010/055877, FIG. 1B, 2B, 3aB to 5aB is then performed on a signal section t₂ of any length. The outputs of FIG. 5aB are in turn connected to the module 6001 and the invariants (constituted at the intersection points ξₕ₂ of the sum of the complex transfer-functions f*[x(t₂)]=[x(t₂)/√ 2̅]*(−1+i) and g*[y(t₂)]=[y(t₂)/√ 2̅]*(1+i) with the half-plane defined by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₂ from the total number k₂ are stored in a memory (“stack”) valid for all further described operation sequences; the mean value

$${ξ°}_{2} := ( {\sum }_{{h}_{2} = 1}^{{k}_{2}} {ξ}_{h 2} ) / {k}_{2}$$

is likewise calculated. The latter is in turn added together with the parameterization φ₂, f₂ (resp. n₂), α₂, β₂, determined by means of said second optimization, to the first mean value ξ^{o}₁ as well as its parameterization φ₁, f₁ (resp. n₁), α₁, β₁, in the dictionary valid for all further described operation sequences. Since the memory (“stack”) now contains more than one mean value, the module 6002 is then activated.

The latter calculates the mean value ξ*₂ of all intersection points ξₕ₁, ξₕ₂ stored in the stack:

$${ξ}_{2}^{*} := ( {\sum }_{{h}_{1} = 1}^{{k}_{1}} {ξ}_{h 1} + {\sum }_{{h}_{2} = 1}^{{k}_{2}} {ξ}_{h 2} ) / ( {k}_{1} + {k}_{2} )$$

andselects from the dictionary among the mean values ξ^{o}₁, ξ^{o}₂ with their associated parameterizationthe mean value closest to ξ*₂. If this is the case for both mean values ξ^{o}₁, ξ^{o}₂, ξ^{o}₁ resp. the parameterization φ₁, f₁ (resp. n₁), α₁, β₁ is selected from the dictionary. The mean value selected from the dictionary is then transmitted together with ξ*₂ to the module 6003. The latter verifies whether the mean value selected by the module 6002 is within the interval [−σ+ξ*₂, ξ*₂+σ], where σ>0 represents the standard deviation, freely selectable by the user, of the Gauss distribution fictitiously set as zero in ξ*₂:

$${f}^{⋓} ( {z}_{2}^{*} ) = ( 1 / ( √ ( 2 π ) * σ ) ) * {e}^{- ( 1 / 2 ) * ( ( {( {z}_{2}^{*} - {ξ}_{2}^{*} )}^{⋀} 2 ) / σ ⋀ 2 )}$$

If the mean value selected by the module 6002 is within the interval [−σ+ξ*₂, ξ*₂+σ], the parameterization selected by the module 6002 according to 6010 in the arrangement of FIG. 7A resp. FIG. 1B (which shows again for the sake of clarity the amplifier 717 and the MS matrix, wherein both of which are to be passed through only once) resp. the outputs 6006 and 6007 of FIG. 1B are activated, likewise the outputs 6008 and 6009 of FIG. 2B. The output 6006 runs into the input 6006 of FIG. 6C, the output 6007 runs into the input 6007 of FIG. 6C, the output 6008 runs into the input 6008 of FIG. 6C and the output 6009 runs into the input 6009 of FIG. 6C. Reference 6006 directly represents the output signal x(t) from the module 6003, reference 6007 directly represents the output signal y(t) from the module 6003, 6008 directly represents the output signal Re f*[x(t)]+g*[y(t)] from the module 6003, 6009 directly represents the output signal Im f*[x(t)]+g*[y(t)] from the module 6003. These signals, in the signal processing described above, are to be treated as if they represented the output signals of FIG. 5aB, which with FIG. 6C then constitutes, in this example of application, an inseparable unit.

If the mean value selected by the module 6002 is outside the interval [−σ+ξ*₂, ξ*₂+σ], in a q^{th} step a q^{th} optimization is performed according to CH01776/09 resp. PCT/EP2010/055877, FIG. 1B, 2B, 3aB to 5aB on a signal section t_{q} of any length. The outputs of FIG. 5aB are in turn connected to the module 6001 and the invariants (constituted at the intersection points ξ_{hq} of the sum of the complex transfer-functions f*[x(t_{q})]=[x(t_{q})/√ 2̅]*(−1+i) and g*[y(t_{q})]=[y(t_{q})/√ 2̅]*(1+i) with the half-plane defined by the vectors (1, 1, −2) and (1, 1, 1) or also (−1, −1, 2) and (1, 1, 1) and located in the 1^{st} or also 3^{rd} quadrants of the complex number plane—the axis of x₁, u₁₀f the represented algebraic model coincides here with the real axis, the axis x₂, u₂ with the imaginary axis) are analyzed in terms of their statistical distribution. All ξ_{hq} from the total number k_{g} are added to ξₕ₁, ξₕ₂, . . . , ξ_{hq-1} in a memory (“stack”) valid for all further described operation sequences; the mean value

$${ξ°}_{q} := ( {\sum }_{{h}_{q} = 1}^{{k}_{q}} {ξ}_{hq} ) / {k}_{q}$$

is likewise calculated. The latter is in turn added together with the parameterization φ_{q}, f_{q} (resp. n_{q}), α_{q}, β_{q}, optimization, determined by means of said q^{th} optimization, to the first mean values ξ^{o}₁, ξ^{o}₁, . . . , ξ^{o}_{q-1} as well as to their parameterizations φ₁, f₁ (resp. n₁), α₁, β₁; φ₂, f₂ (resp. n₂), α₂, β₂; . . . ; φ_{q-1}, f_{q-1} (resp. n_{q-1}), α_{q-1}, β_{q-1}, in the dictionary valid for all further described operation sequences. Since the memory (“stack”) now contains more than one mean value, the module 6002 is then activated.

The latter calculates the mean value ξ*_{q} of all intersection points ξₕ₁, ξₕ₂, . . . , ξ_{hq} stored in the stack:

$${ξ}_{q}^{*} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1}^{{k}_{q}} {ξ}_{hq} ) / ( {k}_{1} + {k}_{2} + … {k}_{q} )$$

and selects from the dictionary among the mean values ξ^{o}₁, ξ^{o}₂, . . . , ξ^{o}_{q} with their associated parameterization φ, f (resp. n), α, β, the mean value closest to ξ*_{q}. If this is the case for different parameterizations, the parameterization that appears most often in the dictionary is selected. If several parameterizations appear the same number of times, the one that shows the widest scattering in the dictionary is selected, i.e. the one for which the difference d−c is maximum, where d represents the last and c the first index number of the respectively optimization steps undergone. If this too applies to several parameterizations, the first one that appears is selected. If two mean values from ξ^{o}₁, ξ^{o}₂, . . . , ξ^{o}_{q} are close to ξ*_{q}, in so far as in a q−1^{th} step one of the two mean values resp. their associated parameterizations is selected from the dictionary, the very same one resp. its associated parameterizations is retained. The mean value selected from the dictionary is then transmitted together with ξ*_{q} to the module 6003. The latter verifies whether the mean value selected by the module 6002 is within the interval [−σ+ξ*_{q}, ξ*_{q}+σ], where σ>0 represents the standard deviation, freely selectable by the user at the beginning of the entire process illustrated here, of the Gauss distribution fictitiously set as zero in ξ*_{q}:

$${f}^{⋓} ( {z}_{q}^{*} ) = ( 1 / ( √ ( 2 π ) * σ ) ) * {e}^{- ( 1 / 2 ) * ( ( {( {z}_{q}^{*} - {ξ}_{q}^{*} )}^{⋀} 2 ) / σ ⋀ 2 )}$$

If the mean value selected by the module 6002 is within the interval [−σ+ξ*_{q}, ξ*_{q}+σ], the parameterization selected by the module 6002 according to 6010 in the arrangement of FIG. 7A resp. FIG. 1B resp. the outputs 6006 and 6007 of FIG. 1B are activated, likewise the outputs 6008 and 6009 of FIG. 2B as well as the corresponding inputs and outputs of FIG. 6C. Reference 6006 again directly represents the output signal x(t) from the module 6003, reference 6007 directly represents the output signal y(t) from the module 6003, 6008 directly represents the output signal Re f*[x(t)]+g*[y(t)] from the module 6003, 6009 directly represents the output signal Im f*[x(t)]+g*[y(t)] from the module 6003. These signals, in the signal processing described above, are again to be treated as if they represented the output signals of FIG. 5aB, which with FIG. 6C constitutes, in the present example of application, an inseparable unit.

If the mean value selected by the module 6002 is outside the interval [−σ+ξ*_{q}, ξ*_{q}+σ], in a q+1^{th} step a q+1^{th} optimization is performed in the same form as for the q^{th} step and for the q^{th} optimization. The process is repeated as long as necessary until one element of the dictionary fulfills the above requirements or a maximum number of allowed optimization steps has been reached.

FIG. 5C shows the convergence behavior of the just established weighting-function for three optimization steps: 5001 represents in this case the first mean value ξ^{o}₁, 5002 the second mean value ξ^{o}₂, 5003 the first Gauss distribution fictitiously set as zero in ξ*₂:

$${f}^{⋓} ( {z}_{2}^{*} ) = ( 1 / ( √ ( 2 π ) * σ ) ) * {e}^{- ( 1 / 2 ) * ( ( {( {z}_{2}^{*} - {ξ}_{2}^{*} )}^{⋀} 2 ) / σ ⋀ 2 )} ,$$

where σ>0 represents the standard deviation, freely selectable by the user at the beginning of the entire process illustrated here, 5004 the third mean value ξ^{o}₃, which remains within the turning points defined by σ of the Gauss distribution 5005 of same standard deviation, fictitiously set as zero in ξ*₃, and thus fulfills the convergence criterion.

In each case, the result is a parameterization φ, f (resp. n), α, β, which supplies a pseudo-stereophonic function that on average is optimum in relation to all algebraic invariants.

As the number of signal sections increases, the distribution of the intersection points ξ of the algebraic invariants on the half-plane respectively analyzed with the complex number plane approximates the Gauss distribution. The smaller the chosen standard deviation σ is, the closer to ideal the resulting parameterization will be. However, as an only finite number of signal sections are available, σ should not be chosen too small.

Nevertheless, the method in terms of its convergence is considerably faster for sufficiently long signal sections than mentioned simulation models, since algebraic invariants are available for the first time to serve as valid “points of reference” for a weighting of already determined parameterizations.

In principle, use of the described invariants is however not compulsorily bound to a system as in FIG. 3A to 12A resp. 1B, 2B, 3aB, 4aB, 5aB, 6aB, 6bB, 7B to 9B resp. 5C and 6C, but can on the contrary be applied to nearly any part of the entire field of signal technology. The described normalization on the unit circle of the complex number plane, wherein for example two signals x(t) and y(t) are amplified uniformly by a factor ρ* (amplifiers 118, 119 in FIG. 1B) such that the maximum of both signals has a level of exactly 0 dB, is not necessary in this case. The value range for the analyzed combination or combinations—or also for any above function or functions of one or several signals—can thus according to the invention comprise the entire value range of the real or complex number plan and therefore does not remain limited to the unit circle.

If it is intended to normalize a combination f̂(t) or several combinations f₁̂(t), f₂̂(t), . . . , fₚ̂(t) of at least two signals s₁(t), s₂(t), . . . , sₘ(t) resp. of their transfer-functions t₁(s₁(t)), t₂(s₂(t)), . . . , tₘ(sₘ(t))—or also the above freely definable function f^{#}(t) or freely definable functions f₁^{#}(t), f₂^{#(t), . . . , f}_{μ}^{#}(t) of one signal s^{#}(t) or of several signals s₁^{#}(t), s₂^{#}(t), . . . , s_{Ω}^{#}(t)—although there is no imperative necessity of doing so, this normalization can be freely definable.

Instead of the effective modulation of the maximum value of L and R in the present example to 0 db (amplifiers 118 and 119 as well as logic element 120 in FIG. 1B), it is thus possible for example to achieve a normalization on the basis of the sums of the mean square energy of each of the two respective channels, i.e. for L equal to x_{#}(tᵢ) and R equal to y_{#} (tᵢ) on the basis of the sumz_{Li}+z_{Ri} of

$${z}_{Li} = ( 1 / {T}_{i} ) * {\int }_{0}^{{T}_{i}} {x}_{\#} ( {t}_{i} ) d t$$

$$and$$

$${z}_{Ri} = ( 1 / {T}_{i} ) * {\int }_{0}^{{T}_{i}} {y}_{\#} ( {t}_{i} ) d t$$

to introduce a normalization with respect to a reference value z_{ref} according to the principle that x_{#} (tᵢ) and y_{#} (tᵢ) each are to be multiplied by the factor

z_{ref}/(z_{Li}+z_{Ri})

If this principle is generalized for example according to FIG. 7C, this principle can be extended to any number of signals sⱼ(tᵢ) of the total number δ (7001), for each of which respectively the mean square energy is calculated (7002):

$${Z}_{sj ( ti )} = ( 1 / {T}_{i} ) * {\int }_{0}^{{T}_{i}} {s}_{j} ( {t}_{i} ) d t ,$$

where again Tᵢ represents the time span of the time interval tᵢ, and which signals are subsequently multiplied (7003) with a weighting Gⱼ defined for each signal sⱼ (t).

Following this, the products Gⱼ*z_{sj (ti)} thus obtained are summed according to 7004. This sum is transmitted to the amplifiers of 7005 that are individually connected to the original signal inputs s₁(tᵢ), s₂(tᵢ), . . . , s_{δ}(tᵢ), and the signals s₁(tᵢ), s₂(tᵢ), . . . s_{δ}(tᵢ) are then uniformly amplified by the factor

$${Z}_{ref} / ( {\sum }_{j = 1}^{δ} {G}_{j} * {Z}_{sj ( ti )} )$$

and for example transmitted to the module 7006, which—according to the disclosure of the invention—determines the invariants of the combination f̂(t) or of several combinations f₁̂(t), f₂̂(t), . . . , fₚ̂(t) of at least two signals s₁(t), s₂(t), . . . , s_{δ}(t) resp. of their transfer-functions t₁(s₁(t)), t₂(s₂(t)), . . . , t_{δ}(s_{δ}(t))—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{δ}^{#}(t).

Similar considerations can in particular extend also for example to audio signals according for example to ITU-R BS.1770; the modules 7002 to 7005 are then omitted and the signals can be forwarded directly to the module 7006.

Even when analyzing a single, sufficiently long time span for a combination f̂(t) or several combinations f₁̂(t), f₂̂(t), . . . , fₚ̂(t) of at least two signals s₁(t), s₂(t), . . . , sₘ(t) resp. of their transfer-functions t₁(s₁(t)), t₂(s₂(t)), . . . , tₘ(sₘ(t))—or also for the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t)—the invariants according to the disclosure of the invention can be determined and used specifically in an industrial-technical context (for example for evaluating individual signals or processing or optimizing any signal parameter or transmission parameter). The application of the object of the invention it thus not limited to the examples given above, but is oriented in principle towards the described determination of invariants for any signals or signal sections of any length according to the disclosure of the invention.

1. Method for evaluating
a combination (f̂(t)) or several combinations (f₁̂(t), f₂̂(t), . . . , fₚ̂(t)) of two or more signals (s₁(t), s₂(t), . . . , sₘ(t)) resp. of their transfer functions (t₁(s₁(t)), t₂(s₂(t)), . . . , tₘ(sₘ(t))), which can be represented on the real resp. complex number plane, wherein (s₁(t)) represents the function value of the first signal at the point in time t, (s₂(t)) represents the function value of the second signal at the point in time t, . . . (sₘ(t)) represents the function value of the m^{th} signal at the point in time t,
or
a freely definable function (f^{#}(t)) or of freely definable functions (f₁^{#}(t), f₂^{#}(t), . . . , f_{μ}^{#}(t)) of one signal (s^{#}(t)) or of several signals (s₁^{#}(t), s₂^{#}(t), . . . , s_{Ω}^{#}(t)), which can be represented on the real resp. complex number plane, wherein (s₁^{#}(t)) represents the function value of the first signal at the point in time t, (s₂^{#}(t)) represents the function value of the second signal at the point in time t, . . . , (s_{Ω}^{#}(t)) represents the function value of the Ω^{th} signal at the point in time t,
wherein
for one or several signal sections (t₁, t₂, . . . , t_{χ}) the invariants of one function or of several functions of the combination (f̂(t)) or of the combinations (f₁̂(t), f₂̂(t), . . . , fₚ̂(t)) are determined,
or
for one or several signal sections (t₁, t₂, . . . , t_{ç}) the invariants of one function or of several functions of the freely definable function (f^{#}(t)) or of the freely definable functions (f₁^{#}(t), f₂^{#}(t), . . . , f_{μ}^{#}(t)) are determined.

2. Method according to claim 1, wherein
for a combination (f̂(t)) or several combinations (f₁̂(t), f₂̂(t), . . . , fₚ̂(t)) of two or more signals (s₁(t), s₂(t), . . . , sₘ(t)) resp. of their transfer functions (t₁(s₁(t)), t₂(s₂(t)), . . . , tₘ(sₘ(t))), which can be represented on the real resp. complex number plane,
or
for a freely definable function (f^{#}(t)) or freely definable functions (f₁^{#}(t), f₂^{#}(t), . . . , f_{μ}^{#}(t)) of one signal (s^{#}(t)) or of several signals (s₁^{#}(t), s₂^{#}(t), . . . , s_{Ω}^{#}(t)), which can be represented on the real resp. complex number plane,
for one or several signal sections (t₁, t₂, . . . , t_{χ}) the invariants of one function or of several functions of the combination (f̂(t)) or of the combinations (f₁̂(t), f₂̂(t), . . . , fₚ̂(t)) are determined which, if necessary after appropriate conversion, contain the function by means of an equation in the form of (Av₁²+Bv₂²+Cv₃²+2Fv₂v₃+2Gv₃v₁+2Hv₁v₂=0),
or
for one or several signal sections (t₁, t₂, . . . , t_{ç}) the invariants of one function or of several functions of the freely definable function (f^{#}(t)) or of the freely definable functions (f₁^{#}(t), f₂^{#}(t), . . . , f_{μ}^{#}(t)) are determined which, if necessary after appropriate conversion, contain the function by means of an equation in the form of (Av₁²+Bv₂²+Cv₃²+2Fv₂v₃+2Gv₃v₁+2Hv₁v₂=0).

3. Method according to claim 1, wherein the invariants, if necessary after appropriate conversion, can be represented as linear combination of invariants resp. of vectors on one plane which, if necessary after appropriate conversion, is vertical to the real or complex number plane and crosses the latter, if necessary after rotation or appropriate conversion, in the diagonal of the 1^{st} and 3^{rd} quadrants.

4. Method according to claim 1, wherein it uses the intersection points of these invariants resp. vectors with the real or complex number plane, on which
the analyzed combination (f̂(t)) or the analyzed combinations (f₁̂(t), f₂̂(t), . . . , fₚ̂(t))
or
the analyzed, freely definable function (f^{#}(t)) or the analyzed, freely definable functions (f₁^{#}(t), f₂^{#}(t), . . . , f_{μ}^{#}(t)),
if necessary after appropriate conversion, can be represented.

5. Method according to claim 1, wherein said signals (s₁(t), s₂(t), . . . , sₘ(t) resp. s^{#}(t) resp. s₁^{#}(t), s₂^{#}(t), . . . , s_{Ω}^{#}(t) (resp. x(t), y(t) resp. x_{#}(t), y_{#}(t))) are audio signals.

6. Method according to claim 1, wherein on the basis of the determined invariants or, if necessary after appropriate conversion, of the intersection points of these invariants resp. vectors with the real or complex number plane, on which, if necessary after appropriate conversion, is/are located
the analyzed combination (f̂(t)) or the analyzed combinations (f₁̂(t), f₂̂(t), . . . , fₚ̂(t))
or
the analyzed, freely definable function(f^{#}(t)) or the analyzed, freely definable functions (f₁^{#}(t), f₂^{#}(t), . . . , f_{μ}^{#}(t)),
or also on the basis of a selection of these invariants or intersection points, a selection according to statistical or other criteria is made.

7. Method according to claim 1, wherein
the analyzed combination (f̂(t)) or the analyzed combinations (f₁̂(t), f₂̂(t), . . . , fₚ̂(t)) or the used two or more signals (s₁(t), s₂(t), . . . , sₘ(t)) or the used transfer functions (t₁(s₁(t)), t₂(s₂(t)), . . . , tₘ(sₘ(t))), which can be represented on the real resp. complex number plane,
or
the analyzed, freely definable function(f^{#}(t)) or the analyzed, freely definable functions (f₁^{#}(t), f₂^{#}(t), . . . , f_{μ}^{#}(t)) or the used signal (s^{#}(t)) or the used signals (s₁^{#}(t), s₂^{#}(t), . . . , s_{Ω}^{#}(t)), which can be represented on the real resp. complex number plane,
are normalized as regards their amplitude or other properties of theirs.

8. Method according to claim 7, wherein the normalization occurs on the basis of the signal level.

9. Method according to claim 7, wherein the normalization occurs on the basis of the mean-square energy.

10. Method according to claim 1, wherein
the intersection points (ξₕ₁) of the combination (f̂(t₁)) or of the combinations (f₁̂(t₁), f₂̂(t₁), . . . , fₚ̂(t₁)) of two or more signals (s₁ (t₁), s₂(t₁), . . . , sₘ(t₁)) resp. of their transfer functions (t₁(s₁(t₁)), t₂(s₂(t₁)), . . . , tₘ(sₘ(t₁))), which can be represented on the real resp. complex number plane,
or
the intersection points (ξₕ₁) of the freely definable function (f^{#}(t₁)) or of the freely definable functions (f₁^{#}(t₁), f₂^{#}(t₁), . . . , f_{μ}^{#}(t₁)) of the signal (s^{#}(t₁)) or of the signals (s₁^{#}(t₁), s₂^{#}(t₁), . . . , s_{Ω}^{#}(t₁)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, wherein hereinafter the abscissa axis of the real number plane is identical with the real axis of the complex number plane, and the ordinate axis of the real number plane is identical with the imaginary axis of the complex number plane, and then their mean value (
$${ξ°}_{1} := ( {\sum }_{{h}_{1} = 1 )}^{{k}_{1}} {ξ}_{h 1} ) / {k}_{1}$$
is calculated;
the intersection points (ξₕ₂) of the combination (f̂(t₂)) or of the combinations (f₁̂(t₂), f₂̂(t₂), . . . , fₚ̂(t₂)) of two or more signals (s₁(t₂), s₂(t₂), . . . , sₘ(t₂)) resp. of their transfer functions (t₁(s₁(t₂)), t₂(s₂(t₂)), . . . , tₘ(sₘ(t₂))), which can be represented on the real resp. complex number plane,
or
the intersection points (ξₕ₂) of the freely definable function(f^{#}(t₂)) or of the freely definable functions (f₁^{#}(t₂), f₂^{#}(t₂), . . . , f_{μ}^{#}(t₂)) of the signal (s^{#}(t₂)) or of the signals (s₁^{#}(t₂), s₂^{#}(t₂), . . . , s_{Ω}^{#}(t₂)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, and then their mean value (
$${ξ°}_{2} := ( {\sum }_{{h}_{2} = 1 )}^{{k}_{2}} {ξ}_{h 2} ) / {k}_{2}$$
as well as the mean value (ξ*₂) of all intersection points (ξₕ₁, ξₕ₂
$${ξ}_{2}^{*} := ( {\sum }_{{h}_{1} = 1}^{{k}_{1}} {ξ}_{h 1} + {\sum }_{{h}_{2} = 1 )}^{{k}_{2}} {ξ}_{h 2} ) / ( {k}_{1} + {k}_{2} )$$
are calculated, and, insofar as the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user, by selecting, to be matched with (ξ^{o}_{υ}),
the combination (f̂(t_{υ})) or combinations (f₁̂(t_{υ}) or f₂̂(t_{υ}) or . . . or fₚ̂(t_{υ})) or signals (s₁(t_{υ}) or s₂(t_{υ}) or . . . or sₘ(t_{υ})) or the transfer functions (t₁(s₁(t_{υ})) or t₂(s₂(t_{υ})) or . . . or tₘ(sₘ(t_{υ}))), which can be represented on the real resp. complex number plane,
or
the freely definable function (f^{#}(t_{υ})) or freely definable functions (f₁^{#}(t_{υ}) or f₂^{#}(t_{υ}) or . . . or f_{μ}^{#}(t_{υ})) or signals (s*(t_{υ})) or (s₁^{#}(t_{υ}) or s₂^{#}(t_{υ}) or . . . or s_{Ω}^{#}(t_{υ})), which can be represented on the real resp. complex number plane,
or the properties or parameters of these signals or transfer functions or combinations or functions, the entire process is ended, otherwise, provided both mean values (ξ^{o}₁, ξ^{o}₂) have the same distance to (ξ^{*}₂), (ξ^{o}₁) is selected and, provided the first mean value (ξ^{o}₁) lies within the interval [−σ+ξ*₂, ξ*₂+σ], by selecting, to be matched with (ξ^{o}₁),
the combination (f̂(t₁)) or combinations (f₁̂(t₁) or f₂̂(t₁) or . . . or fₚ̂(t₁)) or signals (s₁(t₁) or s₂(t₁) or . . . or sₘ(t₁)) or the transfer functions t₁(s₁(t₁)) or t₂(s₂(t₁)) or . . . or tₘ(sₘ(t₁))), which can be represented on the real resp. complex number plane,
or
the freely definable function (f^{#}(t₁)) or freely definable functions (f₁^{#}(t₁) or f₂^{#}(t₁) or . . . or f_{μ}^{#}(t₁)) or signals (s^{#}(t₁)) or (s₁^{#}(t₁) or s₂^{#}(t₁) or . . . or s_{Ω}^{#}(t₁)), which can be represented on the real resp. complex number plane,
or the properties or parameters of these signals or transfer functions or combinations or functions, the entire process is ended, otherwise, in a q^{th} step
the intersection points (ξ_{hq}) of the combination (f̂(t_{q})) or of the combinations (f₁̂(t_{q}), f₂̂(t_{q}), . . . , fₚ̂(t_{q})) of two or more signals (s₁(t_{q}), s₂(t_{q}), . . . , sₘ(t_{q})) resp. of their transfer functions (t₁(s₁(t_{q})), t₂(s₂(t_{q})), . . . , tₘ(sₘ(t_{q}))), which can be represented on the real resp. complex number plane,
or
the intersection points (ξ_{hq}) of the freely definable function(f^{#}(t_{q})) or of the freely definable functions (f₁^{#}(t_{q}), f₂^{#}(t_{q}), . . . , f_{μ}^{#}(t_{q})) of the signal (s^{#}(t_{q})) or of the signals (s₁^{#}(t_{q}), s₂^{#}(t_{q}), . . . , s_{Ω}^{#}(t_{q})), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, and then their mean value (
$${ξ°}_{q} := ( {\sum }_{{h}_{q} = 1 )}^{{k}_{q}} {ξ}_{hq} ) / {k}_{q}$$
as well as the mean value (ξ*_{q}) of all intersection points (ξₕ₁, ξₕ₂, . . . , ξ_{hq}
$${ξ}_{q}^{*} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1 )}^{{k}_{q}} {ξ}_{hq} ) / ( {k}_{1} + {k}_{2} + … {k}_{q} )$$
are calculated, and, in so far as the mean value (ξ^{o} _{ω̅}) closest to (ξ*_{q}), where ω̅ is equal to 1 or 2 or . . . or q, then lies within the interval [−σ+ξ*_{q}, ξ*_{q}+σ], where σ represents the fictitious standard deviation σ>0, freely selectable by the user, by selecting, to be matched with (ξ^{o} _{ω̅}),
the combination (f̂(t _{ω̅})) or combinations (f₁̂(t _{ω̅}) or f₂̂(t _{ω̅}) or . . . or fₚ̂(t _{ω̅})) or signals (s₁(t _{ω̅}) or s₂(t _{ω̅}) or . . . or sₘ(t _{ω̅})) or the transfer functions (t₁(s₁(t _{ω̅})) or t₂(s₂(t _{ω̅})) or . . . or tₘ(sₘ(t _{ω̅}))), which can be represented on the real resp. complex number plane,
or
the freely definable function (f^{#}(t _{ω̅})) or freely definable functions (f₁^{#}(t _{ω̅}) or f₂^{#}(t _{ω̅}) or . . . or f_{μ}^{#}(t _{ω̅})) or signals (s^{#}(t _{ω̅})) or (s₁^{#}(t _{ω̅}) or s₂^{#}(t _{ω̅}) or . . . or s_{Ω}^{#}(t _{ω̅})), which can be represented on the real resp. complex number plane,
or the properties or parameters of these signals or transfer functions or combinations or functions, the entire process is ended, otherwise for the same mean value of different
combinations (f̂(tₛ)) or combinations (f₁̂(tₛ), f₂̂(tₛ), . . . , fₚ̂(tₛ)) or signals (s₁(tₛ), s₂(tₛ), . . . , sₘ(tₛ)) or transfer functions (t₁(s₁(tₛ)), t₂(s₂(tₛ)), . . . , tₘ(sₘ(tₛ))), which can be represented on the real resp. complex number plane, 1≦s≦q,
or
freely definable functions (f^{#}(tι) or freely definable functions (f₁^{#}(tι), f₂^{#}(tι), . . . , f_{μ}^{#}(tι)) or signals (s^{#}(tι) or signals (s₁^{#}(tι), s₂^{#}(tι), . . . , s_{Ω}^{#}(tι)), which can be represented on the real resp. complex number plane, 1≦ι≦q,
or properties or parameters of these signals or transfer functions or combinations or functions, those signals or those transfer functions or those combinations or those functions or those properties or parameters are selected that so far appeared with the highest frequency, otherwise, insofar as several signals or transfer functions or combinations or functions or their properties or parameters occur with the same frequency, those are selected that exhibit the widest scattering, i.e. those for which the difference d−c is maximum, where d represents the last and c the first index number of the optimization steps respectively undergone, otherwise if this too applies to several signals or transfer functions or combinations or functions or their properties or parameters, the first ones that appear are selected, otherwise if two mean values from (ξ^{o}₁, ξ^{o}₂, . . . , ξ^{o}_{q}) are closest to (ξ*_{q}), in so far as in a q−1^{th} step one of the two mean values resp. their associated signals or transfer functions or combinations or functions or their properties or parameters are selected, the very same ones are retained and, in so far as the selected mean value then lies within the interval [−σ+ξ*_{q}, ξ*_{q}+σ], where σ represents the fictitious standard deviation σ>0, freely selectable by the user, by selecting, to be matched with this mean value, the signals or transfer functions or combinations or functions or their properties or parameters, the entire process is ended, otherwise a q+1^{th} step in the same form as presented for the q^{th} step is performed and the process is repeated as long as necessary until one mean value fulfills the above requirements or a maximum number of allowed optimization steps has been reached,
or in that
the intersection points (ξₕ₁) of the combination (f̂(t₁)) or of the combinations (f₁̂(t₁), f₂̂(t₁), . . . , fₚ̂(t₁)) of two or more signals (s₁(t₁), s₂(t₁), . . . , sₘ(t₁)) resp. of their transfer functions (t₁(s₁(t₁)), t₂(s₂(t₁)), . . . , tₘ(sₘ(t₁))), which can be represented on the real resp. complex number plane
or
the intersection points (ξₕ₁) of the freely definable function (f^{#}(t₁)) or of the freely definable functions (f₁^{#}(t₁), f₂^{#}(t₁), . . . , f_{μ}^{#}(t₁)) of the signal (s^{#}(t₁)) or of the signals (s₁^{#}(t₁), s₂^{#}(t₁), . . . , s_{Ω}^{#}(t₁)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, wherein hereinafter the abscissa axis of the real number plane is identical with the real axis of the complex number plane, and the ordinate axis of the real number plane is identical with the imaginary axis of the complex number plane, and then their mean value (
$${ξ°}_{1} := ( {\sum }_{{h}_{1} = 1 )}^{{k}_{1}} {ξ}_{h 1} ) / {k}_{1}$$
is calculated;
the intersection points (ξₕ₂) of the combination (f̂(t₂)) or of the combinations (f₁̂(t₂), f₂̂(t₂), . . . , fₚ̂(t₂)) of two or more signals (s₁(t₂), s₂(t₂), . . . , sₘ(t₂)) resp. of their transfer functions (t₁(s₁(t₂)), t₂(s₂(t₂)), . . . , tₘ(sₘ(t₂))), which can be represented on the real resp. complex number plane,
or
the intersection points (ξₕ₂) of the freely definable function(f^{#}(t₂)) or of the freely definable functions(f₁^{#}(t₂), f₂^{#}(t₂), . . . , f_{μ}^{#}(t₂)) of the signal (s^{#}(t₂)) or of the signals (s₁^{#}(t₂), s₂^{#}(t₂), . . . , s_{Ω}^{#}(t₂)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, and then their mean value
$${ξ°}_{2} := ( {\sum }_{{h}_{2} = 1 )}^{{k}_{2}} {ξ}_{h 2} ) / {k}_{2}$$
as well as the mean value (ξ*₂) of all intersection points (ξₕ₁, ξₕ₂
$${ξ}_{2}^{*} := ( {\sum }_{{h}_{1} = 1}^{{k}_{1}} {ξ}_{h 1} + {\sum }_{{h}_{2} = 1 )}^{{k}_{2}} {ξ}_{h 2} ) / ( {k}_{1} + {k}_{2} )$$
are calculated, and, in so far as the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user, by selecting, to be matched with (ξ^{o}_{υ})
the combination (f̂(t_{υ})) or combinations (f₁̂(t_{υ}) or f₂̂(t_{υ}) or . . . or fₚ̂(t_{υ})) or signals (s₁(t_{υ}) or s₂(t_{υ}) or . . . or sₘ(t_{υ})) or the transfer functions (t₁(s₁(t_{υ})) or t₂(s₂(t_{υ})) or . . . or tₘ(sₘ(t_{υ}))), which can be represented on the real resp. complex number plane
or
the freely definable function (f^{#}(t_{υ})) or freely definable functions (f₁^{#}(t_{υ}) or f₂^{#}(t_{υ}) or . . . or f_{μ}^{#}(t_{υ})) or signals (s^{#}(t_{υ})) or (s₁^{#}(t_{υ}) or s₂^{#}(t_{υ}) or . . . or s_{Ω}^{#}(t_{υ})), which can be represented on the real resp. complex number plane,
or the properties or parameters of these signals or transfer functions or combinations or functions, the entire process is ended, otherwise, provided both mean values (ξ^{o}₁, ξ^{o}₂) have the same distance to (ξ*₂), (ξ^{o}₁) is selected and, provided the first mean value (ξ^{o}₁) lies within the interval [−σ+ξ*₂, ξ*₂+σ], by selecting, to be matched with (ξ^{o}₁),
the combination (f̂(t₁)) or combinations (f₁̂(t₁) or f₂̂(t₁) or . . . or fₚ̂(t₁)) or signals (s₁(t₁) or s₂(t₁) or . . . or sₘ(t₁)) or the transfer functions (t₁(s₁(t₁)) or t₂(s₂(t₁) or . . . or tₘ(sₘ(t₁))), which can be represented on the real resp. complex number plane,
or
the freely definable function (f^{#}(t₁)) or freely definable functions (f₁^{#}(t₁) or f₂^{#}(t₁) or . . . or f^{#}(t₁) or signals (s^{#}(t₁)) or (s₁^{#}(t₁) or s₂^{#}(t₁) or . . . or s_{Ω}^{#}(t₁), which can be represented on the real resp. complex number plane,
or the properties or parameters of these signals or transfer functions or combinations or functions, the entire process is ended, otherwise in a q^{th} step
the intersection points (ξ_{hq}) of the combination (f̂(t_{q})) or of the combinations (f₁̂(t_{q}), f₂̂(t_{q}), . . . , fₚ̂(t_{q})) of two or more signals (s₁(t_{q}), s₂(t_{q}), . . . , sₘ(t_{q})) resp. of their transfer functions (t₁(s₁(t_{q})), t₂(s₂(t_{q})), . . . , tₘ(sₘ(t_{q}))), which can be represented on the real resp. complex number plane,
or
the intersection points (ξ_{hq}) of the freely definable function (f^{#}(t_{q})) or of the freely definable functions (f₁^{#}(t_{q}), f₂^{#}(t_{q}), . . . f_{μ}^{#}(t_{q})) of the signal (s^{#}(t_{q})) or of the signals (s₁^{#}(t_{q}), s₂^{#}(t_{q}), . . . , s_{Ω}^{#}(t_{q})), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, and then their mean value (
$${ξ°}_{q} := ( {\sum }_{{h}_{q} = 1 )}^{{k}_{q}} {ξ}_{hq} ) / {k}_{q}$$
as well as the mean value (ξ*_{q}) of all intersection points (ξₕ₁, ξₕ₂, . . . , ξ_{hq}
$${ξ}_{q}^{*} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1 )}^{{k}_{q}} {ξ}_{hq} ) / ( {k}_{1} + {k}_{2} + … {k}_{q} )$$
are calculated, and, insofar as the mean value (ξ^{o} _{ω̅}) closest to (ξ*_{q}), where ω̅ is equal to 1 or 2 or . . . or q, then lies within the interval [−σ+ξ*_{q}, ξ*_{q}+σ], where σ represents the fictitious standard deviation σ>0, freely selectable by the user, by selecting, to be matched with (ξ^{o} _{ω̅}),
the combination (f̂(t _{ω̅})) or combinations (f₁̂(t _{ω̅}) or f₂̂(t _{ω̅}) or . . . or fₚ̂(t _{ω̅})) or signals (s₁(t _{ω̅}) or s₂(t _{ω̅}) or . . . or sₘ(t _{ω̅})) or the transfer functions (t₁(s₁(t _{ω̅})) or t₂(s₂(t _{ω̅})) or . . . or tₘ(sₘ(t _{ω̅}))), which can be represented on the real resp. complex number plane,
or
the freely definable function (f^{#}(t _{ω̅})) or freely definable functions (f₁^{#}(t _{ω̅}) or f₂^{#}(t _{ω̅}) or . . . or f_{μ}^{#}(t _{ω̅})) or signals (s^{#}(t _{ω̅})) or (s₁^{#}(t _{ω̅}) or s₂^{#}(t _{ω̅}) or . . . or s_{Ω}^{#}(t _{ω̅})), which can be represented on the real resp. complex number plane,
or the properties or parameters of these signals or transfer functions or combinations or functions, the entire process is ended, otherwise for the same mean value of different
combinations (f̂(tₛ)) or combinations (f₁̂(tₛ), f₂̂(tₛ), . . . , fₚ̂(tₛ)) or signals (s₁(tₛ), s₂(tₛ), . . . , sₘ(tₛ)) or transfer functions (t₁(s₁(tₛ)), t₂(s₂(tₛ)), . . . , tₘ(sₘ(tₛ))), which can be represented on the real resp. complex number plane, 1≦s≦q,
or
freely definable functions (f^{#}(tι)) or freely definable functions (f₁^{#}(tι), f₂^{#}(tι), . . . , f_{μ}^{#}(tι)) or signals (s^{#}(tι)) or signals (s₁^{#}(tι), s₂^{#}(tι), . . . , s_{Ω}^{#}(tι)), which can be represented on the real resp. complex number plane, 1≦ι≦q,
or properties or parameters of these signals or transfer functions or combinations or functions, those signals or those transfer functions or those combinations or those functions or those properties or parameters are selected that so far appeared with the highest frequency, otherwise, insofar as several signals or transfer functions or combinations or functions or their properties or parameters occur with the same frequency, those are selected that exhibit the widest scattering, i.e. those for which the difference d−c is maximum, where d represents the last and c the first index number of the optimization steps respectively undergone, otherwise if this too applies to several signals or transfer functions or combinations or functions or their properties or parameters, the first ones that appear are selected, otherwise if two mean values from (ξ^{o}₁, ξ^{o}₂, . . . , ξ^{o}_{q}) are closest to (ξ*_{q}), in so far as in a q−1^{th} step one of the two mean values resp. their associated signals or transfer functions or combinations or functions or their properties or parameters are selected, the very same ones are retained and, in so far as the selected mean value then lies within the interval [−σ+ξ*_{q}, ξ*_{q}+σ], where σ represents the fictitious standard deviation σ>0, freely selectable by the user, by selecting, to be matched with this mean value, the signals or transfer functions or combinations or functions or their properties or parameters, the entire process is ended, otherwise a q+1^{th} step in the same form as presented for the q^{th} step is performed and the process is repeated as long as necessary until one mean value fulfills the above requirements or a maximum number of allowed optimization steps has been reached.

11. Method according to claim 1, wherein
the intersection points (ξₕ₁) of the sum of the complex transfer functions (f*[x(t₁)]=[x(t₁)/√ 2̅]*(−1+i) and g*[y(t₁)]=[y(t₁)/√ 2̅]*(1+i)) of the paired signal (x(t₁), y(t₁)), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, wherein hereinafter the abscissa axis of the real number plane is identical with the real axis of the complex number plane, and the ordinate axis of the real number plane is identical with the imaginary axis of the complex number plane, and then their mean value (
$${ξ°}_{1} := \begin{matrix}{k}_{1} \\ ( \sum {ξ}_{h 1} ) / {k}_{1} \\ {h}_{1} = 1 )\end{matrix}$$
is calculated;
the intersection points (ξₕ₂) of the sum of the complex transfer functions (f*[x(t₂)]=[x(t₂)/√ 2̅]*(−1+i) and g*[y(t₂)]=[y(t₂)/√ 2̅]*(1+i)) of the paired signal (x(t₂), y(t₂)), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, and then their mean value (
$${ξ°}_{2} := \begin{matrix}{k}_{2} \\ ( \sum {ξ}_{h2} ) / {k}_{2} \\ {h}_{2} = 1 )\end{matrix}$$
as well as the mean value (ξ*₂) of all intersection points (ξₕ₁, ξₕ₂
$${ξ}_{2}^{*} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 )\end{matrix}$$
are calculated, and, insofar as the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user, by selecting the signals (x(t_{υ}) or y(t_{υ})) or transfer functions (f*[x(t_{υ})]=[x(t)/√ 2̅]* (−1+i) or g*[y(t_{υ}]=[y(t_{υ})/√ 2̅]*(1+i)) or the sum of these transfer functions or specific properties or parameters of these signals or transfer functions or sum, to be matched with (ξ^{o}_{υ}), the entire process is ended, otherwise, provided both mean values (ξ^{o}₁, ξ^{o}₂) have the same distance to (ξ*₂), (ξ^{o}₁) is selected and, provided (ξ^{o}₁) lies within the interval [−σ+ξ*₂, ξ*₂+σ], by selecting signals (x (t₁) or y(t₁)) or transfer functions (f*[x(t₁)]=[x(t₁)/√ 2̅]*(−1+i) or g*[y(t₁)]=[y(t₁)/√ 2̅]*(1+i)) or the sum of these transfer functions or specific properties or parameters of these signals or transfer functions or sum, to be matched with (ξ^{o}₁), the entire process is ended, otherwise
in a q^{th} step, the intersection points (ξ_{hq}) of the sum of the complex transfer functions (f*[x(t_{q})]=[x(t_{q})/√ 2̅]*(−1+i) and g*[y(t_{q})]=[y(t_{q})/√ 2̅]*(1+i)) of the paired signal (x(t_{q}), y(t_{q})), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane are determined, and then their mean value (
$${ξ°}_{q} := \begin{matrix}{k}_{q} \\ ( \sum {ξ}_{hq} ) / {k}_{q} \\ {h}_{q} = 1 )\end{matrix}$$
as well as the mean value (ξ*_{q}) of all intersection points (ξₕ₁, ξₕ₂, . . . , ξ_{hq},
$${ξ}_{q}^{*} := \begin{matrix}{k}_{1} & & {k}_{2} & & {k}_{q} \\ ( \sum {ξ}_{h 1} & + & \sum {ξ}_{h 2} & + … + & \sum {ξ}_{hq} ) / ( {k}_{1} + {k}_{2} + … {k}_{q} ) \\ {h}_{1} = 1 & & {h}_{2} = 1 & & {h}_{q} = 1 ) ,\end{matrix}$$
are calculated, and, in so far as the mean value (ξ^{o} _{ω̅}) closest to (ξ*_{q}) where ω̅ is equal to 1 or 2 or . . . or q, then lies within the interval [−σ+ξ*_{q}, ξ*_{q}+σ], where σ represents the fictitious standard deviation σ>0, freely selectable by the user, by selecting signals (x(t _{ω̅}) or y(t _{ω̅})) or transfer functions (f*[x(t _{ω̅})]=[x(t _{ω̅})/√ 2̅]*(−1+i) or g*[y(t _{ω̅})]=[y(t _{ω̅})/√ 2̅]*(1+i)) or the sum of these transfer functions or specific properties or parameters of these signals or transfer functions or sum, to be matched with (ξ^{o} _{ω̅}), the entire process is ended, otherwise in case of the same mean value of different signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, 1≦s≦q, those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum are selected thatso far appeared with the highest frequency, otherwise, insofar as as several signals (x(tₛ) or y(tₛ)) or transfer functions (f*[x(tₛ]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums occur with the same frequency, those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum are selected that exhibit the widest scattering, i.e. those for which the difference d−c is maximum, where d represents the last and c the first index number of the optimization steps respectively undergone, otherwise if this too applies to several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, the first one that appears resp. its signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum are selected, otherwise, if two mean values from) ξ^{o}₁, ξ^{o}₂, . . . , ξ^{o}_{q}) are closest to (ξ*_{q}), in so far as in a q−1^{th} step one of the two mean values resp. its associated signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum are selected, the very same ones are retained, and, in so far as the selected mean value then lies within the interval [−σ+ξ*_{q}, ξ*_{q}+σ], where σ represents the fictitious standard deviation σ>0, freely selectable by the user, by selecting, to be matched with this mean value, the signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum, the entire process is ended, otherwise
a q+1^{th} step in the same form as presented for the qth step is performed and the process is repeated as long as necessary until one mean value fulfills the above requirements or a maximum number of allowed optimization steps has been reached,
or that
the intersection points (ξₕ₁) of the sum of the complex transfer functions (f*[x(t₁)]=[x(t₁)/√ 2̅]*(−1+i) and g*[y(t₁)]=[y(t₁)/√ 2̅]*(1+i)) of the paired signal (x(t₁), y(t₁)), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, wherein hereinafter the abscissa axis of the real number plane is identical with the real axis of the complex number plane, and the ordinate axis of the real number plane is identical with the imaginary axis of the complex number plane, and then their mean value (
$${ξ°}_{1} := \begin{matrix}{k}_{1} \\ ( \sum {ξ}_{h 1} ) / {k}_{1} \\ {h}_{1} = 1 )\end{matrix}$$
is calculated;
the intersection points (ξₕ₂) of the sum of the complex transfer functions (f*[x(t₂)]=[x(t₂)/√ 2̅]*(−1+i) and g*[y(t₂)]=[y(t₂)/√ 2̅]*(1+i)) of the paired signal (x(t₂), y(t₂)), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, and then their mean value (
$${ξ°}_{2} := \begin{matrix}{k}_{2} \\ ( \sum {ξ}_{h 2} ) / {k}_{2} \\ {h}_{2} = 1 )\end{matrix}$$
as well as the mean value (ξ*₂) of all intersection points (ξₕ₁, ξₕ₂
$${ξ}_{2}^{*} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 )\end{matrix}$$
are calculated, and, insofar as the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user, by selecting the signals (x(t_{υ}) or y(t_{υ})) or transfer functions (f*[x(t_{υ})]=[x(t_{υ})/√ 2̅]* (−1+i) or g*[y(t_{υ}]=[y(t_{υ})/√ 2̅]*(1+i)) or the sum of these transfer functions or specific properties or parameters of these signals or transfer functions or sum, to be matched with (ξ^{o}_{υ}), the entire process is ended, otherwise, provided both mean values (ξ^{o}₁, ξ^{o}₂) have the same distance to (ξ*₂), (ξ^{o}₁) is selected and, provided (ξ^{o}₁) lies within the interval [−σ+ξ*₂, ξ*₂+σ], by selecting signals (x(t₁) or y(t₁)) or transfer functions (f*[x(t₁)]=[x(t₁)/√ 2̅]*(−1+i) or g*[y(t₁)]=[y(t₁)/√ 2̅]*(1+i)) or the sum of these transfer functions or specific properties or parameters of these signals or transfer functions or sum, to be matched with (ξ^{o}₁), the entire process is ended, otherwise
in a q^{th} step, the intersection points (ξ_{hq}) of the sum of the complex transfer functions (f*[x(t_{q})]=[x(t_{q})/√ 2̅]*(−1+i) and g*[y(t_{q})]=[y(t_{q})/√ 2̅]*(1+i)) of the paired signal (x(t_{q}), y(t_{q})), which can be represented on the complex or real number plane, with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane are determined, and then their mean value (
$${ξ°}_{q} := \begin{matrix}{k}_{q} \\ ( \sum {ξ}_{hq} ) / {k}_{q} \\ {h}_{q} = 1 )\end{matrix}$$
as well as the mean value (ξ*_{q}) of all intersection points (ξₕ₁, ξₕ₂, . . . , ξ_{hq},
$${ξ}_{q}^{*} := \begin{matrix}{k}_{1} & & {k}_{2} & & {k}_{q} \\ ( \sum {ξ}_{h 1} & + & \sum {ξ}_{h 2} & + … + & \sum {ξ}_{hq} ) / ( {k}_{1} + {k}_{2} + … {k}_{q} ) \\ {h}_{1} = 1 & & {h}_{2} = 1 & & {h}_{q} = 1 ) ,\end{matrix}$$
are calculated, and, in so far as the mean value (ξ^{o} _{ω̅}) closest to (ξ*_{q}) where ω̅ is equal to 1 or 2 or . . . or q, then lies within the interval [−σ+ξ*_{q}, ξ*_{q}+σ], where σ represents the fictitious standard deviation σ>0, freely selectable by the user, by selecting signals (x(t _{ω̅}) or y(t _{ω̅})) or transfer functions (f*[x(t _{ω̅})]=[x(t _{ω̅})/√ 2̅]*(−1+i) or g*[y(t _{ω̅})]=[y(t _{ω̅})/√ 2̅]*(1+i)) or the sum of these transfer functions or specific properties or parameters of these signals or transfer functions or sum, to be matched with (ξ^{o} _{ω̅}), the entire process is ended, otherwise in case of the same mean value of different signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, 1≦s≦q, those signals (x(tₛ) or y(tₛ)) or transfer functions (f*[x(tₛ)]=[x(tₛ)/√ 2̅]*(−1+i) or g*[y(tₛ)]=[y(tₛ)/̂ 2̅]*(1+i)) or the sum of these transfer functions or specific properties or parameters of these signals or transfer functions or sum are selected that so far appeared with the highest frequency, otherwise, in so far as as several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums occur with the same frequency, those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum are selected that exhibit the widest scattering, i.e. those for which the difference d−c is maximum, where d represents the last and c the first index number of the optimization steps respectively undergone, otherwise if this too applies to several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, the first one that appears resp. its signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum are selected, otherwise, if two mean values from (ξ^{o}₁, ξ^{o}₂, . . . , ξ^{o}_{q}) are closest to (ξ*_{q}), in so far as in a q−1^{th} step one of the two mean values resp. its associated signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum are selected, the very same ones are retained, and, in so far as the selected mean value then lies within the interval [−σ+ξ*_{q}, ξ*_{q}+σ], where σ represents the fictitious standard deviation >0, freely selectable by the user, by selecting, to be matched with this mean value, the signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum, the entire process is ended, otherwise
a q+1^{th} step in the same form as presented for the q^{th} step is performed and the process is repeated as long as necessary until one mean value fulfills the above requirements or a maximum number of allowed optimization steps has been reached.

12. Method according to claim 1, comprising the additional use of compression methods or data reduction methods or other selective evaluation methods.

13. A device with
means for evaluating a combination(f̂(t)) or several combinations (f₁̂(t), f₂̂(t), . . . , fₚ̂(t)) of two or more signals (s₁(t), s₂(t), . . . , sₘ(t)) resp. of their transfer functions (t₁(s₁(t)), t₂(s₂(t)), . . . , tₘ(sₘ(t))), which can be represented on the real resp. complex number plane, wherein (s₁(t)) represents the function value of the first signal at the point in time t, (s₂(t)) represents the function value of the second signal at the point in time t, . . . , (sₘ(t)) represents the function value of the m^{th} signal at the point in time t,
or
means for evaluating a freely definable function (f^{#}(t)) or freely definable functions (f₁^{#}(t), f₂^{#}(t), . . . , f_{μ}^{#}(t)) of one signal (s^{#}(t)) or of several signals (s₁^{#}(t), s₂^{#}(t), . . . , s_{Ω}^{#}(t)), which can be represented on the real resp. complex number plane, wherein (s₁^{#}(t)) represents the function value of the first signal at the point in time t, (s₂^{#}(t)) represents the function value of the second signal at the point in time t, . . . , (s_{Ω}^{#}(t)) represents the function value of the Ω^{th} signal at the point in time t,
Said device further comprising
means for determining the invariants of one function or of several functions of the combination (f̂(t)) or of the combinations (f₁̂(t), f₂̂(t), . . . , fₚ̂(t)) for one or several signal sections (t₁, t₂, . . . , t_{χ}),
or
means for determining the invariants of one function or of several functions of the freely definable function (f^{#}(t)) or of the freely definable functions(f₁^{#}(t), f₂^{#}(t), . . . , f_{μ}^{#}(t)) for one or several signal sections (t₁, t₂, . . . , t_{ç}).

14. Device according to claim 13, with
means for evaluating a combination(f̂(t)) or several combinations (f₁̂(t), f₂̂(t), . . . , fₚ̂(t)) of two or more signals (s₁(t), s₂(t), . . . , sₘ(t)) resp. of their transfer functions (t₁(s₁(t)), t₂(s₂(t)), . . . , tₘ(sₘ(t))), which can be represented on the real resp. complex number plane,
or
means for evaluating a freely definable function (f^{#}(t)) or freely definable functions (f₁^{#}(t), f₂^{#}(t), . . . , f_{μ}^{#}(t)) of one signal (s^{#}(t)) or of several signals (s₁^{#}(t), s₂^{#}(t), . . . , s_{Ω}^{#}(t)), which can be represented on the real resp. complex number plane,
said device further comprising
means for determining the invariants of one function or of several functions which, if necessary after appropriate conversion, use the function by means of an equation in the form of (Av₁²+Bv₂²+Cv₃²+2Fv₂v₃+2Gv₃v₁+2Hv₁v₂=0), of the combination (f̂(t)) or of the combinations (f₁̂(t), f₂̂(t), . . . , fₚ̂(t)) for one or several signal sections (t₁, t₂, . . . , t_{χ}),
or
means for determining the invariants of one function or of several functions which, if necessary after appropriate conversion, use the function by means of an equation in the form of (Av₁²+Bv₂²+Cv₃²+2Fv₂v₃+2Gv₃v₁+2Hv₁v₂=0), of the freely definable function (f^{#}(t)) or of the freely definable functions (f₁^{#}(t), f₂^{#}(t), . . . , f_{μ}^{#}(t)) for one or several signal sections (t₁, t₂, . . . , t_{ç}).

15. Device according to claim 13, in which the invariants, if necessary after appropriate conversion, can be represented as linear combination of invariants resp. of vectors on one plane which, if necessary after appropriate conversion, is vertical to the real or complex number plane and crosses the latter, if necessary after rotation or appropriate conversion, in the diagonal of the 1^{st} and 3^{rd} quadrants.

16. Device according to claim 13, comprising means which use the intersection points of these invariants resp. vectors with the real or complex number plane, on which
the analyzed combination (f̂(t)) or the analyzed combinations (f₁̂(t), f₂̂(t), . . . , fₚ̂(t))
or
the analyzed, freely definable function (f^{#}(t)) or the analyzed, freely definable functions (f₁^{#}(t), f₂^{#}(t), . . . , f_{μ}^{#}(t)),
if necessary after appropriate conversion, can be represented.

17. Device according to claim 13, wherein said signals (s₁(t), s₂(t), . . . , sₘ(t) resp. s^{#}(t) resp. s₁^{#}(t), s₂^{#}(t), . . . , s_{Ω}^{#}(t) (resp. x(t), y(t) resp. x_{#} (t), y_{#}(t))) are audio signals.

18. Device according to claim 13, comprising means for selecting, according to statistical and other criteria, on the basis of the determined invariants or, if necessary after appropriate conversion, the intersection points of these invariants resp. vectors with the real or complex number plane, on which
the analyzed combination (f̂(t)) or the analyzed combinations(f₁̂(t), f₂̂(t), . . . , fₚ̂(t))
or
the analyzed, freely definable function(f^{#}(t)) or the analyzed, freely definable functions(f₁^{#}(t), f₂^{#}(t), . . . , f_{μ}^{#}(t)),
is/are located, if necessary after appropriate conversion, or also on the basis of a selection of these invariants or intersection points.

19. Device according to claim 13, comprising means for normalizationas regards the amplitude or other properties of
the analyzed combination (f̂(t)) or the analyzed combinations (f₁̂(t), f₂̂(t), . . . , fₚ̂(t)) or the used two or more signals (s₁(t), s₂(t), . . . , sₘ(t)) or the used transfer functions (t₁(s₁(t)), t₂(s₂(t)), . . . , tₘ(sₘ(t))), which can be represented on the real resp. complex number plane,
or
the analyzed, freely definable function (f^{#}(t)) or the analyzed, freely definable functions (f₁^{#}(t), f₂^{#}(t), . . . , f_{μ}^{#}(t)) or the used signal (s^{#}(t)) or the used signals (s₁^{#}(t), s₂^{#}(t), . . . , s_{Ω}^{#}(t)), which can be represented on the real resp. complex number plane.

20. Device according to claim 19, comprising means for normalization on the basis of the signal level.

21. Device according to claim 19, comprising means for normalization on the basis of the mean-square energy.

22. Device according to claim 13, comprising means for determining
the intersection points (ξₕ₁) of the combination (f̂(t₁)) or of the combinations (f₁̂(t₁), f₂̂(t₁), . . . , fₚ̂(t₁)) of two or more signals (s₁(t₁), s₂(t₁), . . . , sₘ(t₁)) resp. of their transfer functions (t₁(s₁(t₁)), t₂(s₂(t₁)), . . . , tₘ(sₘ(t₁))), which can be represented on the real resp. complex number plane,
or
the intersection points (ξₕ₁) of the freely definable function (f^{#}(t₁)) or of the freely definable functions (f₁^{#}(t₁), f₂^{#}(t₁), . . . , f_{μ}^{#}(t₁)) of the signal (s^{#}(t₁)) or of the signals (s₁^{#}(t₁), s₂^{#}(t₁), . . . , s_{Ω}^{#}(t₁)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane, wherein hereinafter the abscissa axis of the real number plane is identical with the real axis of the complex number plane, and the ordinate axis of the real number plane is identical with the imaginary axis of the complex number plane, and then determining their mean value (
$${ξ°}_{1} := \begin{matrix}{k}_{1} \\ ( \sum {ξ}_{h 1} ) / {k}_{1} \\ {h}_{1} = 1 ) ;\end{matrix}$$
as well as means for subsequently determining
the intersection points (ξₕ₂) of the combination (f̂(t₂)) or of the combinations (f₁̂(t₂), f₂̂(t₂), . . . , fₚ̂(t₂)) of two or more signals (s₁(t₂), s₂(t₂), . . . , sₘ(t₂)) resp of their transfer functions (t₁(s₁(t₂)), t₂(s₂(t₂)), . . . , tₘ(sₘ(t₂))) which can be represented on the real resp complex number plane,
or
the intersection points (ξₕ₂) of the freely definable function(f^{#}(t₂)) or of the freely definable functions(f₁^{#}(t₂), f₂^{#}(t₂), . . . , f_{μ}^{#}(t₂)) of the signal (s^{#}(t₂)) or of the signals (s₁^{#}(t₂), s₂^{#}(t₂), . . . , s_{Ω}^{#}(t₂)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane, and then determining their mean value (
$${ξ°}_{2} := \begin{matrix}{k}_{2} \\ ( \sum {ξ}_{h 2} ) / {k}_{2} \\ {h}_{2} = 1 )\end{matrix}$$
as well as the mean value (ξ*₂) of all intersection points (ξₕ₁, ξₕ₂
$${ξ}_{2}^{*} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 )\end{matrix}$$
as well as means for determining whether the mean value (ξ^{o}_{υ}) closest to (ξ*₂), where u is equal to 1 or 2, then lies within the interval [−σ+ξ*₂, ξ*₂+σ], where σ represents the fictitious standard deviation σ>0, freely selectable by the user also by a means, as well as, if this is the case, for selecting, to be matched with (ξ^{o}_{υ}),
the combination (f̂(t_{υ})) or combinations (f₁̂(t_{υ}) or f₂̂(t_{υ}) or . . . or fₚ̂(t_{υ})) or signals (s₁(t_{υ}) or s₂(t_{υ}) or . . . or sₘ(t_{υ})) or the transfer functions (t₁(s₁(t_{υ})) or t₂(s₂(t_{υ})) or . . . or tₘ(sₘ(t_{υ}))), which can be represented on the real resp. complex number plane,
or
the freely definable function (f^{#}(t_{υ})) or freely definable functions (f₁^{#}(t_{υ}) or f₂^{#}(t_{υ}) or . . . or f_{μ}^{#}(t_{υ}) or signals (s^{#}(t_{υ})) or (s₁^{#}(t_{υ}) or s₂^{#}(t_{υ}) or . . . or s_{Ω}^{#}(t_{υ})), which can be represented on the real resp. complex number plane,
or the properties or parameters of these signals or transfer functions or combinations or functions, as well as means for ending the entire process if this is the case, as well as for determining whether possibly two mean values (ξ^{o}₁, ξ^{o}₂) have the same distance to (ξ*₂), and if this is the case, for selecting (ξ^{o}₁), as well as for determining whether the first mean value (ξ^{o}₁) lies within the interval [−σ+ξ*₂, ξ*₂+σ], where σ represents the fictitious standard deviation σ>0, freely selectable by the useralso by a means, as well as, if this is the case, for selecting, to be matched with (ξ^{o}₁),
the combination (f̂(t₁)) or combinations (f₁̂(t₁) or f₂̂(t₁) or . . . or fₚ̂(t₁)) or signals (s₁(t₁) or s₂(t₁) or . . . or sₘ(t₁)) or the transfer functions t₁(s₁(t₁)) or t₂(s₂(t₁)) or . . . or tₘ(sₘ(t₁))), which can be represented on the real resp. complex number plane,
or
the freely definable function (f^{#}(t₁)) or freely definable functions (f₁^{#}(t₁) or f₂^{#}(t₁) or . . . or f_{μ}^{#}(t₁)) or signals (s^{#}(t₁)) or (s₁^{#}(t₁) or s₂^{#}(t₁) or . . . or s_{Ω}^{#}(t₁)), which can be represented on the real resp. complex number plane,
or the properties or parameters of these signals or transfer functions or combinations or functions, as well as means for ending the entire process if this is the case, as well as means for determining
the intersection points (ξ_{hq}) of the combination (f̂(t_{q})) or of the combinations (f₁̂(t_{q}), f₂̂(t_{q}), . . . , fₚ̂(t_{q})) of two or more signals (s₁(t_{q}), s₂(t_{q}), . . . , sₘ(t_{q})) resp. of their transfer functions (t₁(s₁(t_{q})), t₂(s₂(t_{q})), . . . , tₘ(sₘ(t_{q}))), which can be represented on the real resp. complex number plane,
or
the intersection points (ξ_{hq}) of the freely definable function(f^{#}(t_{q})) or of the freely definable functions(f₁^{#}(t_{q}), f₂^{#}(t_{q}), . . . , f_{μ}^{#}(t_{q})) of the signal (s^{#}(t_{q})) or of the signals (s₁^{#}(t_{q}), s₂^{#}(t_{q}), . . . , s_{Ω}^{#}(t_{q})), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 1^{st} quadrant of the complex or real number plane, this in a q^{th} step, and then determining their mean value (
$${ξ°}_{q} := \begin{matrix}{k}_{q} \\ ( \sum {ξ}_{hq} ) / {k}_{q} \\ {h}_{q} = 1 )\end{matrix}$$
as well as the mean value (ξ*_{q}) of all intersection points (ξₕ₁, ξₕ₂, . . . , ξ_{hq}
$${ξ}_{q}^{*} := \begin{matrix}{k}_{1} & & {k}_{2} & & {k}_{q} \\ ( \sum {ξ}_{h 1} & + & \sum {ξ}_{h 2} & + … + & \sum {ξ}_{hq} ) / ( {k}_{1} + {k}_{2} + … {k}_{q} ) \\ {h}_{1} = 1 & & {h}_{2} = 1 & & {h}_{q} = 1 )\end{matrix}$$
as well as means for determining whether the mean value (ξ^{o} _{ω̅}) closest to (ξ*_{q}), where ω̅ is equal to 1 or 2 or . . . or q, then lies within the interval [−σ+ξ*_{q}, ξ*_{q}+σ], where σ represents the fictitious standard deviation σ>0, freely selectable by the user also by a means, and if this is the case, for selecting, to be matched with (ξ^{o} _{ω̅}),
the combination (f̂(t _{ω̅})) or combinations (f₁̂(t _{ω̅}) or f₂̂(t _{ω̅}) or . . . or fₚ̂(t _{ω̅})) or signals (s₁(t _{ω̅}) or s₂(t _{ω̅}) or . . . or sₘ(t _{ω̅})) or transfer functions (t₁(s₁(t _{ω̅})) or t₂(s₂(t _{ω̅})) or . . . or tₘ(sₘ(t _{ω̅}))), which can be represented on the real resp. complex number plane,
or
the freely definable function (f^{#}(t _{ω̅})) or freely definable functions (f₁^{#}(t _{ω̅}) or f₂^{#}(t _{ω̅}) or . . . or f_{μ}^{#}(t _{ω̅})) or signals (s^{#}(t _{ω̅})) or (s₁^{#}(t _{ω̅}) or s₂^{#}(t _{ω̅}) or . . . or s_{Ω}^{#}(t _{ω̅})), which can be represented on the real resp. complex number plane,
or the properties or parameters of these signals or transfer functions or combinations or functions, as well as means for ending the entire process if this is the case, as well as means for determining if for the same mean value, different
combinations (f̂(tₛ)) or combinations (f₁̂(tₛ), f₂̂(tₛ), . . . , fₚ̂(tₛ)) or signals (s₁(tₛ), s₂(tₛ), . . . , Sₘ(tₛ)) or transfer functions (t₁(s₁(tₛ)), t₂(S₂(tₛ)), . . . , tₘ(sₘ(tₛ))), which can be represented on the real resp. complex number plane, 1≦s≦q,
or
freely definable functions (f^{#}(tι) or freely definable functions (f₁^{#}(tι), f₂^{#}(tι), . . . , f_{μ}^{#}(tι)) or signals (s^{#}(tι) or signals (s₁^{#}(tι), s₂^{#}(tι), . . . , s_{Ω}^{#}(tι)), which can be represented on the real resp. complex number plane, 1≦ι≦q,
or properties or parameters of these signals or transfer functions or combinations or functions exist, and, if this is the case, for selecting those signals or those transfer functions or those combinations or those functions or those properties or parameters of these signals or transfer functions or combinations or functions, that so far appeared with the highest frequency, as well as for determining whether several signals or transfer functions or combinations or functions or properties or parameters of these signals or transfer functions or combinations or functions occur with the same frequency, and if this is the case for selecting those signals or those transfer functions or those combinations or those functions or those properties or parameters of these signals or transfer functions or combinations or functions that exhibit the widest scattering, i.e. those for which the difference d—c is maximum, where d represents the last and c the first index number of the optimization steps respectively undergone, as well as means for determining whether this too applies to several signals or transfer functions or combinations or functions or properties or parameters of these signals or transfer functions or combinations or functions, and if this is the case, for selecting the first ones that appear as well as for determining whether two mean values from (ξ^{o}₁, ξ^{o}₂, . . . , ξ^{o}_{q}) are closest to (ξ*_{q}), and if this is the case, for determining whether in a q−1^{th} step one of the two mean values resp. their associated signals or transfer functions or combinations or functions or properties or parameters of these signals or transfer functions or combinations or functions have been selected, and if this is the case, for retaining those signals or transfer functions or combinations or functions or properties or parameters of these signals or transfer functions or combinations or functions, as well as means for determining whether the thus selected mean value then lies within the interval [−σ+ξ*_{q}, ξ*_{q}+σ], where σ represents the fictitious standard deviation σ>0, freely selectable by the user also by a means, and if this is the case for selecting, to be matched with this mean value, the signals or transfer functions or combinations or functions or the properties or parameters of these signals or transfer functions or combinations or functions, as well as means for ending the entire process if this is the case, as well as means for performing a q+1^{th} step in the same form as presented for the q^{th} step and for continuing the process and for determining whether one mean value fulfills the above requirements or a maximum number of allowed optimization steps has been reached, and thus whether the process should be ended, and if this is the case, for ending the entire process;
or also means for determining
the intersection points (ξₕ₁) of the combination (f̂(t₁)) or of the combinations (f₁̂(t₁), f₂̂(t₁), . . . , fₚ̂(t₁)) of two or more signals (s₁(t₁), s₂(t₁), . . . , sₘ(t₁)) resp. of their transfer functions (t₁(s₁(t₁)), t₂(s₂(t₁)), . . . , tₘ(sₘ(t₁))), which can be represented on the real resp. complex number plane
or
the intersection points (ξₕ₁) of the freely definable function(f^{#}(t₁)) or of the freely definable functions(f₁^{#}(t₁), f₂^{#}(t₁), . . . , f_{μ}^{#}(t₁)) of the signal (s^{#}(t₁)) or of the signals (s₁^{#}(t₁), s₂^{#}(t₁), . . . , s_{Ω}^{#}(t₁)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane, wherein hereinafter the abscissa axis of the real number plane is identical with the real axis of the complex number plane, and the ordinate axis of the real number plane is identical with the imaginary axis of the complex number plane, and then determining their mean value (
$${ξ°}_{1} := \begin{matrix}{k}_{1} \\ ( \sum {ξ}_{h 1} ) / {k}_{1} \\ {h}_{1} = 1 )\end{matrix}$$
as well as means for subsequently determining
the intersection points (ξₕ₂) of the combination (f̂(t₂)) or of the combinations (f̂(t₂), f₂̂(t₂), . . . , fₚ̂(t₂)) of two or more signals (s₁(t₂), s₂(t₂), . . . , sₘ(t₂)) resp. of their transfer functions (t₁(s₁(t₂)), t₂(s₂(t₂)), . . . , tₘ(sₘ(t₂))), which can be represented on the real resp. complex number plane,
or
the intersection points (ξₕ₂) of the freely definable function(f^{#}(t₂)) or of the freely definable functions(f₁^{#}(t₂), f₂^{#}(t₂), . . . , f_{μ}^{#}(t₂)) of the signal (s^{#}(t₂)) or of the signals (s₁^{#}(t₂), s₂^{#}(t₂), . . . , s_{Ω}^{#}(t₂)), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane, and then determining their mean value (
$${ξ°}_{2} := \begin{matrix}{k}_{2} \\ ( \sum {ξ}_{h 2} ) / {k}_{2} \\ {h}_{2} = 1 )\end{matrix}$$
as well as the mean value (ξ*₂) of all intersection points (ξₕ₁, ξₕ₂
$${{ξ}^{*}}_{2} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 )\end{matrix}$$
as well as means for determining whether the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the useralso by a means, and if this is the case, for selecting, to be matched with (ξ^{o}_{υ}),
the combination (f̂(t_{υ})) or combinations (f₁̂(t_{υ}) or f₂̂(t_{υ}) or . . . or fₚ̂(t_{υ})) or signals (s₁(t_{υ}) or s₂(t_{υ}) or . . . or sₘ(t_{υ})) or the transfer functions (t₁(s₁(t_{υ})) or t₂(s₂(t_{υ})) or . . . or tₘ(sₘ(t_{υ}))), which can be represented on the real resp. complex number plane
or
the freely definable function (f^{#}(t_{υ})) or freely definable functions (f₁^{#}(t_{υ}) or f₂^{#}(t_{υ}) or . . . or f_{μ}^{#}(t_{υ})) or signals (s^{#}(t_{υ})) or (s₁^{#}(t_{υ}) or s^{#}(t_{υ}) or . . . or s_{Ω}^{#}(t_{υ})), which can be represented on the real resp. complex number plane,
or the properties or parameters of these signals or transfer functions or combinations or functions, as well as means for ending the entire process if this is the case, as well as for determining whether possibly two mean values (ξ^{o}₁, ξ^{o}₂) have the same distance to (ξ*₂), as well as for selecting (ξ^{o}₁) if this is the case, as well as determining whether the first mean value (ξ^{o}₁) lies within the interval [−σ+ξ*₂, ξ*₂+σ], where σ represents the fictitious standard deviation σ>0, freely selectable by the useralso by a means, and if this is the case, for selecting, to be matched with (ξ^{o}₁),
the combination (f̂(t₁)) or combinations (f₁̂(t₁) or f₂̂(t₁) or . . . or fₚ̂(t₁)) or signals (s₁(t₁) or s₂(t₁) or . . . or sₘ(t₁)) or the transfer functions (t₁(s₁(t₁)) or t₂(s₂(t₁)) or . . . or tₘ(sₘ(t₁))), which can be represented on the real resp. complex number plane,
or
the freely definable function (f^{#}(t₁)) or freely definable functions (f₁^{#}(t₁) or f₂^{#}(t₁) or . . . or f_{μ}^{#}(t₁)) or signals (s^{#}(t₁)) or (s₁^{#}(t₁) or s₂^{#}(t₁) or . . . or s_{Ω}^{#}(t₁)), which can be represented on the real resp. complex number plane,
or the properties or parameters of these signals or transfer functions or combinations or functions, as well as means for ending the entire process if this is the case, as well as means for determining
the intersection points (ξ_{hq}) of the combination (f̂(t_{q})) or of the combinations (f₁̂(t_{q}), f₂̂(t_{q}), . . . , fₚ̂(t_{q})) of two or more signals (s₁(t_{q}), s₂(t_{q}), . . . , sₘ(t_{q})) resp. of their transfer functions (t₁(s₁(t_{q})), t₂(s₂(t_{q})), . . . , tₘ(sₘ(t_{q}))), which can be represented on the real resp. complex number plane,
or
the intersection points (ξ_{hq}) of the freely definable function(f^{#}(t_{q})) or of the freely definable functions(f₁^{#}(t_{q}), f₂^{#}(t_{q}), . . . , f_{μ}^{#}(t_{q})) of the signal (s^{#}(t_{q})) or of the signals (s₁^{#}(t_{q}), s₂^{#}(t_{q}), . . . , s_{Ω}^{#}(t_{q})), which can be represented on the real resp. complex number plane,
with, if necessary after appropriate conversion, the half-plane spanned by the vectors (1, 1, −2) and (1, 1, 1) or also (−1, −1, 2) and (1, 1, 1) and located in the 3^{rd} quadrant of the complex or real number plane, this in a in a q^{th} step, and then determining their mean value (
$${ξ°}_{q} := \begin{matrix}{k}_{q} \\ ( \sum {ξ}_{h q} ) / {k}_{q} \\ {h}_{q} = 1 )\end{matrix}$$
as well as the mean value (ξ*_{q}) of all intersection points (ξₕ₁, ξₕ₂, . . . , ξ_{hq}
$${{ξ}^{*}}_{q} := \begin{matrix}{k}_{1} & & {k}_{2} & & {k}_{q} \\ ( \sum {ξ}_{h 1} & + & \sum {ξ}_{h 2} & + … + & \sum {ξ}_{h q} ) / ( {k}_{1} + {k}_{2} + … {k}_{q} ) \\ {h}_{1} = 1 & & {h}_{2} = 1 & & {h}_{q} = 1 )\end{matrix}$$
as well as means for determining whether the mean value (ξ^{o} _{ω̅}) closest to (ξ*_{q}), where ω̅ is equal to 1 or 2 or . . . or q, then lies within the interval [−σ+ξ*_{q}, ξ*_{q}+σ], where σ represents the fictitious standard deviation σ>0, freely selectable by the user also by a means, and if this is the case for selecting, to be matched with (ξ^{o} _{ω̅}),
the combination (f̂(t _{ω̅})) or combinations (f₁̂(t _{ω̅}) or f₂̂(t _{ω̅}) or . . . or fₚ̂(t _{ω̅})) or signals (s₁(t _{ω̅}) or s₂(t _{ω̅}) or . . . or sₘ(t _{ω̅})) or the transfer functions (t₁(s₁(t _{ω̅})) or t₂(s₂(t _{ω̅})) or . . . or tₘ(sₘ(t _{ω̅}))), which can be represented on the real resp. complex number plane,
or
the freely definable function (f^{#}(t _{ω̅})) or freely definable functions (f₁^{#}(t _{ω̅}) or f₂^{#}(t _{ω̅}) or . . . or f_{μ}^{#}(t _{ω̅})) or signals (s^{#}(t _{ω̅})) or (s₁^{#}(t _{ω̅}) or s₂^{#}(t _{ω̅}) or . . . or s_{Ω}^{#}(t _{ω̅})), which can be represented on the real resp. complex number plane,
or the properties or parameters of these signals or transfer functions or combinations or functions, as well as means for ending the entire process if this is the case, as well as means for determining whether for the same mean value of different
combinations (f̂(tₛ)) or combinations (f₁̂(tₛ), f₂̂(tₛ), . . . , fₚ̂(tₛ)) or signals (s₁(tₛ), s₂(tₛ), . . . , sₘ(tₛ)) or transfer functions (t₁(s₁(tₛ)), t₂(s₂(tₛ)), . . . , tₘ(sₘ(tₛ))), which can be represented on the real resp. complex number plane, 1≦s≦q,
or
freely definable functions (f^{#}(tι) or freely definable functions (f₁^{#}(tι), f₂^{#}(tι), . . . , f_{μ}^{#}(tι)) or signals (s^{#}(tι)) or signals (s₁^{#}(tι), s₂^{#}(tι), . . . , s_{Ω}^{#}(tι)), which can be represented on the real resp. complex number plane, 1≦ι≦q,
or properties or parameters of these signals or transfer functions or combinations or functions exist, and, if this is the case, for selecting those signals or those transfer functions or those combinations or those functions or those properties or parameters of these signals or transfer functions or combinations or functions, that so far appeared with the highest frequency, as well as for determining whether several signals or transfer functions or combinations or functions or properties or parameters of these signals or transfer functions or combinations or functions occur with the same frequency, and if this is the case for selecting those signals or those transfer functions or those combinations or those functions or those properties or parameters of these signals or transfer functions or combinations or functions that exhibit the widest scattering, i.e. those for which the difference d−c is maximum, where d represents the last and c the first index number of the optimization steps respectively undergone, as well as means for determining whether this too applies to several signals or transfer functions or combinations or functions or properties or parameters of these signals or transfer functions or combinations or functions, and if this is the case, for selecting the first ones that appear, as well as for determining whether two mean values from (ξ^{o}₁, ξ^{o}₂, . . . , ξ^{o}_{q}) are closest to (ξ*_{q}), and if this is the case, for determining whether in a q−1^{th} step one of the two mean values resp. their associated signals or transfer functions or combinations or functions or properties or parameters of these signals or transfer functions or combinations or functions have been selected, and if this is the case, for retaining those signals or transfer functions or combinations or functions or the properties or parameters of these signals or transfer functions or combinations or functions, as well as means for determining whether the thus selected mean value then lies within the interval [−σ+ξ*_{q}, ξ*_{q}+σ], where σ represents the fictitious standard deviation σ>0, freely selectable by the user also by a means, and if this is the case for selecting, to be matched with this mean value, the signals or transfer functions or combinations or functions or the properties or parameters of these signals or transfer functions or combinations or functions, as well as means for ending the entire process if this is the case, as well as means for performing a q+1^{th} step in the same form as presented for the q^{th} step and for continuing the process and for determining whether one mean value fulfills the above requirements or a maximum number of allowed optimization steps has been reached, and thus whether the process should be ended, and if this is the case, for ending the entire process.

23. Device according to claim 13, comprising means
for determining the intersection points (ξₕ₁) of the sum of the complex transfer functions (f*[x(t₁)]=[x(t₁)/√ 2̅]*(−1+i) and g*[y(t₁)]=[y(t₁)/√ 2̅]*(1+i)) of the paired signal (x(t₁), y(t₁)), which can be represented on the complex or real number plane, if necessary after appropriate conversion, with the half-plane spanned by the vectors (1, 1, −2) and (1, 1, 1) or also (−1, −1, 2) and (1, 1, 1) and located in the 1^{st} quadrant of the complex or real number plane, wherein hereinafter the abscissa axis of the real number plane is identical with the real axis of the complex number plane, and the ordinate axis of the real number plane is identical with the imaginary axis of the complex number plane, and then determining their mean value (
$${ξ°}_{1} := \begin{matrix}{k}_{1} \\ ( \sum {ξ}_{h 1} ) / {k}_{1} \\ {h}_{1} = 1 ) ;\end{matrix}$$
for subsequently determining the intersection points (ξₕ₂) of the sum of the complex transfer functions (f*[x(t₂)]=[x(t₂)/√ 2̅]*(−1+i) and g*[y(t₂)]=[y(t₂)/√ 2̅]*(1+i)) of the paired signal (x(t₂), y(t₂)), which can be represented on the complex or real number plane, if necessary after appropriate conversion, with the half-plane spanned by the vectors (1, 1, −2) and (1, 1, 1) or also (−1, −1, 2) and (1, 1, 1) and located in the 1^{st} quadrant of the complex or real number plane, and then determining their mean value (
$${ξ°}_{2} := \begin{matrix}{k}_{2} \\ ( \sum {ξ}_{h 2} ) / {k}_{2} \\ {h}_{2} = 1 )\end{matrix}$$
as well as the mean value (ξ*₂) of all intersection points (ξₕ₁, ξₕ₂
$${{ξ}^{*}}_{2} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 )\end{matrix}$$
as well as for determining whether the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user, as well as for selecting the signals (x(t_{υ}) or y(t_{υ})) or transfer functions (f*[x(t_{υ})]==[x(t_{υ})/√ 2̅]*(−1+i) or g*[y(t_{υ}]=[y(t_{υ})/√ 2̅]*(1+i)) or the sum of these transfer functions or specific properties or parameters of these signals or transfer functions or sum, to be matched with (ξ^{o}_{υ}), and, if this is the case, for ending the entire process, as well as for determining whether possibly two mean values (ξ^{o}₁, ξ^{o}₂) have the same distance to (ξ*₂). and if this is the case, for selecting (ξ^{o}₁) and for determining whether (ξ^{o}₁) lies within the interval [−σ+ξ*₂, ξ*₂+σ], where σ represents the fictitious standard deviation σ>0, freely selectable by the user also by a means, as well as for selecting signals (x(t₁) or y(t₁)) or transfer functions (f*[x(t₁)]=[x(t₁)/√ 2̅]* (−1+i) or g*[y(t₁)]=[y(t₁)/√ 2̅]*(1+i)) or the sum of these transfer functions or specific properties or parameters of these signals or transfer functions or sum, to be matched with (ξ^{o}₁), and if this is the case, for ending the entire process, as well as
for determining the intersection points (ξ_{hq}) of the sum of the complex transfer functions (f*[x(t_{q})]=[x(t_{q})/√ 2̅]*(−1+i) and g*[y(t_{q})]=[y(t_{q})/√ 2̅]*(1+i)) of the paired signal (x(t_{q}), y(t_{q}), which can be represented on the complex or real number plane, if necessary after appropriate conversion, with the half-plane spanned by the vectors (1, 1, −2) and (1, 1, 1) or also (−1, −1, 2) and (1, 1, 1) and located in the 1^{st} quadrant of the complex or real number plane, this in a q^{th} step, and then determining their mean value (
$${ξ°}_{q} := \begin{matrix}{k}_{q} \\ ( \sum {ξ}_{h q} ) / {k}_{q} \\ {h}_{q} = 1 )\end{matrix}$$
as well as the mean value (ξ*_{q}) of all intersection points (ξₕ₁, ξₕ₂, . . . , ξ_{hq},
$${{ξ}^{*}}_{q} := \begin{matrix}{k}_{1} & & {k}_{2} & & {k}_{q} \\ ( \sum {ξ}_{h 1} & + & \sum {ξ}_{h 2} & + … + & \sum {ξ}_{h q} ) / ( {k}_{1} + {k}_{2} + … {k}_{q} ) \\ {h}_{1} = 1 & & {h}_{2} = 1 & & {h}_{q} = 1 ) ,\end{matrix}$$
and for determining whether the mean value (ξ^{o} _{ω̅}) closest to (ξ*_{q}), where ω̅ is equal to 1 or 2 or . . . or q, then lies within the interval [−σ+ξ_{q}*, ξ*_{q}+σ], where σ represents the fictitious standard deviation σ>0, freely selectable by the user also by a means, and for selecting signals (x(t _{ω̅}) or y(t _{ω̅})) or transfer functions (f*[x(t _{ω̅})]=[x(t _{ω̅})/√ 2̅]*(−1+i) or g*[y(t _{ω̅})]=[y(t _{ω̅})/√ 2̅]*(1+i)) or the sum of these transfer functions or specific properties or parameters of these signals or transfer functions or sum, to be matched with (ξ^{o} _{ω̅}), and, if this is the case, for ending the entire process, as well as for determining whether in case of the same mean value, different signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, 1≦s≦q, exist and, if this is the case, for selecting those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum that so far appeared with the highest frequency, as well as for determining whether several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums occur with the same frequency, and if this is the case, for selecting those signals (x(tₛ) or y(tₛ)) or transfer functions (f*[x(tₛ)]=[x(tₛ)/√ 2̅]* (−1+i) or g*[y(tₛ)]=[y(tₛ)/√ 2̅]*(1+i)) or the sum of these transfer functions or specific properties or parameters of these signals or transfer functions or sum that exhibit the widest scattering, i.e. those for which the difference d−c is maximum, where d represents the last and c the first index number of the optimization steps respectively undergone, as well as for determining whether this too applies to several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, and if this is the case for selecting the first one that appears resp. its signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum, as well as for determining whether two mean values from (ξ^{o}₁, ξ^{o}₂, . . . , ξ^{o}_{q}) are closest to (ξ*_{q}), and if this is the case for determining whether in a q−1^{th} step one of the two mean values resp. its associated signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum are selected, and if this is the case, for retaining those signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum, as well as for determining whether the thus selected mean value then lies within the interval [−σ+ξ*_{q}, ξ*_{q}+σ], where σ represents the fictitious standard deviation σ>0, freely selectable by the user also by a means, and if this is the case for selecting, to be matched with this mean value, the signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum, and for ending the entire process, as well as
for performing a q+1^{th} step in the same form as presented for the qth step and for continuing the process as well as for determining whether one mean value fulfills the above requirements or a maximum number of allowed optimization steps has been reached and thus whether the process should be ended, and if this is the case, for ending the entire process;
as well as means
for determining the intersection points (ξₕ₁) of the sum of the complex transfer functions (f*[x(t₁)]=[x(t₁)/√ 2̅]*(−1+i) and g*[y(t₁)]=[y(t₁)/√ 2̅]*(1+i)) of the paired signal (x(t₁), y(t₁)), which can be represented on the complex or real number plane, if necessary after appropriate conversion, with the half-plane spanned by the vectors (1, 1, −2) and (1, 1, 1) or also (−1, −1, 2) and (1, 1, 1) and located in the 3^{rd} quadrant of the complex or real number plane wherein hereinafter the abscissa axis of the real number plane is identical with the real axis of the complex number plane, and the ordinate axis of the real number plane is identical with the imaginary axis of the complex number plane, and then determining their mean value (
$${ξ°}_{1} := \begin{matrix}{k}_{1} \\ ( \sum {ξ}_{h 1} ) / {k}_{1} \\ {h}_{1} = 1 ) ;\end{matrix}$$
for subsequently determining the intersection points (ξₕ₂) of the sum of the complex transfer functions (f*[x(t₂)]=[x(t₂)/√ 2̅]*(−1+i) and g*[y(t₂)]=[y(t₂)/√ 2̅]*(1+i)) of the paired signal (x(t₂), y(t₂)), which can be represented on the complex or real number plane, if necessary after appropriate conversion, with the half-plane spanned by the vectors (1, 1, −2) and (1, 1, 1) or also (−1, −1, 2) and (1, 1, 1) and located in the 3^{rd} quadrant of the complex or real number plane, and then determining their mean value (
$${ξ°}_{2} := \begin{matrix}{k}_{2} \\ ( \sum {ξ}_{h 2} ) / {k}_{2} \\ {h}_{2} = 1 )\end{matrix}$$
as well as the mean value (ξ*₂) of all intersection points (ξₕ₁, ξₕ₂
$${{ξ}^{*}}_{2} := \begin{matrix}{k}_{1} & & {k}_{2} \\ ( \sum {ξ}_{h 1} & + & \sum {ξ}_{h 2} ) / ( {k}_{1} + {k}_{2} ) \\ {h}_{1} = 1 & & {h}_{2} = 1 ) ,\end{matrix}$$
as well as for determining whether the mean value (ξ^{o}_{υ}) closest to (ξ*₂), where υ is equal to 1 or 2, then lies within the interval [−σ+ξ*₂, ξ*₂+σ], where σ represents the fictitious standard deviation σ>0, freely selectable by the user also by a means, as well as for selecting the signals (x(t_{υ}) or y(t_{υ})) or transfer functions (f*[x(t_{υ})]=[x(t_{υ})/√ 2̅]*(−1+i) or g*[y(t_{υ}]=[y(t_{υ})/√ 2̅]*(1+i)) or the sum of these transfer functions or specific properties or parameters of these signals or transfer functions or sum, to be matched with (ξ^{o}_{υ}), and if this is the case, for ending the entire process, as well as for determining whether possibly two mean values (ξ^{o}₁, ξ^{o}₂) have the same distance to (ξ*₂), and if this is the case, for selecting (ξ^{o}₁) and for determining whether (ξ^{o}₁) lies within the interval [−σ+ξ*₂, ξ*₂+σ], where σ represents the fictitious standard deviation σ>0, freely selectable by the user also by a means, as well as for selecting signals (x(t₁) or y(t₁)) or transfer functions (f*[x(t₁)]=[x(t₁)/√ 2̅]*(−1+i) or g*[y(t₁)]=[y(t₁)/√ 2̅]*(1+i)) or the sum of these transfer functions or specific properties or parameters of these signals or transfer functions or sum, to be matched with (ξ^{o}₁), and if this is the case, for ending the entire process, as well as
for determining the intersection points (ξ_{hq}) of the sum of the complex transfer functions (f*[x(t_{q})]=[x(t_{q})/√ 2̅]*(−1+i) and g*[y(t_{q})]=[y(t_{q})/√ 2̅]*(1+i)) of the paired signal (x(t_{q}), y(t_{q})), which can be represented on the complex or real number plane, if necessary after appropriate conversion, with the half-plane spanned by the vectors (1, 1, −2) and (1, 1, 1) or also (−1, −1, 2) and (1, 1, 1) and located in the 3_{rd} quadrant of the complex or real number plane, this in a q^{th} step, and then determining their mean value
$${ξ°}_{q} := \begin{matrix}{k}_{q} \\ ( \sum {ξ}_{h q} ) / {k}_{q} \\ {h}_{q} = 1 )\end{matrix}$$
as well as the mean value (ξ*_{q}) of all intersection points (ξₕ₁, ξₕ₂, . . . , ξ_{hq},
$${{ξ}^{*}}_{q} := \begin{matrix}{k}_{1} & & {k}_{2} & & {k}_{q} \\ ( \sum {ξ}_{h 1} & + & \sum {ξ}_{h 2} & + … + & \sum {ξ}_{h q} ) / ( {k}_{1} + {k}_{2} + … {k}_{q} ) \\ {h}_{1} = 1 & & {h}_{2} = 1 & & {h}_{q} = 1 ) ,\end{matrix}$$
as well as for determining whether the mean value (ξ^{o} _{ω̅}) closest to (ξ*_{q}), where ω̅ is equal to 1 or 2 or . . . or q, then lies within the interval [−σ+ξ*_{q}, ξ*_{q}+σ], where σ represents the fictitious standard deviation σ>0, freely selectable by the user also by a means, as well as for selecting signals (x(t _{ω̅}) or y(t _{ω̅})) or transfer functions (f*[x(t _{ω̅})]=[x(t _{ω̅})/√ 2̅]*(−1+i) or g*[y(t _{ω̅})]=[y(t _{ω̅})/√ 2̅]*(1+i)) or the sum of these transfer functions or specific properties or parameters of these signals or transfer functions or sum, to be matched with (ξ^{o} _{ω̅}), and if this is the case, for ending the entire process, as well as for determining in case of the same mean value whether different signals (x(tₛ) or y(tₛ) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, 1≦s≦q, exist, and if this is the case, for selecting those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum that so far appeared with the highest frequency, as well as for determining whether several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums occur with the same frequency, and if this is the case for selecting those signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum that exhibit the widest scattering, i.e. those for which the difference d−c is maximum, where d represents the last and c the first index number of the optimization steps respectively undergone, as well as for determining if this too applies to several signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or sums of these transfer functions or specific properties or parameters of these signals or transfer functions or sums, and if this is the case, for selecting the first one that appears resp. its signals (x(tₛ) or y(tₛ)) or transfer functions (f*[x(tₛ)]=[x(tₛ)/√ 2̅]*(−1+i) or g*[y(tₛ)]=[y(tₛ)/√ 2̅]*(1+i)) or the sum of these transfer functions or specific properties or parameters of these signals or transfer functions or sum, as well as for determining whether two mean values from (ξ^{o}₁, ξ^{o}₂, . . . , ξ^{o}_{q}) are closest to (ξ*_{q}), and if this is the case, for determining whether in a q−1^{th} step one of the two mean values resp. its associated signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum are selected, and if this is the case, for retaining those signals (x(t) or y(t)) or transfer functions (f*[x(t)]=[x(t)/√ 2̅]*(−1+i) or g*[y(t)]=[y(t)/√ 2̅]*(1+i)) or the sum of these transfer functions or specific properties or parameters of these signals or transfer functions or sum, as well as for determining whether the thus selected mean value then lies within the interval [−σ+ξ*_{q}, ξ*_{q}+σ], where σ represents the fictitious standard deviation σ>0, freely selectable by the user also by a means, as well as for selecting, to be matched with this mean value, the signals (x(t) or y(t)) or transfer functions (f*[x(t)]=[x(t)/√ 2̅]* (−1+i) or g*[y(t)]=[y(t)/√ 2̅]*(1+i)) or the sum of these transfer functions or specific properties or parameters of these signals or transfer functions or sum, and for ending the entire process, as well as
for performing a q+1^{th} step in the same form as presented for the qth step is performed and for continuing the process, as well as for determining whether one mean value fulfills the above requirements or a maximum number of allowed optimization steps has been reached and thus whether the process should be ended, and if this is the case, for ending the entire process.

24. Device according to claim 13, with means for compression or data reduction or other selective evaluation.
